(19) United States
(12) Patent Application Publication
(10) Pub. No.: US 2013/0110565 A1
(43) Pub. Date: May 2, 2013

(54) System, Method and Computer Program Product for Distributed User Activity Management

(71) Applicants: Robert S. MEANS, JR., Crystal Beach, FL (US); Naveed Iftikhar, Chapel Hill, NC (US)

(72) Inventors: Robert S. MEANS, JR., Crystal Beach, FL (US); Naveed Iftikhar, Chapel Hill, NC (US)

(73) Assignee: Transparency Sciences, LLC, Chevy Chase, MD (US)

(21) Appl. No.: 13/455,122

(22) Filed: Apr. 24, 2012

Related U.S. Application Data
(60) Provisional application No. 61/478,909, filed on Apr. 25, 2011.
(60) Provisional application No. 61/567,122, filed on Dec. 6, 2011.
(60) Provisional application No. 61/590,796, filed on Jan. 25, 2012.

(51) Int. Cl. G06Q 10/06

(52) U.S. Cl. CPC G06Q 10/063
USPC 705/7.11

(57) ABSTRACT

A system, method and computer program product for providing a user activity management system including recording activity which may include audio; video or image; screen capture; data from a sensor; location information; computer usage; electronic communications; or social networking activities; transmitting activity information to a network cloud; making available for analyzing, viewing, reporting, training, or alerting; attaching a user activity record to IT systems; or verifying user commitments. The system or method may optionally further include providing playback or supervisor review of recordings; incorporating feedback into an employee or user record; incorporating notes-to-self; or enabling selecting an activity as a best practice for training purposes.

### CROSS-REFERENCE TO RELATED APPLICATION

This application is related to U.S. Provisional Patent Application Ser. No. 61/567,122, filed Dec. 6, 2011, to Means et al., entitled “System, Method and Computer Program Product for Improved Distributed Employee Management,” the contents of which is incorporated herein by reference in its entirety;

This application is also related to U.S. Provisional Patent Application Ser. No. 61/478,909, filed Apr. 25, 2011, to Means et al., entitled “System, Method and Computer Program Product for Improved Distributed Employee Management,” the contents of which is incorporated herein by reference in its entirety; and

This application is also related to U.S. Provisional Patent Application Ser. No. 61/590,796, filed Jan. 25, 2012, to Means et al., entitled “System, Method and Computer Program Product for Improved Distributed Employee Management Integrated with Telecommunications Provider Offering,” the contents of which is incorporated herein by reference in its entirety.

### BACKGROUND OF THE INVENTION

1. Field of the Invention

The present invention relates to communications, telephony, and training, in general, and more particularly to capturing user activity and providing coaching or training of users such as, employees, or the like.

2. Discussion of the Related Art

Conventionally, various systems have existed for logging call recordings and voice recordings of telephone calls in call centers.

For example, conventional voice logging or telephone recording, is the practice of regularly recording audio, usually in a business situation. Most commonly telephone lines or business radio channels may be recorded. Recording may allow a business to keep records, improve customer service, increase security, and decrease errors. Although voice logging may be synonymous with telephone recording, or phone recording, it may also include recording radio and/or VoIP conversations. In a call center environment voice logging may often be called more particularly “agent monitoring” or “call logging.” The word “logging” comes from the log of calls or audio files that are generated as each recording is made.

An original voice logging system was a large analog tape recorder, developed by Magnasync in 1950. In 1953 Magnasync Corporation sold 300 voice loggers to the U.S. Air Force. In the 1980s the first digital voice logging systems were developed and shrank to the size of a large PC. The original computerized systems were designed and manufactured by Eventide, Eyretel and Dictaphone. In 1996 Mercom Systems, which was purchased by Verint in July 2006, introduced Audiolog the first Windows-based voice logging system.

Conventionally, there have been three types of business phone recorders in use. The first is an analog tape system. Some businesses still use older model reel-to-reel tape to record multiple phone lines, or hook up individual cassette or micro-cassette tape recorders up to each individual phone. Analog tape is usually more expensive to maintain and much less convenient to search than digital systems. A second is a digital system. Digital systems are the most commonly used today. Digital systems may include a proprietary box of hardware that may hook into a phone system or specialized hardware that may plug into a personal computer (PC) in, e.g., a peripheral component interconnect (PCI) bus slot or may attach by, e.g., a universal serial bus (USB) cable, or the like. Some systems allow users to remotely review telephone recordings with desktop screen capture and quality reporting. A third is a software only system. The software only system may be all-software system, which may run on, e.g., but not limited to, an industry-standard server, or may use hardware such as a sound card on a PC, to record and/or monitor telephone calls. Some are simple single-user systems that typically only require a user to install the software on a PC, and use some type of simple adapter to connect the PC to a phone. However this type of software can only record a single line at a time, and is much more limited in features. Business-class recording and monitoring systems enable businesses of all sizes to deploy centralized call recording and monitoring for IP telephony systems.

Conventional call recording software as used by a call center may be used to record telephone conversations transported over the public switched telephone network (PSTN) or voice over Internet Protocol (VoIP) session calls. Call recording is distinct from call logging and tracking, which may record details about the call but not the conversation; however, software may include both recording and logging functionality.

Conventional direct recording of mobile phone calls may require a hardware adapter connected to a handset. There are many other ways to record mobile phone calls. One approach is to route calls via a PBX system linked or coupled to a recorder. However, such systems are typically expensive to purchase and change the way that calls are made, incurring continually running costs. Another approach links directly into existing recording systems from a personal digital assistant (PDA), smartphone, or other phone. These approaches may allow recordings to be time stamped, often required for legal reasons. Recording directly onto mobile devices however does not provide a legally valid recording.

Conventional call recording systems have shortcomings and are especially ill-suited to non-centralized, non-call center, distributed and/or mobile employee applications. Also, a call is only one type of activity of a given distributed employee, contractor, worker, or contracted user and therefore conventional call logging captures only a minor subset of employee or user activity. What is needed is an improved system that overcomes shortcomings of conventional systems and methods.

### SUMMARY OF EXEMPLARY EMBODIMENTS OF INVENTION

Various exemplary embodiments of a system, method and computer program product for providing an employee or user activity management system may include, in an exemplary, but nonlimiting embodiment: at least one processor adapted to record activity at the employee or user computing device comprising at least one of: audio from mic, speaker, telco device, or VoIP session; video, or images from a camera such as, e.g., but not limited to, a web cam; screen capture of what appears on a display of an employee, or other user computing device; environmental data from, e.g., but not limited to, a sensor (such as, e.g., but not limited to, a temperature, a humidity, or other sensor, etc.); geo-location information from a location sensing device (such as, e.g., but not limited to, a global positioning system (GPS) device, etc.); computer usage; electronic communications (such as, e.g., but not limited to, electronic mail, chat, instant message, simple message system (SMS), multimedia message system (MMS), etc.); or social networking activities (e.g., but not limited to, a post, a tweet, as status, etc.); the at least one processor adapted to provide, or transmit information to, e.g., but not limited to, a network cloud, or a cloud storage, or at least one of: local storage, a network, a cloud, a remote computing device in an exemplary embodiment. At the network cloud, or cloud storage, a system or method may, e.g., but not limited to at least one of: store, analyze, or enable for remote viewing. In an exemplary embodiment, at least one processor may be adapted to make information available to at least one of: perform at least one of analyzing, viewing, reporting, training, or alerting; may attach an employee or other user activity record to, e.g., but not limited to, an information technology (IT) or other independent systems, which may include, e.g., but not limited to, integrating an employee or user activity referenced/attached with other data processing systems such as, e.g., but not limited to, corporate IT systems (such as, including, e.g., but not limited to, enterprise resource planning (ERP), customer relationship management (CRM), project management, Engineering project management (EPM), knowledge management (KM), or human resources (HR), etc.), in an exemplary embodiment. The system may in an exemplary embodiment be further used to, e.g., but not limited to, verify employee, or other user commitments including, e.g., but not limited to, at least one of: a recorded session of an employee or user's communication of a promise, or other commitment to, e.g., but not limited to, a peer, customer, or manager, etc.; or to process by a third party verification system.

The system may further include, according to an exemplary embodiment, the at least one processor, which may be adapted to at least one of: may incorporate at least one of a manager's, a supervisor's, or a coach's feedback as part of an employee, or other user record; may incorporate notes to self as an exemplary part of an employee, or other user, knowledge base; or may enable a company to, e.g., but not limited to, select activities/sessions/etc. for coaching and/or training purposes and may include such in, e.g., but not limited to, a company knowledge base, according to an exemplary embodiment.

According to an exemplary embodiment, a system, method and/or computer program product may include a computer implemented method of providing an employee or user activity management system comprising: receiving, by at least one processor, an indication to start or stop recording, wherein said indication comprises receiving at least one of a selection to start recording, a selection to stop recording, a trigger, or a toggle, comprising at least one of: receiving said selection based on a timer, wherein said timer comprises at least one of a user defined timer or a signaled timer from a remote web server to start recording user activity and stop recording said user activity; receiving said selection based upon receiving launching of at least one user-selected software application, or portion of at least one software application to start recording user activity; receiving said selection based upon receiving closing or making inactive at least one user-selected software application, or portion of at least one software application to stop recording user activity; receiving said selection based upon receiving facial recognition by at least one of the webcam, or other video capture device; receiving said selection based upon receiving a change in audio level or a prescribed voice detection; receiving said selection based upon receiving a signal from a remote web server, initiated by a manager or automated based on detection of certain external events or software parameters; or receiving said selection based upon receiving a signal from at least one of a VoIP session initiation, or telco activity, to at least one of: start recording user activity, or stop recording activity; upon receiving said indication, recording, by at least one processor, activity information at an employee or user computing device, said recording comprising at least one of: capturing audio from at least one of a mic, speaker, telco device, or VoIP session; capturing at least one of a video, an image from a web cam, or an image from a camera; capturing a screen capture of a computing device; capturing a screen capture of an employee or user computing device; capturing environmental data from at least one sensor comprising at least one of a temperature sensor, a humidity sensor, or an environmental conditions sensor; capturing geo-location information from at least one location sensing device; capturing computer usage data; capturing electronic communications comprising at least one of an electronic mail message, an instant message, an SMS message, or an MMS message; capturing at least one social media post; or capturing at least one social networking activity; and providing or transmitting, by the at least one processor, said activity information to a network cloud for at least one of: storage, processing, access, or review.

According to an exemplary embodiment the method may further include making information available, by the at least one processor, for at least one of: providing or performing at least one of analyzing, viewing, reporting, training, or alerting; attaching employee or user activity record to at least one of IT or other independent system comprising at least one of: employee or user activity referenced or attached to corporate IT systems including at least one of enterprise resource planning (ERP), customer relationship management (CRM), engineering project management (EPM), project management, collaboration, knowledge management (KM), or human resources (HR); verifying commitment of an employee or user comprising at least one of: reviewing a recorded session of said commitment of the employee or user, wherein said commitment is to at least one of a peer, customer, or manager, or approving said commitment; or processing by a third party verification system.

According to an exemplary embodiment the method may further include receiving, by the at least one processor, feedback of at least one of a manager, a supervisor, or a coach, and associating or incorporating said feedback with said content; receiving, by the at least one processor, at least one note to self, and associating or incorporating, as part of an employee knowledge base; or providing for user selection, by the at least one processor, of at least one activity or at least one session for training purposes, and receiving said user selection, or storing said user selection in a company knowledge base.

According to an exemplary embodiment the method may include providing by at least one processor, an information display mechanism, whereby the recording component serves to display information of at least one user activity.

According to an exemplary embodiment the method may include providing said information display mechanism further comprises at least one of: providing a visual display of information of various outcomes across user activities comprising at least one of: a number of telco calls; a number of CRM outcomes; a number of feedback messages; a number of user defined outcomes in various software applications; a user specific electronic message; a team specific electronic message; or an alert based on at least one of an organizational or a user defined characteristic comprising at least one of a breaking news item, weather, product information, service information, or company information; providing a recent webcam image to provide visual feedback as to mood or facial expression of the user; providing a performance ranking or a status of a user within a team; providing proximity to defined goals, or potential awards, of a user or a team of the user; or providing for review of training materials or time required to achieve a training objective of the user.

According to an exemplary embodiment the method may include at least one of: analyzing, by the at least one processor, a volume level of an audio recording to determine when an actual conversation was taking place; analyzing, by the at least one processor, how often, or a percentage of time the user was engaged in a conversation; analyzing, by the at least one processor, a conversational tone for mood detection or determining at least one of: a level of anxiety, level of stress, or level of calmness; analyzing, by the at least one processor, a mood of the user during various times; correlating, by the at least one processor, a mood of the user with user productivity; analyzing, by the at least one processor, a webcam image to determine presence of an individual in an image to ascertain amount of time user was at desk of the user; analyzing, by the at least one processor, a facial expression of the user for mood detection; analyzing, by the at least one processor, a desktop screen image of the user to assess the nature of computing activity engaged by the user; analyzing, by the at least one processor, a software application used by the user; analyzing, by the at least one processor, a duration of use of a software application by the user; or analyzing, by the at least one processor, a frequency of use of a software application by the user.

According to an exemplary embodiment the method may include computer-implemented method comprising: receiving, by at least one processor, input comprising at least one of audio data, visual data, screen data, webcam data, sensory data, or environmental data comprising: capturing data or receiving captured data comprising at least one of: capturing or receiving data of a category comprising at least one of: capturing or receiving continuous audio data captured in a plurality of portions from a source comprising at least one of: a mic; a speaker; a cloud based telco; a VoIP calls; a video conference; a captured audio; or an audio stream; capturing or receiving a video comprising at least one of: at least one image, or a stream of images, wherein said at least one image or said stream is captured at a configurable frequency from a video source comprising at least one of: a Webcam; an external video capture device; a video conference device; or a camera; capturing or receiving a screen capture comprising at least one of: at least one screen image, or a stream of screen images, wherein said at least one screen image or said stream is captured at a configurable frequency from a display screen capture source comprising at least one of: a user display device; a display device controller; a software usage catalog; a computer usage list; or a browser usage catalog; capturing or receiving user activity data comprising at least one user activity captured at a configurable frequency from at least one interactive device comprising at least one of: a camera; a video device; an audio device; a capture device; a sensing device; a behavioral demographic indication of user activity; a psychographic indication of user activity; an action button; an activity indicator; a message capture; an electronic message; an instant message (IM); a social media post; or a message; capturing or receiving a location using a location based sensing device comprising at least one of: a global positioning system (GPS) sensing device; a geo tagging system; a wireless location sensing system; or a multi-dimensional location sensing system; capturing or receiving data of or for a customer relationship management (CRM) system; capturing or receiving data of or for telco data comprising at least one of: data of calls initiated through the ToolBar; data of calls on the Web; data of calls on VoIP; data of calls recorded as separate calls; data of separate calls flagged as separate calls/interactions; or calls incorporated in the Analysis/Viewing System; capturing or receiving sales force automation data comprising at least one of: CRM data; customer data; customer service data; purchasing data; or billing data; capturing or receiving sensor based data comprising at least one of: capturing location data; capturing environmental data; or capturing user activity data; capturing or receiving Environmental data comprising at least one of: capturing temperature data; capturing humidity data; or capturing sensor-based data; capturing or receiving user data; or capturing or receiving scanning data comprising at least one of scanner data, or fax data; or capturing or receiving data of a source comprising at least one of: capturing a user-initiated data; or capturing an automated capture of data; creating or receiving, and storing or receiving, metadata comprising at least one of: monitoring or analyzing capture activity; creating log of activity; tracking time of transfers; or sending a message about transfer to server; analyzing, by the at least one processor, said input comprising at least one of: analyzing audio content comprising at least one of: analyzing at least one of a client end, or server end; performing audio quantification comprising at least one of: distinguishing noise from silence comprising at least one of: placing audio content on a scale; or enabling a supervisor to use a threshold to filter; performing call analysis comprising at least one of: analyzing Web-based calls; or analyzing VoIP calls; capturing calls since the calls may not necessarily be recorded at the client; determining at least one of inbound, or outbound calls; or distinguishing telephony calls comprising at least one of VoIP or plain old telephone system (POTS) calls from generic audio; processing audio comprising analyzing using a speech-to-text engine comprising at least one of: transcribing audio; translating a language transcription; analyzing an audio transcript for keywords; enabling searches of audio content; or analyzing audio for possible filtering of at least one of unauthorized, or non-consensual recordings; analyzing image content, wherein said image content comprises at least one of webcam, camera, or videoconference image content, said analyzing comprising at least one of: analyzing on a device comprising at least one of a client; or a server, said analyzing comprising at least one of: comparing images analyzing presence of user; comparing images analyzing non-presence of user; detecting presence of user; marking presence of user; detecting nonpresence of user; marking nonpresence of user; monitoring facial expressions for at least one of: changes, or mood changes; or performing screen capture content analysis comprising at least one of: analyzing at at least one of a client, or a server, comprising at least one of: analyzing computing device screens for cataloging user software usage; analyzing computing device activity; analyzing browser activity; or cataloguing for review; and providing output, by the at least one processor, of said process to at least one of: a display for a Viewing System of a viewing user; storage; or a display, wherein the display comprising displaying at least one of: displaying individual captured data; displaying individual analyzed data; displaying team captured data; displaying team analyzed data; displaying a timeline of user activity for playback comprising at least one of: displaying and allowing feedback to user during interaction; displaying an audio graph of audio/volume levels recorded; displaying screen captured images; displaying webcam images captured; displaying activity detail from external systems comprising at least one of enterprise resource planning (ERP), customer relationship management (CRM), engineering project management (EPM), project management, collaboration, knowledge management (KM), human resources (HR), or other user defined software; displaying weather data; displaying breaking news; displaying customer name, company name, telephone number from an external CRM or Telco system; or receiving at least one of audio or text comments from at least one of a manager, a supervisor, a coach, or a peer; setting up an Alert System comprising at least one of: providing a push system; displaying selected data; or displaying selected data based on supervisor defined rules and/or triggers; setting up a training system comprising at least one of: displaying selected data; or displaying selected data based on supervisor selection; displaying random sampling of the users activities during the day as a slideshow; displaying random sampling of team activities during the day as a slideshow; benchmarking; displaying benchmark data to compare at least one of a team or an individual activity to at least one of industry average, or geographic averages; or displaying individual captured data as a personal diary.

According to an exemplary embodiment a system may include a computer implemented system comprising a processor and memory coupled to said processor, said system comprising: a user capture system operative to capture content data about a first user comprising: audio content captured continually in a plurality of segments, webcam content comprising a plurality of images captured at a configurable frequency, and screen capture content comprising a plurality of images or data captured at a configurable frequency; to capture meta data about said captured content; to store said captured content and said meta data; and to transfer said captured content and said meta data about said captured content to at least one of a cloud based network system or a cloud based storage system for at least one of analysis or processing to prepare said content for viewing by a second user.

According to an exemplary embodiment the system may further include an analysis system on at least one of: said user capture system, or the cloud based network or storage system, said analysis system operative to process said content.

According to an exemplary embodiment the system may further include a viewing system, coupled to the cloud based network or storage system, adapted to allow the second user to access said captured content of the first user.

According to an exemplary embodiment the system may further include a management system operative to provide users a subscription-based access to an application program service adapted to provide said capture, storage, and transmission of said captured content from said user capture system, adapted to provide an analysis system adapted to analyze said captured content to obtain analyzed content, and adapted to provide display on a viewing system of said analyzed content, and adapted to provide said storage and access to said storage of said analyzed content on the cloud-based network and storage system.

According to an exemplary embodiment the system may include wherein said audio content is segmented in 1 minute segments.

According to an exemplary embodiment the system may include each image of said plurality of images of said webcam content is captured every 10 seconds.

According to an exemplary embodiment the system may include wherein each image of said plurality of images of said screen capture content is captured every 10 seconds.

According to an exemplary embodiment the system may include wherein said user capture system comprises a browser based toolbar application program comprising at least one of: a start recording button; a recording activity button; at least one activity button; or a message button.

According to an exemplary embodiment the system may include wherein said user capture system comprises a browser-based toolbar application program comprising: a start recording button; a recording activity button; at least one activity button; and a message button.

According to an exemplary embodiment the system may further include a viewing system coupled to the cloud-based network and storage system, adapted to display to the second user analyzed data comprising at least one of: analysis of individual captured content; or analysis of team based captured content.

According to an exemplary embodiment a computer program product may include computer program product embodied on a computer readable storage medium comprising a plurality of program instructions which, when executed on at least one computer processor, provide a method of providing an employee or user activity management system, the method comprising: recording, by at least one processor, activity at the employee or user computing device comprising at least one of: capturing audio from at least one of a mic, a speaker, a telco, or VoIP; capturing at least one of video or images from a web cam; capturing a screen capture of a computing device of an employee or user; capturing environmental data from sensors comprising at least one of temperature, humidity, or environment data; capturing location information from a multi-dimensional location sensing device; capturing computer usage; capturing electronic communications; or capturing social networking activity; providing, by the at least one processor, or transmitting, by the at least one processor, information to a network cloud for at least one of: storage, or processing; and making information available, by the at least one processor, for at least one of: performing at least one of analyzing, viewing, reporting, training, or alerting; attaching employee activity record to records comprising at least one of: employee or user activity referenced IT systems comprising at least one of enterprise resource planning (ERP), customer relationship management (CRM), engineering project management, project management, knowledge management (KM), or HR; verifying employee or user commitments comprising at least one of: a recorded session of an employee or user or user interaction with at least one of a peer, a customer, or a manager; or processing by a third party verification system.

According to an exemplary embodiment the computer program product may include the method further including wherein the method further comprises at least one of: incorporating, by the at least one processor, feedback of at least one of a manager, a supervisor, or a coach as part of the user record; incorporating, by the at least one processor, notes to self as part of the employee or user knowledge base; or enabling, by the at least one processor, a user to select an activity or session for training purposes and to include in a company knowledge base.

According to an exemplary embodiment a system may include employee or user activity management system comprising: at least one processor adapted to record activity at the employee or user computing device comprising at least one of: audio from at least one of a mic, a speaker, a telco device, or VoIP session; a video or at least one image from a web cam; a screen capture of an employee or user computing device; environmental data from at least one sensor comprising at least one of a temperature, a humidity, or other environmental data; location information from a multi-dimensional location sensing device; computer usage; electronic communication; or social networking activity; said at least one processor adapted to provide, or transmit information to at least one of a cloud based network, or a cloud based storage, for at least one of storage or processing; and said at least one processor adapted to make information available to at least one of: to perform at least one of analyzing, viewing, reporting, training, or alerting; attaching an employee or user activity record to system comprising at least one of: an employee or user activity record of a corporate IT systems, an enterprise resource planning (ERP) system, a customer relationship management (CRM) system, an engineering project management (EPM), a project management system, a knowledge management (KM) system, or a human resources (HR) system; to verify a user commitment comprising at least one of: a recorded session of a user's promise to at least one of a peer, a customer, or a manager; to intelligently make available talking points comprising at least one of a sales tip, training, coaching, or product feature information for user access based on type of call or activity employee or user engaged in; to intelligently make available resource links/applications (e.g., credit bureaus, etc.) for employee or user to access based on type of call or activity employee or user engaged in; or to process by a third party verification system.

According to an exemplary embodiment the system may further include analyzing of recording activity comprising at least one of: means for incorporating at least one of a manager's, a supervisor's, or a coach's feedback as part of the Employee or user record; means for incorporating notes to self as part of the Employee or user Knowledge base; enable a company to select activities/sessions for training purposes and to include in the company knowledge base; means for recognizing words in a recording activity; means for recognizing the length of a recording activity; means for determining the percentage of time of activity as compared to inactivity; means for recognizing a number of speakers in a recording activity; means for recognizing a number of speakers in a recording activity; means for recognizing a language of a recording activity; means for recognizing an age of a participant in a recording activity; means for recognizing an audio quality of a recording activity; means for recognizing a video quality of a recording activity; means for recognizing gender of a participant in a recording activity; means for evaluating a recording activity; means for selecting a particular recording activity from a plurality of recording activities for review; means for capturing a screen associated with a recording activity; means for performing voice recognition on a recording activity; means for speech to text recognition of a recording activity; means for translation of a recording activity; means for keyword searching of a recording activity; means for identifying people in a recording activity; means for detecting stress in a recording activity; means for detecting emotion in a recording activity; means for identifying location of a participant in a recording activity; or means for geolocation sensing of a recording activity.

According to an exemplary embodiment the system may include means for recording activity of at least one of: a distributed employee or user recording activity; a distributed workforce recording activity; a mobile workforce recording activity; a virtual workforce recording activity; a manager review of an employee or user recording activity; a customer and employee or user recording activity; a recording activity for a government or public worker; a recording activity for a private industry worker; a sales person and a customer recording activity; a manager and subordinate recording activity; a trainer and a trainee recording activity; a peer to peer recording activity; a recruiter to recruit recording activity; a customer relationship management (CRM) recording activity; a call recording activity; a VoIP call recording activity; an employer and candidate recording activity; a commercial recording activity; a business-related recording activity; an employment management activity; a human resource tracking recording activity; a personal diary recording activity; a compliance tracking recording activity; or a recording activity of an employee or user's actions.

According to an exemplary embodiment a method may further include capturing or storing content in the cloud, said content further comprising at least one of: audio content; video content; a recording; a file; a stream of content; a video content stream; an audio content stream; a media content stream; compressed content; uncompressed content; digital content; sampled audio content; captured video content; digitized analog content; or data compressed in a compressed format comprising at least one of: a WAV format, an MP3 format, an OGG format, an MPEG format, an AVI format, or another compressed format.

According to an exemplary embodiment a method may include a method for gathering person specific activity data, comprising: capturing activity data through at least one collection device, the at least one collection device being of at least one of: a distributed work force, or a mobile work force, and allowing the data to be at least one of: exported, saved for review, analyzed, referenced, or exported to a third party system.

According to an exemplary embodiment method may include a method for gathering person specific activity data, comprising: capturing person specific activity data through at least one collection device, or receiving from at least one of a public or private data source, said capturing comprising: capturing information regarding at least one of a distributed or mobile work force, and allowing said captured data to be at least one of: exported, saved for review, analyzed, referenced, or exported to a third party system.

According to an exemplary embodiment a method may include a method comprising: gathering individual activity data comprising at least one of: gathering data across multiple platforms, gathering data from at least one of multiple sources or sensors, or gathering data across broad geographies, said gathering said individual activity data comprising: collecting data in a computing device, transmitting said data to a network cloud computing device comprising at least one of: a remote computing device; a storage device; allowing said individual activity data to be combined with data available from at least one of: a public data source, or a private data source; and allowing said individual activity data to be made available for at least one of: analyzing, correlating, making available for a least one of: reviewing, archiving, searching, analysis, or reporting.

According to an exemplary embodiment the method may further include using said individual activity data by at least one of: an organization for at least one of employee or user activity management, or a school for student activity management.

According to an exemplary embodiment a method may further include taking said data collected, and at least one of: inserting, exporting, attaching to an other system comprising at least one of: customer relationship management (CRM), enterprise resource planning (ERP), project management (PM), engineering project management (EPM), knowledge management (KM), or human resources (HR).

According to an exemplary embodiment a method may further include at least one of: intelligently making available analysis; intelligently making available talking points; intelligently analyzing at least one of screen activity or sensed data; intelligently making available talking points for at least one of: sales tips, coaching, training, information, or product feature information for user access based on type of call or activity user is engaged in; intelligently making available resource links or applications for at least one of: a credit bureau, an information service a user to access based on type of call or activity in which user is engaged; or intelligently making available via an underlying artificial intelligence system recommended processing.

According to an exemplary embodiment a method may further include wherein said user capture system is adapted to share said recording activity comprising at least one of: adapted to authorize selected viewers to view user recorded activities; or adapted to authorize selected viewers to view portions of user recorded activities.

According to an exemplary embodiment a method may further include the user capture system which may be adapted to receive at least one of: a selection of recorded activity comprising being adapted to at least one of: receive a selection of at least one segment of a plurality of items on a time line; select a least one segment based on at least one pre-defined length; select at least one segment based on a selection or pointing device adapted to select a selection or particular range; or select at least one segment based on at least one received input of at least one time selection; a selection of recorded activity, adapted to analyze at least one of: at least one keyword in the recording; a frequency of at least one keyword in the recording; a voice match of at least one voice in the recording; a gender match of at least one voice in the recording; a phrase match in the recording; a keyword match in at least one of an associated audio note, or feedback message within a recording; an other software activity match, displayed on a time line of a recording; a particular screen image match; a particular URL match within the software activity; at least one of a VoIP or Telco Activity match displayed within a time line of a recording; a location match of the recording activity; or a selection of access to at least one selected recorded activity or group of recording activities made available through a system adapted to at least one of: embed at least one segment in an email or other communication message; create a URL, accessible via the web, comprising at least one of: open access—no password or access control; user defined passwords; expiring URLs that become unavailable after a pre-defined length of time; or number of views; make at least one segment available within a messaging or sharing component; or tag at least one selected recorded activity by at least one specific tag and programmatically make them available to a user or pre-defined group of users.

According to an exemplary embodiment the system may further include being adapted for privacy and control of recording activity comprising being adapted to at least one of: designate which sensory data is to be captured; designate how often sensory data is captured; designate who is authorized to view what, when, and/or for how long; or designate, select or permanently delete data.

According to an exemplary embodiment a system may further include being adapted to provide output, by the at least one processor, of said process adapted to provide for viewing at least one time line of recording data adapted to display at least one of: a timeline of user activity for playback comprising being adapted to at least one of: display or allow feedback to user during interaction; or receive at least one of audio or text comments from at least one of a manager, a supervisor, a coach, or a peer; display an audio graph of audio/volume levels recorded; display screen captured images; display webcam images captured; display activity detail from external systems such as CRM or ERP or Project Management or other user defined Software; display weather data; display breaking news; display customer name, company name, telephone number from an external CRM or Telco system; display feedback and messages associated with that moment in the recording; or a navigation of a display by a time line comprising being adapted to at least one of: receive a click or selection on any point or moment on the time line; or receive a click or selection on any event marked on the time line.

According to an exemplary embodiment a system may further include being adapted to provide output comprising being adapted to provide at least one of: a view system whereby a viewer can select or search calls by at least one of: an event across one user or an entire team of users; an event for a particular user; to define a call and have a system find “like” calls, wherein a like call comprises a call being determined or evaluated by a common characteristic across one or a plurality of calls comprising at least one of: keywords within the calls; frequency of keywords within the calls; gender voice; event type; time of call; length of call; geography of call; or demographics of call; to define a call and have a system find “unlike” calls, wherein unlike calls are determined by evaluating an uncommon characteristic across one or a plurality of calls comprising at least one of: at least one keyword within a call; a frequency of at least one keyword within the call; a gender of a voice; an event type; time of call; length of call; geography of call; or demographics of call; select “Live” and listen to at least one call in near real-time; or a view system adapted to display a list of one or more calls selected, displayed in at least one of a plurality of ways, said view system adapted to at least one of: incorporate a “mini-player” adapted to allow the user to select to play audio of one or more searched calls in a sequential or nonsequential fashion; or incorporate a “mini-player” adapted to allow the user to select to play audio of one or more searched calls with associated notes and feedback comments in a sequential or nonsequential fashion.

According to an exemplary embodiment a method may further include analyzing, by at least one processor, critical success factor data associated with at least one activity outcome or result, said analyzing comprising: analyzing data comprising at least one of: endogenous factors comprising at least one of: audio transcript for keywords; frequency of keyword usage; CRM data; customer data; customer service data; purchasing data; billing data; words in a recording activity; speech during recording activity; silence during recording activity; length of a recording activity; percentage of time of activity as compared to inactivity; number of speakers in a recording activity; gender of a participant in a recording activity; capturing a screen associated with a recording activity; people in a recording activity; stress in a recording activity; emotion in a recording activity; location of a participant in a recording activity; geolocation sensing of a recording activity; or exogenous factors comprising at least one of: environmental factors; breaking political news; breaking financial news; breaking industry news; or breaking company news.

According to an exemplary embodiment a method may further include continuously refining results based on new data; developing associated improved impact coefficients; or improving accompanying confidence intervals for probabilistic critical success factors.

According to an exemplary embodiment a method may further include incorporating data from at least one of: a training material mastered by at least one user further comprising at least one of: a reference material; a best practice; an audio transcript; participation in a discussion forum; a note or feedback from at least one of a coach, a peer, or a manager; a duration of time having been coached; industry news; financial news; or a performance of a team member comprising at least one of; a number of years of experience in a profession; a number of years of experience in an industry; a gender of a team member; an education of a team member; a cumulative amount of training time; an on-going training per time period comprising at least one of a week, a month, or a year; or a number of hours at least one of coaching, or being coached.

According to an exemplary embodiment a method may further include ascertaining effectiveness of at least one of: coaching methods, coaches, or training programs, comprising at least one of: reviewing changes in performance outcomes after coaching interventions; or reviewing changes in performance outcomes after training sessions.

According to an exemplary embodiment a method may further include enabling a coach to review an intervention of an other coach, comprising at least one of: providing review without identifying a particular coach; or judging an evaluation of an intervention of a coach against actual results.

According to an exemplary embodiment a method may include ascertaining at least one training deficiency of a user; identifying at least one high impact training activity for a user; or developing at least one automated training program for a user.

According to an exemplary embodiment a method may include allowing a user to determine how much time is available for training; and allocating a most efficient or effective training regimen based on said time available.

According to an exemplary embodiment a method may include matching a particular user to at least one of: an activity to which the particular user is most suited; a sales product to which the particular user is most suited; or a demographic to which the particular user is most suited to target.

According to an exemplary embodiment a method may include a computer implemented method of providing an employee or user a training, coaching and collaboration system comprising: providing, by at least one processor, a training playbook comprising: a sales script or talking point; a summarized list of bullet points; at least one image, video clip, or audio clip; a reference material; at least one coaching note, or feedback note marked as at least one of good, bad or neutral; a collection of at least one best practice; at least one of an employee or a user role play; at least one management note; at least one management priority; at least one discussion forum; an industry news item; and at least one product detail.

According to an exemplary embodiment a method may further include at least one of: categorizing or cataloguing each element of the playbook around a subject; associating a subject or associated material from a playbook with an activity or sales outcome; prioritizing or associating a subject or associated material from a playbook with an activity or sales outcome; creating a subject library of playbook materials; creating a display of outcomes across a group of users or a team; or providing a performance ranking for each user around at least one subject or playbook material.

According to an exemplary embodiment a method may include wherein performance of each user is further provided comprising at least one of: analyzing the performance around at least one outcome associated with at least one subject, or analyzing the performance around at least one outcome and associated playbook materials, or analyzing performance, wherein if the performance is subpar, selecting at least one of the associated playbook materials for improvement, coaching, or training.

According to an exemplary embodiment the method may include wherein training of each user is further provided comprising at least one of: prioritizing by at least one management objective or customizing, to deliver materials with a highest degree of anticipated impact on the at least one outcome and within a time constraint of the user.

According to an exemplary embodiment a method may further include at least one of: enabling review by management of training activity of a user at least one of: by subject or by material, and ensuring proper availability of time to close any training gap; or enabling review by a user of a training deficit at least one of: by subject, by material, or priority, and closing the training deficit efficiently.

According to an exemplary embodiment a method may further include at least one of: continuously updating an importance of a particular subject; or reprioritizing training based on an importance of a particular subject.

According to an exemplary embodiment a method may further include at least one of: identifying a need for coaching intervention; focusing on a particular user, subject, or playbook material; or creating an impact on an outcome.

According to an exemplary embodiment a method may further include at least one of: presenting at least one version of at least one of: at least one sales script, at least one talking point, or at least one reference material; presenting at random across at least one of a team, or group of users; or ascertaining an effectiveness of at least one material in producing a positive outcome.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of an embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1A depicts an exemplary view of an exemplary embodiment of an exemplary distributed work force environment using a plurality of computing and communication devices coupled together in a distributed networked system architecture 100, according to an exemplary embodiment;

FIG. 1B depicts an exemplary embodiment of an activity recording, analysis & reporting, management reporting, and manager/coaching system architecture 120, according to an exemplary embodiment coupled together by an exemplary cloud-based architecture network, according to an exemplary embodiment;

FIG. 1C depicts an exemplary embodiment of a system 160 illustrating an exemplary employee or user system including various content capture devices, in an exemplary embodiment, a microphone, screen and webcam are coupled to deliver content captured from the employee or user system over a network such as the Internet to exemplary cloud storage, and further processing and analyzing on various webservers, and for providing access to the analyzed content by other users such as supervisors, managers or coaches of the employee or user, according to an exemplary embodiment coupled together by an exemplary cloud-based architecture network, according to an exemplary embodiment;

FIG. 1D depicts an exemplary embodiment of a diagram 180 illustrating an application programming interface (API) which may be used to interface an exemplary embodiment of a toolbar to other information technology systems such as CRM, sales tracking, ERP, etc, as well as providing access to a marketplace of services such as, e.g., but not limited to, coaching, verifications, audits, etc. and also access to an APP store for accessing on an exemplary subscription, or one-time license cost access to applications, apps, or the like to provide capture, messaging, alerts and/or analysis and viewing functionality, according to an exemplary embodiment;

FIG. 1E depicts an exemplary embodiment of an exemplary system 190 illustrating an exemplary distributed employee or user activity recording system for capturing employee or user activity of an exemplary team member user, whose system is coupled to an exemplary cloud-based network, including, e.g., but not limited to, a Telco/VoIP network, and/or storage system, which itself may be coupled to, e.g., but not limited to, an exemplary remote storage, an exemplary database management application system, an exemplary messaging system, an exemplary management system, and/or an exemplary analysis/viewing/reporting/alerts system, as could be used by another exemplary supervisor user to, e.g., but not limited to, review, provide training, and/or coach the activities of the team member user, according to an exemplary embodiment, according to an exemplary embodiment;

FIG. 2A depicts an exemplary embodiment of an exemplary toolbar application software program 200 as may be provided in an exemplary embodiment, including an exemplary user friendly, unobtrusive profile application, various graphical user interface features such as multi-colored (e.g., green, red, yellow, blue) action buttons 202, start recording selector/indicator 204, recording indicator 208, configuration/setup button 206, messaging input field 205, messaging button 212, screencapture button 210, etc., according to an exemplary embodiment;

FIG. 2B depicts an exemplary embodiment of an exemplary toolbar application software program 220 as may be provided in an exemplary embodiment, including exemplary customized buttons, showing an exemplary customer user activity recording environment application, according to an exemplary embodiment, according to an exemplary embodiment;

FIG. 2C depicts an exemplary embodiment of an exemplary toolbar application software program 230 as may be provided in an exemplary embodiment, on a client device such as, e.g., a PC, a computing device, a communications device, a personal digital assistant, a smart phone, a tablet, a color-coded easy to use application or applet, or browser toolbar, including various exemplary indicators, selection buttons, messaging fields, and action and customization selection buttons, according to an exemplary embodiment;

FIG. 2D depicts an exemplary embodiment of a diagram 240 of an exemplary inobtrusive minimized or miniature sized graphical user interface applet, application, gadget, etc. application software program including exemplary but nonlimiting indicators and buttons, of various graphical user interface features, according to another exemplary embodiment;

FIG. 2E depicts a diagram 250 illustrating an exemplary embodiment of an exemplary TeamVisibility graphical user interface toolbar applet, application, gadget, application software program, etc., which may include exemplary but nonlimiting indicators and/or buttons, including various graphical user interface features, which may be used, e.g., for tracking messages, allowing a user to flag a recording, a record start/stop indication for stopping/starting recording, one or more activity counter button(s), which may be color coded or have other indicia to indicate information, which may be collected, various content selector(s) such as, e.g., but not limited to, a toggle or radio button object(s) for selecting, e.g., but not limited to, a mic, a webcam, a desktop screen capture, a manager's full view, and/or rep share only, etc. exemplary views, according to another exemplary embodiment;

FIG. 2F depicts a diagram 260 illustrating an exemplary embodiment of an enhanced exemplary toolbar serving an exemplary information dashboard with exemplary third party data as may be integrated with an exemplary toolbar, illustrating an exemplary toolbar display of exemplary information from an exemplary CRM or other enterprise system, such as, e.g., but not limited to, a number of contacts, gross or net revenues, number of sales, number of callbacks, number of rejections, number of upsells, etc., exemplary indicators for recording, or to start/stop, a user flag, which may be used to mark a particular recording, or to alert a manager, etc., an icon to display and/or access messages; and/or exemplary activity counter(s) icon(s), as may appear on the exemplary toolbar, according to an exemplary embodiment;

FIG. 3A depicts an exemplary embodiment of a diagram 300 illustrating an exemplary supervisor interface management reporting toolbar in an exemplary teamview 300, including various exemplary analysis, reporting features as may be provided in an exemplary embodiment;

FIG. 3B depicts an exemplary embodiment of a diagram 320 of an exemplary supervisor interface management indicating an inside sales group, including exemplary day, week and monthly views and compiled data as gathered from an exemplary employee or user toolbar, according to an exemplary embodiment;

FIG. 3C depicts an exemplary embodiment of a diagram 330 of an exemplary supervisor interface management/reporting tool bar indicating exemplary activity by an exemplary employee or user, including exemplary captured audio, captured screens, and captured images of the team member, according to an exemplary embodiment;

FIG. 3D depicts an exemplary embodiment of a diagram 340 of an exemplary supervisor interface management/reporting tool bar indicating exemplary call activity providing exemplary summaries of call activity by an exemplary employee or user, including time of call, exemplary duration, exemplary keyword counts, which can be acquired by, e.g., but not limited to, direct voice recognition, or speech to text recognition, etc., exemplary audio or textual transcripts and/or screen shots;

FIG. 3E depicts an exemplary embodiment of a diagram 350 of an exemplary supervisor interface management/reporting tool bar indicating exemplary call detail for an exemplary employee or user, including an exemplary captured transcript, email, or instant message (IM) message, call statistics, etc., according to an exemplary embodiment;

FIG. 3F depicts an exemplary embodiment of a diagram 360 of an exemplary supervisor interface management/reporting tool bar indicating exemplary call detail by an exemplary employee or user, including exemplary captured audio, email, or instant message (IM) message, call statistics, etc., according to an exemplary embodiment;

FIG. 3G depicts an exemplary embodiment of a diagram 370 of an exemplary supervisor interface management/reporting tool bar indicating exemplary call detail activity, where a transcript of the call has been captured/analyzed, and a keyword “warehouse” has been searched, according to an exemplary embodiment;

FIG. 3H depicts an exemplary embodiment of a diagram 380 of an exemplary supervisor interface management/reporting tool bar indicating exemplary screen pane activity, where a frequency of screen capture images is indicated for a given user, along with a catalog of what software programs were used, and how often, etc., according to an exemplary embodiment;

FIG. 3I depicts an exemplary embodiment of a diagram 390 of an exemplary supervisor interface management/reporting tool bar indicating exemplary web cam (or other camera captured image) pane activity, where a frequency of web cam images, along with facial recognition processing data indication is indicated for a given user, and in addition, the system may, in one exemplary embodiment. be refashioned to detect any distractions among employee or users, according to an exemplary embodiment;

FIG. 3J depicts an exemplary embodiment of a diagram 392 of an exemplary supervisor interface management/reporting tool bar indicating exemplary call activity, where a status and keyword count of transcripts is provided as well as access to recorded transcripts for various call segments of a given user, according to an exemplary embodiment;

FIG. 3K depicts an exemplary embodiment of a diagram 394 of an exemplary supervisor interface management/reporting tool bar indicating exemplary member view, where various call activity, screen pane and web cam pane activity may be summarized, as well as various reports may be accessed regarding cell usage, IM chats, use of social networks, attentiveness indications, absence, sequential calls, successful calls, unsuccessful calls, keyword alerts, etc., may be searched, by keyword of transcripts for a given member user, according to an exemplary embodiment;

FIG. 3L depicts an exemplary embodiment of a diagram 396 of an exemplary supervisor interface management/reporting tool bar indicating exemplary member view, where various captured audio call activity, the audio level indicator may, e.g., but not limited to, allow the supervisor to play audio blocks, which actually contain audio, versus silence, etc., screen pane and web cam pane activity may be viewed via graphical user interface display of an exemplary timeline indicating call segments, and a selected magnified area for a selected call segment, including providing for adding comments by a coach/manager/supervisor, as well as review of the team member's action button selections, screen shot and web cam image of the team member, according to an exemplary embodiment;

FIG. 3M depicts an exemplary embodiment of a diagram 398 of an exemplary supervisor interface management/reporting tool bar indicating exemplary team view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment;

FIG. 3N depicts an exemplary embodiment of a diagram 397 of an exemplary supervisor interface management/reporting tool bar indicating exemplary push-alerts page view, providing the supervisor the ability to provide customized alerts, listing exemplary push activities, by team member, as well as the date/time and length of the segment, and optionally, the supervisor, e.g., may be enabled to listen in the background, and with a text to speech analyzer announcing, which segment is being played, etc., according to an exemplary embodiment;

FIG. 3O depicts an exemplary embodiment of a diagram 399 of an exemplary supervisor interface management/reporting tool bar indicating exemplary member detail play view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment;

FIG. 3P depicts a diagram 325 illustrating an exemplary embodiment of a diagram of an exemplary supervisor interface management/reporting tool bar indicating exemplary team day view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment;

FIG. 3Q depicts a diagram 326 illustrating an exemplary embodiment of a diagram of an exemplary supervisor interface management/reporting tool bar indicating exemplary team week view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment;

FIG. 3R depicts a diagram 335 illustrating an exemplary embodiment of a diagram of an exemplary supervisor interface management/reporting tool bar indicating exemplary team month view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment;

FIG. 3S depicts a diagram 336 illustrating an exemplary embodiment of a diagram of an exemplary supervisor interface management/reporting tool bar indicating exemplary team setting page view, where various settings may be adjusted, according to an exemplary embodiment;

FIG. 3T depicts a diagram 345 illustrating an exemplary embodiment of a diagram of an exemplary supervisor interface management/reporting tool bar indicating exemplary push alerts, where various alerts may be reviewed, an optional check/uncheck box may allow the supervisor to select and save particular items for later coaching or inclusion in a best practices archive, etc. according to an exemplary embodiment;

FIG. 3U depicts a diagram 346 illustrating an exemplary embodiment of a diagram of an exemplary supervisor interface management/reporting tool bar indicating exemplary push settings page view, where various push settings may be adjusted, according to an exemplary embodiment;

FIG. 4 depicts an exemplary flow diagram 400, according to an exemplary embodiment illustrating an exemplary process of gathering user activity data;

FIG. 5 depicts an exemplary diagram 500 illustrating an exemplary computer/communications device hardware architecture as may be used in various components of exemplary embodiments of the present invention;

FIG. 6A depicts an exemplary embodiment of a diagram 600 illustrating an exemplary member view including an exemplary timeline of captured data, for a day, by minutes, or by hours, according to an exemplary embodiment;

FIG. 6B depicts an exemplary embodiment of a diagram 620 of an exemplary member notes view, where various exemplary audio or text messages are listed, as well as the time and duration of the notes, according to an exemplary embodiment;

FIG. 6C depicts an exemplary embodiment of a diagram 630 illustrating an exemplary member detail hour view including an exemplary timeline of captured data, for a day, by minutes, or by hours, according to an exemplary embodiment;

FIG. 6D depicts an exemplary embodiment of a diagram 640 illustrating an exemplary member detail day view including an exemplary timeline of captured data, for a day, by minutes, or by hours, according to an exemplary embodiment;

FIG. 6E depicts an exemplary embodiment of a diagram 650 illustrating an exemplary manage team view—for assigning licenses, inviting users, reviewing status of a team, according to an exemplary embodiment;

FIG. 6F depicts an exemplary embodiment of a diagram 660 illustrating an exemplary manage team remote configuration and assign action buttons configuration screen, according to an exemplary embodiment;

FIG. 6G depicts an exemplary embodiment of a diagram 670 illustrating an exemplary method of purchasing additional license and/or storage, exemplary add services screen, according to an exemplary embodiment;

FIG. 6H depicts an exemplary embodiment of a diagram 680 illustrating an exemplary member summary month view including an exemplary timeline of captured data, for a month, according to an exemplary embodiment;

FIG. 6I depicts an exemplary embodiment of a diagram 690 illustrating an exemplary member summary week view including an exemplary timeline of captured data, for a week for an exemplary member, according to an exemplary embodiment;

FIG. 7 depicts a diagram 700 of an exemplary embodiment of an exemplary environment illustrating an exemplary direct peer-to-peer implementation of the system, wherein, in an exemplary framework, all Employee or user Activity Records may be, e.g., stored locally on an employee or user/user device and the employee/user may be able to create in effect a ‘personal DVR (Digital Video Recorder),’ according to an exemplary embodiment, another user/supervisor/coach etc., can then directly access full or partial information on the user's computer, and, according to an exemplary embodiment, the collected information can be, e.g., but not limited to, deleted, uploaded to a private storage device, or directed for, e.g., but not limited to, storage, remote access, processing, in, e.g., but not limited to, the cloud/network environment;

FIG. 8A depicts an exemplary embodiment of a diagram 800 illustrating an exemplary TeamVisibility system illustrating a detailed activity display and showing exemplary voice notes displayed on a viewing timeline, according to an exemplary embodiment;

FIG. 8B depicts an exemplary embodiment of a diagram 810 illustrating an exemplary TeamVisibility system illustrating an exemplary player view illustrating an exemplary share button for sharing a recorded activity to another user as authorized by a given setup, according to an exemplary embodiment;

FIG. 9A depicts an exemplary embodiment of a diagram 900 illustrating an exemplary TeamVisibility (TV) Third Party Data Integration system illustrating exemplary third party data, e.g., a customer relationship management (CRM) system, such as, e.g., but not limited to, an exemplary view as shown in an exemplary TV system including an exemplary event indicator and exemplary integration, according to an exemplary embodiment;

FIG. 9B depicts an exemplary embodiment of a diagram 910 illustrating an exemplary TeamVisibility (TV) system activities incorporated in an external system, such as, e.g., but not limited to an order entry, or CRM system, illustrating an exemplary third party integration illustrating an exemplary TV solutions link embedded in an enterprise order management system, according to an exemplary embodiment;

FIG. 10A depicts an exemplary embodiment of a diagram 1000 illustrating an exemplary TeamVisibility (TV) enhanced player displaying results of audio filters and exemplary sound block navigation according to an exemplary embodiment;

FIG. 10B depicts an exemplary embodiment of a diagram 1010 illustrating an exemplary TeamVisibility system depicting enhanced reporting and navigation illustrating an exemplary live play icon, customizable metrics, and exemplary clickable activity filters, according to an exemplary embodiment;

FIG. 10C depicts an exemplary embodiment of a diagram 1020 illustrating an exemplary TeamVisibility (TV) enhanced reporting of filtered results according to an exemplary embodiment;

FIG. 10D depicts an exemplary embodiment of a diagram 1030 illustrating an exemplary TeamVisibility system depicting enhanced messaging/collaboration, and miniplayer system, according to an exemplary embodiment;

FIG. 10E depicts an exemplary embodiment of a diagram 1040 illustrating an exemplary TeamVisibility (TV) adaptive learning system I including an exemplary rule extraction engine (REL), and captured rules and confidence intervals according to an exemplary embodiment;

FIG. 10F depicts an exemplary embodiment of a diagram 1050 illustrating an exemplary TeamVisibility system adaptive learning system II including an exemplary rule validation and improvement engine, and captured rules and improved rules, probabilities and confidence levels according to an exemplary embodiment;

FIG. 10G depicts an exemplary embodiment of a diagram 1060 illustrating an exemplary TeamVisibility (TV) adaptive learning system I including an exemplary rule extraction engine (REL), and captured rules and confidence intervals according to an exemplary embodiment;

FIG. 10H depicts an exemplary embodiment of a diagram 1070 illustrating an exemplary TeamVisibility system adaptive learning system II including an exemplary rule validation and improvement engine, and captured rules and improved rules, probabilities and confidence levels according to an exemplary embodiment;

FIG. 11 depicts a diagram 1100 illustrating an exemplary local exchange carrier telecommunications public switched telephone network (PSTN) in an exemplary environment;

FIG. 12 depicts a diagram 1200 illustrating an exemplary local exchange carrier and intraexchange carrier telecommunications public switched telephone network (PSTN) in an exemplary environment;

FIG. 13 depicts a diagram 1300 illustrating an exemplary voice over a data network hardware architecture as may illustrate an exemplary voice over Internet Protocol (VoIP) hybrid communications network including both VoIP devices, as well as PSTN devices, coupled together via an exemplary voice over IP network as may include, e.g., but not limited to, gateways, routers, signaling devices, SIP and/or MGCP protocol devices, softswitches, etc., as will be apparent to those skilled in the relevant art;

FIG. 14 depicts an exemplary embodiment of a diagram 1400 illustrating an exemplary TeamVisibility (TV) training gap, rep feedback, campaigns, close gap summary; according to an exemplary embodiment;

FIG. 15 depicts an exemplary embodiment of a diagram 1500 illustrating an exemplary TeamVisibility (TV) training gap, rep feedback, campaigns, close gap summary of FIG. 14, scrolled to the right; according to an exemplary embodiment;

FIG. 16 depicts an exemplary embodiment of a diagram 1600 illustrating an exemplary TeamVisibility (TV) Best Practices, training tool, rep feedback, campaigns, close gap summary; according to an exemplary embodiment;

FIG. 17 depicts an exemplary embodiment of a diagram 1700 illustrating an exemplary TeamVisibility (TV) Summary, training, and members, coaches, and campaign information according to an exemplary embodiment;

FIG. 18 depicts an exemplary embodiment of a diagram 1800 illustrating an exemplary TeamVisibility (TV) Training, Summary by campaign, member information for an exemplary member; according to an exemplary embodiment;

FIG. 19 depicts an exemplary embodiment of a diagram 1900 illustrating an exemplary TeamVisibility (TV) Summary, training, for an exemplary campaign summary information according to an exemplary embodiment;

FIG. 20 depicts an exemplary embodiment of a diagram 2000 illustrating an exemplary TeamVisibility (TV) Training, Summary by campaign, for a given member; according to an exemplary embodiment; and

FIG. 21 depicts an exemplary embodiment of a diagram 2100 illustrating an exemplary TeamVisibility (TV) Summary, training, coach gap, campaign and member information according to an exemplary embodiment.

### DETAILED DESCRIPTION OF EXEMPLARY EMBODIMENTS OF THE INVENTION

Various exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

An exemplary system for collecting one or more combinations of exemplary multiple pieces of data/information from an exemplary user's computing/communications device, transmitting, and/or storing it in an exemplary cloud computing/network storage system, combining the collected data/information with data from other sources, analyzing the totality of information and making data, reports and results of analysis available for viewing across an exemplary internet/data communications/computer network.

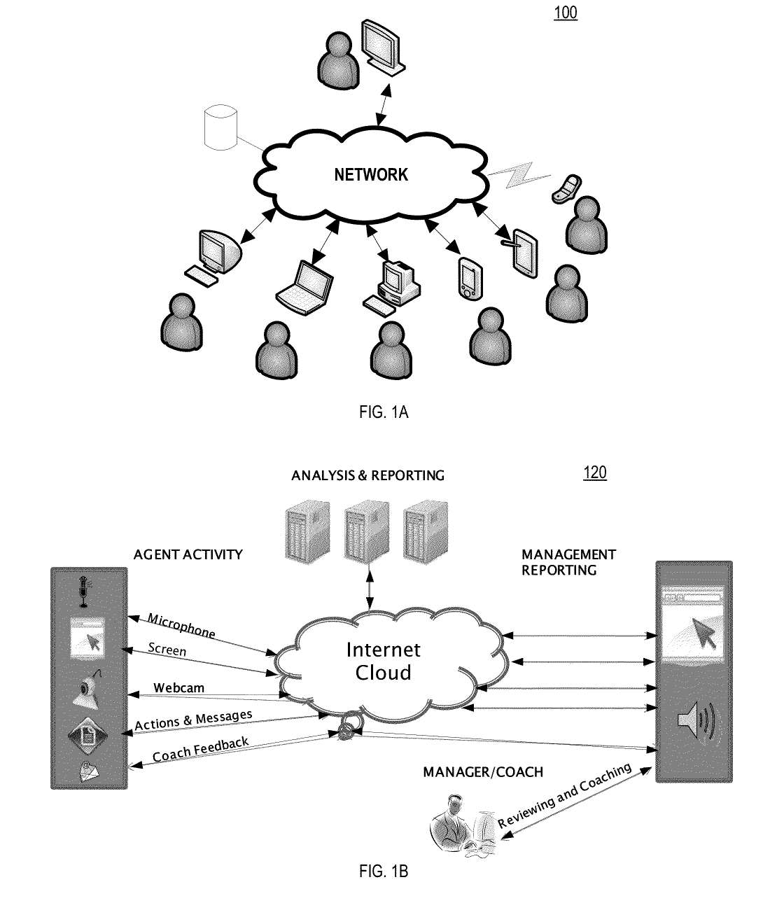

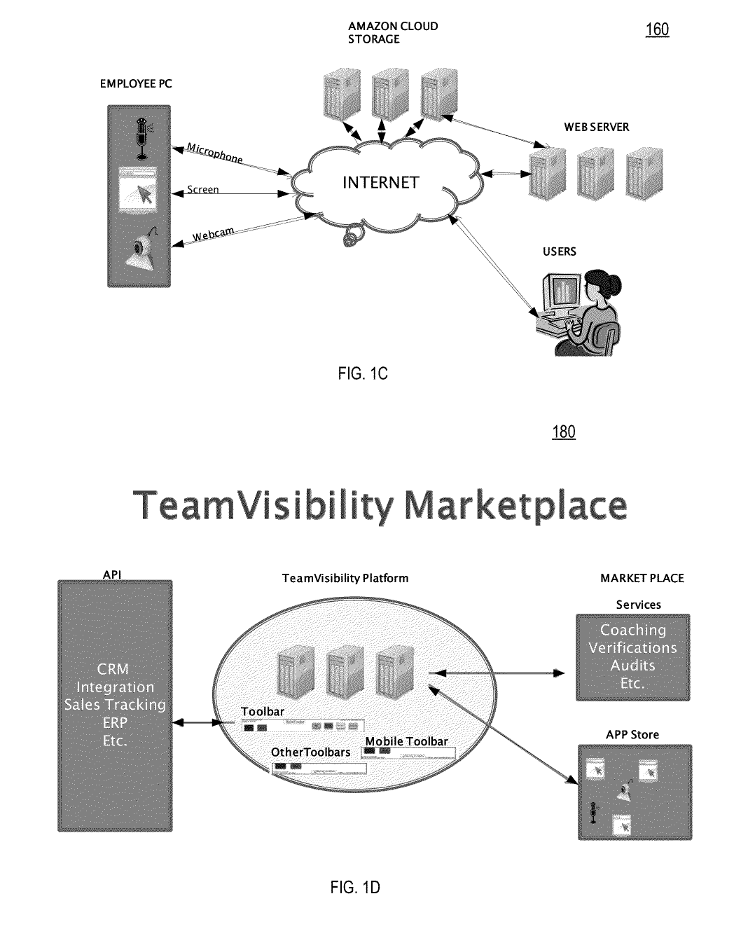

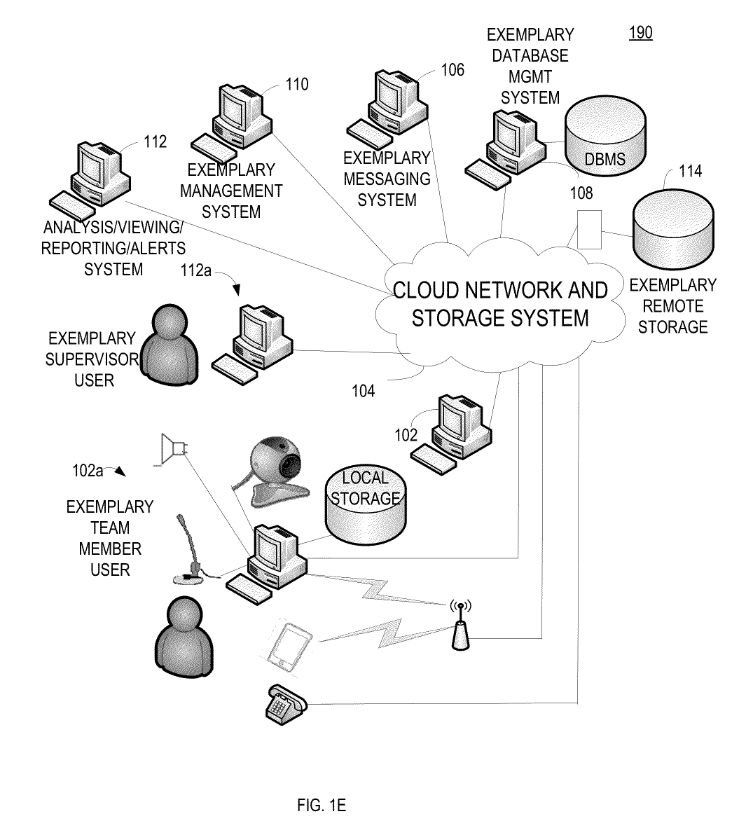

Various exemplary, but non-limiting High-Level Elements of an exemplary embodiment of the exemplary system 190, according to an exemplary embodiment, are shown in FIG. 1E. The elements may include, in an exemplary embodiment an exemplary user data/information collection component 102, an exemplary cloud/network storage system facility 104, an exemplary message processing system 106, an exemplary database server 108, an exemplary remote management system 110 and an exemplary Analysis/Viewing/Reporting/Alerts system 112. In an exemplary embodiment, an exemplary team member user 102a may use an exemplary collection device to capture information about the team member's interactions with customers. In an exemplary embodiment, an exemplary supervisor user 112a may use an exemplary viewing device 112a to access exemplary analyzed and stored interaction content at an exemplary team or team member level.

### Exemplary User Data/Information Collection Component 102:

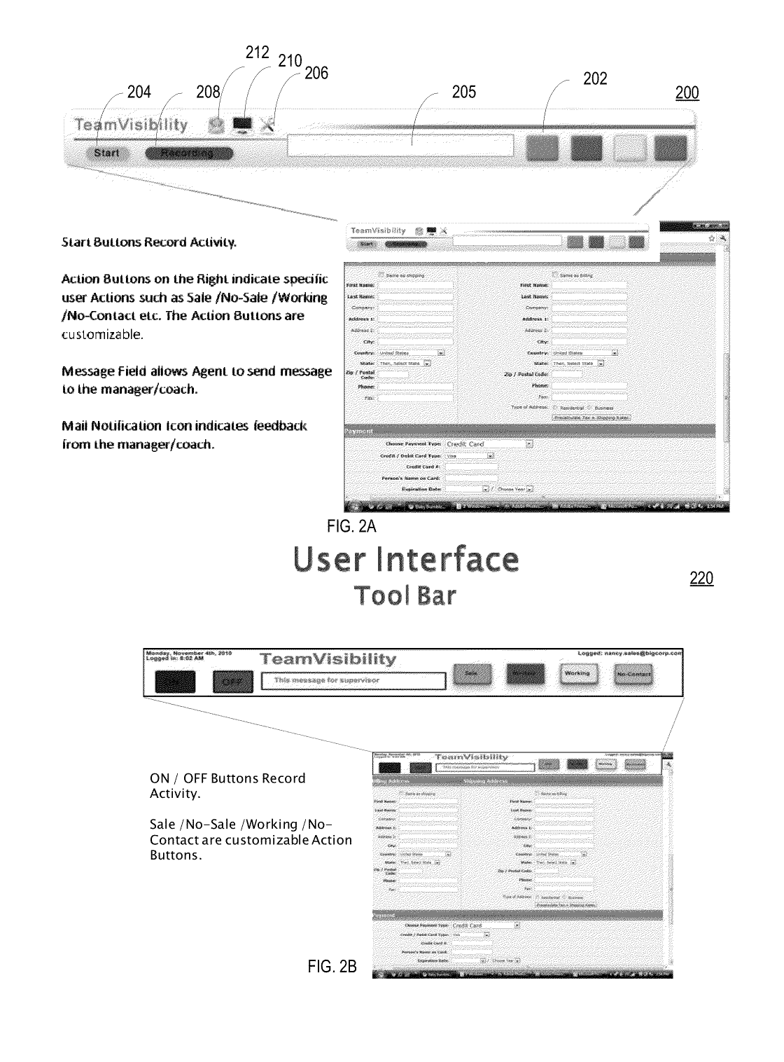

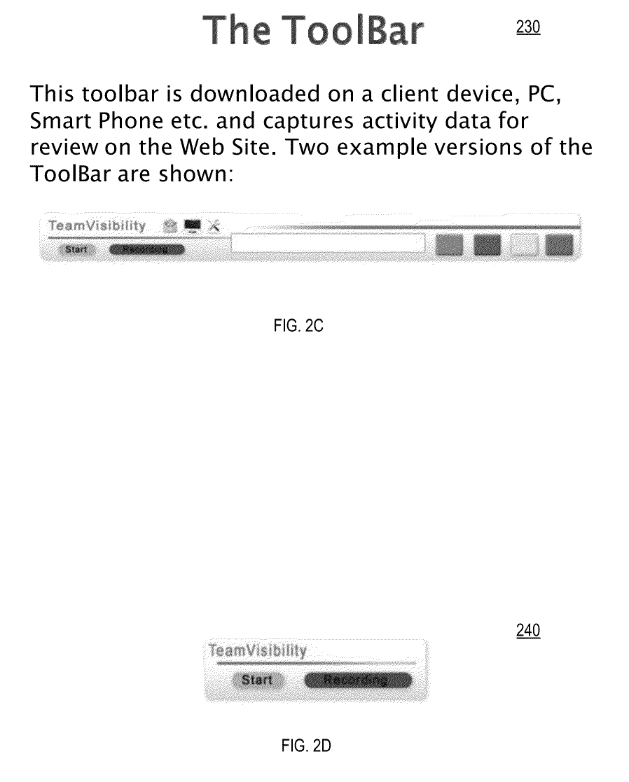

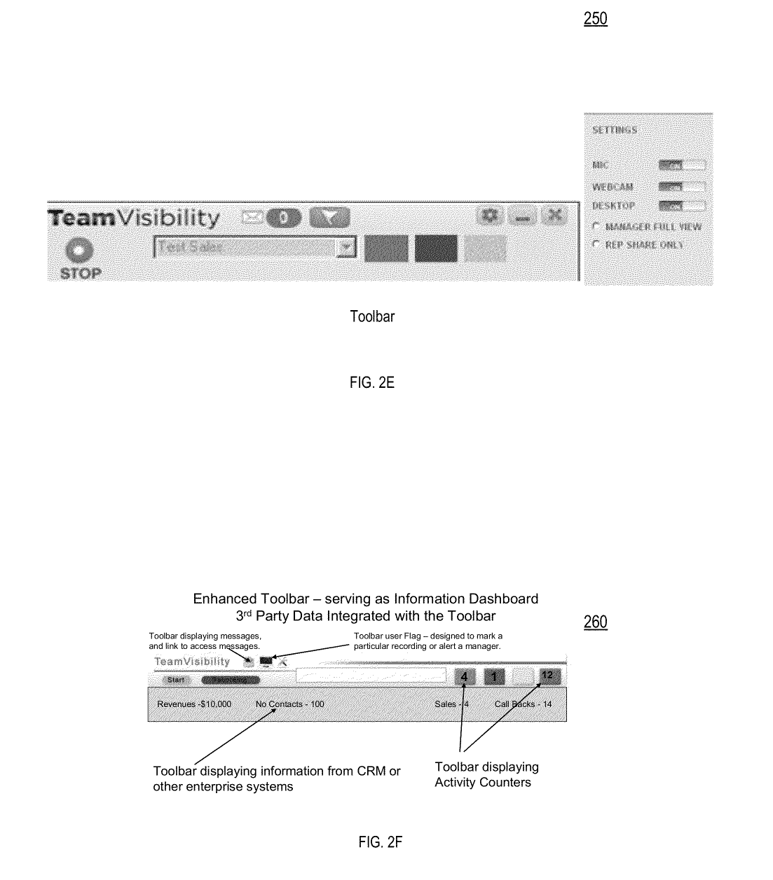

An exemplary computer system platform executing an exemplary software application program, which may reside, in an exemplary embodiment, on a user's computing device 102 may include, but is not limited to, a computing or communications device, desktop/laptop computers, tablet computers, personal digital assistant, telephony, smart-phone, mobile device, tablet, personal digital assistant, handheld and the like, which may in an exemplary embodiment, be responsible for collecting exemplary data/information from the user and the user's computing device relating to an interaction with an exemplary customer, or the like. An exemplary data/Information collection process can be configured to be automated, periodic, user initiated or any combination thereof, according to an exemplary embodiment. According to an exemplary embodiment, the version of the software program, which may be named an exemplary ToolBar, may be displayed on a user's computing/communications device 102 as shown in FIGS. 2A-2D, according to exemplary embodiments. In an exemplary embodiment, the exemplary toolbar may be a browser based toolbar. In another exemplary embodiment, the toolbar may be an applet, or other application program that may be provided in any of various well known ways, such as, e.g., but not limited to, an Internet browser-based toolbar, a JAVA applet, an ANDROID Application, an iPOD or iPAD application, or the like, etc.

Exemplary Data/Information which may be collected, according to an exemplary embodiment, may fall into two exemplary, but non-limiting categories:

A. Exemplary System-generated information, according to an exemplary embodiment, may be collected without any user intervention, according to an exemplary embodiment, which may include, but is not limited to:
An exemplary Snapshot of the users computing device screen;
An exemplary Image acquired by the webcam/camera on the users computing device;
An exemplary Audio recording by the user's computer microphone or heard on the computer speakers;
An exemplary catalog of software programs running on the users' computing device.
An exemplary catalog of web sites visited on the users computing device; and/or
An exemplary geo-location based on the GPS, if present, in the users computing device.

B. Exemplary User-generated information, according to an exemplary embodiment, may be collected, according to an exemplary embodiment, with user input, which may include, but is not limited to:

Exemplary Activity Indicator(s), see FIGS. 2A-2D (collectively 2), where an exemplary activity action button(s) 202 may be illustrated on an exemplary application software program executed on an exemplary computer system platform, which may be selected by a user using, e.g., but not limited to, a mouse or stylus selection, click, etc.).

Exemplary Messages which May be Typed, See FIG. 2, 205 (Exemplary Text Field on the ToolBar).

Exemplary Call Indicators, see FIG. 2, start button 204, recording button 208, configure/setup 206, capture screen 210, message indicator 212, (exemplary but nonlimiting icons on the ToolBar).

According to an exemplary embodiment, each exemplary data element collected may be uniquely identified by, e.g., but not limited to, a unique identifier, a users' unique login name, and a date and/or time stamp. According to an exemplary embodiment, in addition, to storing for example all data elements, the system can create a ‘message’ which may contain exemplary Metadata (meta-content), i.e., information about the information being captured.

According to an exemplary embodiment, the aforementioned information may be collected on a pre-determined schedule and/or based on user input and may be stored on the local computing device. According to an exemplary embodiment, the information collection system may monitor the availability of network bandwidth and according to an exemplary embodiment, may during low usage, opportunistically forward the information to the exemplary cloud computing storage and/or analysis system(s). According to an exemplary embodiment, all or a portion of the exemplary data elements may be uploaded to an exemplary Cloud Storage System 104, 114, and the Metadata message may be sent to the exemplary message processing server 106 on a Cloud based application server 106 according to an exemplary embodiment.

### Additional Exemplary Features

The exemplary software and/or hardware system platform may be designed to periodically communicate with an exemplary cloud/network server, such as, e.g., but not limited to, exemplary management server 110. According to an exemplary embodiment, such exemplary communication may enable, e.g., but not limited to: remote authentication, remote configuration and/or web to ToolBar application system communication.

Exemplary Remote Authentication: According to an exemplary embodiment, the exemplary software system executed on an exemplary computer system processing platform may periodically check with the exemplary server to ensure that the software application and hardware platform system may be properly licensed and/or authorized.

Exemplary Remote Configuration: According to an exemplary embodiment, the exemplary software system executed on an exemplary computing system, may periodically update its configuration by checking with the remote server. Parameters that can be remotely managed include, e.g., but are not limited to: the periodicity of data capture, the types of data capture and definition and/or labeling of activity buttons.

Exemplary Audio Level Quantification: According to an exemplary embodiment, the exemplary software system executed on an exemplary computing system, may continually monitor, e.g., but not limited to, audio levels being recorded and may create an exemplary numeric string to indicate when an actual conversation is occurring versus silence. According to an exemplary embodiment, this exemplary data element may be included in the data elements being uploaded to the cloud storage facility to remote storage 104, 114.

Exemplary Calling Integration: According to an exemplary embodiment, the exemplary software system executed on an exemplary computing system, can be configured to make exemplary phone calls using, e.g., but not limited to, a number of systems, including, but not limited to: voice over Internet Protocol (VoIP) systems on, e.g., the user's computing device, such as, e.g., but not limited to, Skype, Google Talk etc., or any other such as, e.g., but not limited to, Web-based VoIP systems, or the like. In each of these cases the systems may mark the activity as an exemplary inbound or an outbound call, may record the conversation and may send, e.g., all call related data elements to the cloud storage 104, 114.

### Exemplary Cloud/Network Storage Facility 104, 114

According to an exemplary embodiment an exemplary cloud/network storage facility 104, 114, may allow, e.g., but not limited to, direct up-load of data from user computing devices 102. According to an exemplary embodiment, many exemplary commercial cloud service providers may be used such as, e.g., but not limited to, Amazon, Rackspace, Microsoft and/or many others as will be apparent to those skilled in the art, offer such capabilities.

### Exemplary Message Processing System 106 and Exemplary Database Management System Server 108

According to an exemplary embodiment, an exemplary cloud/network based application server which may receive messages, containing metadata, from the user data collection software FIG. 1 (A), reads the message and updates the database FIG. 1(D) with information about the data elements being stored in the cloud/network storage facility.

### Exemplary Remote Management System 110

According to an exemplary embodiment, an exemplary cloud/network based management application server 110 may, e.g., but not limited to, periodically check the validity, etc. of exemplary user data collection software system data and/or content and may perform remote configuration of the exemplary user data collection software on the exemplary collection device 102.

### Exemplary Analysis/Viewing/Reporting/Alerts System 112

According to an exemplary embodiment, the exemplary data elements/content collected from the user data collection software system 102, may be processed, including, e.g., but not limited to, being made available for, e.g., but not limited to, exemplary analysis, exemplary viewing, exemplary reporting and exemplary managing of exemplary alerts in the exemplary system 112.

### Exemplary Analysis Functions:

According to an exemplary embodiment, the exemplary analysis functions, which may be incorporated in the system may be organized around the data collected and may include, but are not limited to:
Exemplary Audio Analysis: According to an exemplary embodiment, the exemplary audio data may be processed through exemplary voice recognition software and the exemplary audio files may be transcribed. Exemplary transcribed files may be made available for exemplary keyword recognition and/or exemplary foreign language translation, etc.
Exemplary WebCam Image Analysis: According to an exemplary embodiment, the exemplary Web cam images may be subjected to exemplary image analysis to determine, e.g., but not limited to, the identity of the user, and/or to determine how often the user was at his or her desk, etc. According to an exemplary embodiment, the exemplary ‘@Desk Percentage’ is an may be calculated and provided as an exemplary element of the reporting mechanism.
Exemplary ScreenCapture Analysis: According to an exemplary embodiment, the exemplary desktop or screen captured images may be analyzed to determine, e.g., but not limited to, what software applications, activities and actions are being used/performed by the user at the time of capture. According to an exemplary embodiment, the exemplary data and processing may include identifying open software windows, sites visited, and/or browser history, etc.

### Exemplary PRODUCT INTEGRATION CAPABILITIES

According to an exemplary embodiment, the exemplary system according to an exemplary embodiment may be integrated into other applications as a feature of such other application systems, such as, e.g., but not limited to, in various exemplary broad areas, including, but not limited to:

Use the exemplary toolbar and analysis product/system to build a full blown CRM system around it;

Use the exemplary toolbar and analysis product/system to build a VoIP solution ala Skype GoogleTalk;

Use the exemplary toolbar and analysis product/system to build a Web-based Telco/CRM system—combining elements of SalesForce.com and Voxeo or SalesForce.com and a Telco provider's offerings; and/or

Use the exemplary toolbar and analysis product/system to build a collaboration tool aka Lotus Live, Microsoft Exchange/Sharepoint.

According to an exemplary embodiment, the exemplary, an exemplary employee or user activity management system may be provided according to an exemplary embodiment. According to an exemplary embodiment, a virtual organization or company, or distributed organization or company may bring together the management of such distributed employee or users via an exemplary system. According to an exemplary embodiment, all exemplary employee or user activity may be recorded in the system. According to an exemplary embodiment, the exemplary system may also enable an employee or user to add files, emails and other documents into the system. According to an exemplary embodiment, exemplary feedback from peers and/or supervisors, and/or managers and/or coaches, and/or other users, etc. can be directly recorded in, e.g., the employee or user's files and/or records, by, e.g., but not limited to, using Voice and/or text Notes in the system, and/or calling a phone number and/or mailbox and leaving a general message which may become an exemplary part of the exemplary employee or user record.

According to an exemplary embodiment, in an exemplary pure audio capture mode, the exemplary system may incorporate VoIP detection and/or may mark a call as, e.g., a VoIP call when a VoIP process is detected by the software. According to an exemplary embodiment, the exemplary software and/or system may scan, e.g., but not limited to, incoming network traffic and may mark, e.g., but not limited to, SIP and/or other messaging protocol messages, etc., as indicators of an exemplary VoIP Call.

Exemplary Voice Filtering: According to an exemplary embodiment, when and exemplary one person in an exemplary call declines to be recorded, further processing may be performed to ensure such person's communications are not recorded. According to an exemplary embodiment, if on an exemplary 2 channel call, the decliner's call may be deleted. According to an exemplary embodiment, if on an exemplary single channel call a voice print may be taken from the customer and the decliner's voice voice may be deleted. Other processing so as to filter audio may be performed.

According to an exemplary embodiment, an exemplary system may provide for users an ability to leave exemplary notes directly in the exemplary member detail area—such as, e.g., but not limited to, by the employee or user for his or her own recall/reference, and/or by the coach/manager/supervisor/peer, etc.

According to an exemplary embodiment, the exemplary features may in an exemplary embodiment all be under user control and can be selectively and/or completely turned on or off, in one exemplary embodiment. According to an exemplary embodiment, user configurability may be set at a user level, such as, e.g., but not limited to, a client user, a team member user, a supervisor user, a coach user, and/or a manager user, etc. According to an exemplary embodiment, the exemplary recorder sessions can be deleted by the user, e.g., but not limited to, on demand, and/or, as needed. According to an exemplary embodiment, a user may be permitted to review a locally stored session prior to transfer to a remote storage facility, in one exemplary but nonlimiting embodiment.

Exemplary TYPES OF Exemplary CALLS/AUDIO RECORDING may include, e.g., but not limited to:

Exemplary PLAIN AUDIO Open-ended audio recording from the mic and/or Speaker;

Exemplary VoIP DETECTION ONLY Open-ended audio recording from Mic, but Toolbar may detect, e.g., SIP protocol on a VoIP call and may mark the audio recording with, e.g., but not limited to, the call start and stop time stamp;

Exemplary VoIP INTEGRATION Integrated VoIP audio recording—recording may, e.g., only occur when VoIP software comes alive, inbound/outbound status is recorded along with telephone numbers, duration and/or multichannel recording; and/or

Exemplary WEB Based/TELCO a call may be placed, according to an exemplary embodiment, from the ToolBar. The exemplary toolbar, may in an exemplary embodiment effectively initiate an exemplary conference call by calling the user on a cell phone, POTS, VoIP, and/or other line, etc., and/or the customer. According to an exemplary embodiment, the exemplary multi-channel call may actually recorded on the TELCO cloud. According to an exemplary embodiment, the exemplary recording (and/or a portion thereof) may be made available to the ANALYZING/VIEWING SYSTEM 112, e.g., directly and/or indirectly from the cloud and/or storage, in an exemplary embodiment.

### Exemplary Product Usage for Features of the Exemplary Embodiments

The aforementioned system can be used to achieve multiple exemplary objectives of various example, but nonlimiting embodiments:

### Exemplary Sales & Customer Service Environment:

According to an exemplary embodiment, an exemplary successful sales team may require ongoing training, coaching and/or collaboration. The TV System allows the salesperson's activities to be constantly and consistently available to peers, coaches and management for feedback, coaching and determining best practices. This creates a very powerful tool to archive the best practices of a company's best sales people and use it for training and coaching. This can also form the basis of collecting and harnessing the intellectual capital of the corporation.

According to an exemplary embodiment, an exemplary ToolBar data can be combined with information contained in a traditional customer relationship management (CRM) system, as well as environmental factors like weather. This combination creates a very potent set of data to analyze an individual's sales performance as well as matching the right customer with the right salesperson.

### Exemplary Contractor Productivity Measurement:

According to an exemplary embodiment, an exemplary tool can enable a service provider or contractor to explicitly show and prove to clients/customers the service providers activity level. When service providers are paid on a time and material basis it is very difficult for either party to trust the other. The TV system provides an objective measure of contractor productivity.

### Exemplary Tutoring and Teaching Environments:

According to an exemplary embodiment, an exemplary large number of students may be poor judges of their own capabilities and can waste a lot of time trying to work on problems they think they know how to solve but don't. By using an exemplary embodiment of the system a teacher or a mentor can review the work in near real-time and make an assessment about the students' ability way before student frustration sets in.

### Additional Exemplary Features

The data collected can be subjected to a number of different analyses. And these in turn can allow for a number of different uses, some of these include:
Exemplary analyzing the volume levels of the audio recording to determine when an actual conversation was taking place. How often was the user engaged in a conversation?
Exemplary analyzing conversational tones for mood detection and in some cases to determine levels of anxiety, stress, calmness etc. What is the user's mood during various times and correlating them with user productivity etc.
Exemplary analyzing webcam images to determine presence of an individual in the image to ascertain amount of time user was at his or her desk.
Exemplary analyzing facial expressions for mood detection.
Exemplary analyzing user's desktop screen images to assess the nature of computing activity engaged by the user. What software applications he or she was using, for how long and with what frequency?
Exemplary analyzing Employee or user Activity Data across industries, functions and within an organization to develop comparative productivity and effectiveness metrics.

FIG. 1A depicts an exemplary view of an exemplary embodiment of an exemplary distributed work force environment using a plurality of computing and communication devices coupled together in a distributed networked system architecture 100.

FIG. 1B depicts an exemplary embodiment of an activity recording, analysis & reporting, management reporting, and manager/coaching system architecture 120, according to an exemplary embodiment coupled together by an exemplary cloud-based architecture network.

FIG. 1C depicts an exemplary embodiment of a system 160 illustrating an exemplary employee or user system including various content capture devices, in an exemplary embodiment, a microphone, screen and webcam are coupled to deliver content captured from the employee or user system over a network such as the Internet to exemplary cloud storage, and further processing and analyzing on various webservers, and for providing access to the analyzed content by other users such as supervisors, managers or coaches of the employee or user, according to an exemplary embodiment coupled together by an exemplary cloud-based architecture network.

FIG. 1D depicts an exemplary embodiment of a diagram 180 illustrating an application programming interface (API) which may be used to interface an exemplary embodiment of a toolbar to other information technology systems such as CRM, sales tracking, ERP, etc, as well as providing access to a marketplace of services such as, e.g., but not limited to, coaching, verifications, audits, etc. and also access to an APP store for accessing on an exemplary subscription, or one-time license cost access to applications, apps, or the like to provide capture, messaging, alerts and/or analysis and viewing functionality.

FIG. 1E depicts an exemplary embodiment of an exemplary system 190 illustrating an exemplary distributed employee or user activity recording system for capturing employee or user activity of an exemplary team member user, whose system is coupled to an exemplary cloud-based network and storage system, itself coupled to exemplary remote storage, an exemplary database management application system, an exemplary messaging system, an exemplary management system, and an exemplary analysis/viewing/reporting/alerts system, as could be used by another exemplary supervisor user to review and coach the activities of the team member user, according to an exemplary embodiment.

FIG. 2A depicts an exemplary embodiment of an exemplary toolbar application software program 200 as may be provided in an exemplary embodiment, including an exemplary user friendly, unobtrusive profile application, various graphical user interface features such as multi-colored (e.g., green, red, yellow, blue) action buttons 202, start recording selector/indicator 204, recording indicator 208, configuration/setup button 206, messaging input field 204, messaging button 212, screencapture button 210, etc.

FIG. 2B depicts an exemplary embodiment of an exemplary toolbar application software program 220 as may be provided in an exemplary embodiment, including exemplary customized buttons, showing an exemplary customer user activity recording environment application, according to an exemplary embodiment.

FIG. 2C depicts an exemplary embodiment of an exemplary toolbar application software program 230 as may be provided in an exemplary embodiment, on a client device such as, e.g., a PC, a computing device, a communications device, a personal digital assistant, a smart phone, a tablet, a color-coded easy to use application or applet, or browser toolbar, including various exemplary indicators, selection buttons, messaging fields, and action and customization selection buttons.

FIG. 2D depicts an exemplary embodiment of a diagram 240 of an exemplary inobtrusive minimized or miniature sized graphical user interface applet, application, gadget, etc. application software program including exemplary but nonlimiting indicators and buttons, of various graphical user interface features, according to another exemplary embodiment.

FIG. 2E depicts a diagram 250 illustrating an exemplary embodiment of an exemplary TeamVisibility graphical user interface toolbar applet, application, gadget, application software program, etc., which may include exemplary but nonlimiting indicators and/or buttons, including various graphical user interface features, which may be used, e.g., for tracking messages, allowing a user to flag a recording, a record start/stop indication for stopping/starting recording, one or more activity counter button(s), which may be color coded or have other indicia to indicate information, which may be collected, various content selector(s) such as, e.g., but not limited to, a toggle or radio button object(s) for selecting, e.g., but not limited to, a mic, a webcam, a desktop screen capture, a manager's full view, and/or rep share only, etc. exemplary views, according to another exemplary embodiment.

FIG. 2F depicts a diagram 260 illustrating an exemplary embodiment of an enhanced exemplary toolbar serving an exemplary information dashboard with exemplary third party data as may be integrated with an exemplary toolbar, illustrating an exemplary toolbar display of exemplary information from an exemplary CRM or other enterprise system, such as, e.g., but not limited to, a number of contacts, gross or net revenues, number of sales, number of callbacks, number of rejections, number of upsells, etc., exemplary indicators for recording, or to start/stop, a user flag, which may be used to mark a particular recording, or to alert a manager, etc., an icon to display and/or access messages; and/or exemplary activity counter(s) icon(s), as may appear on the exemplary toolbar, according to an exemplary embodiment.

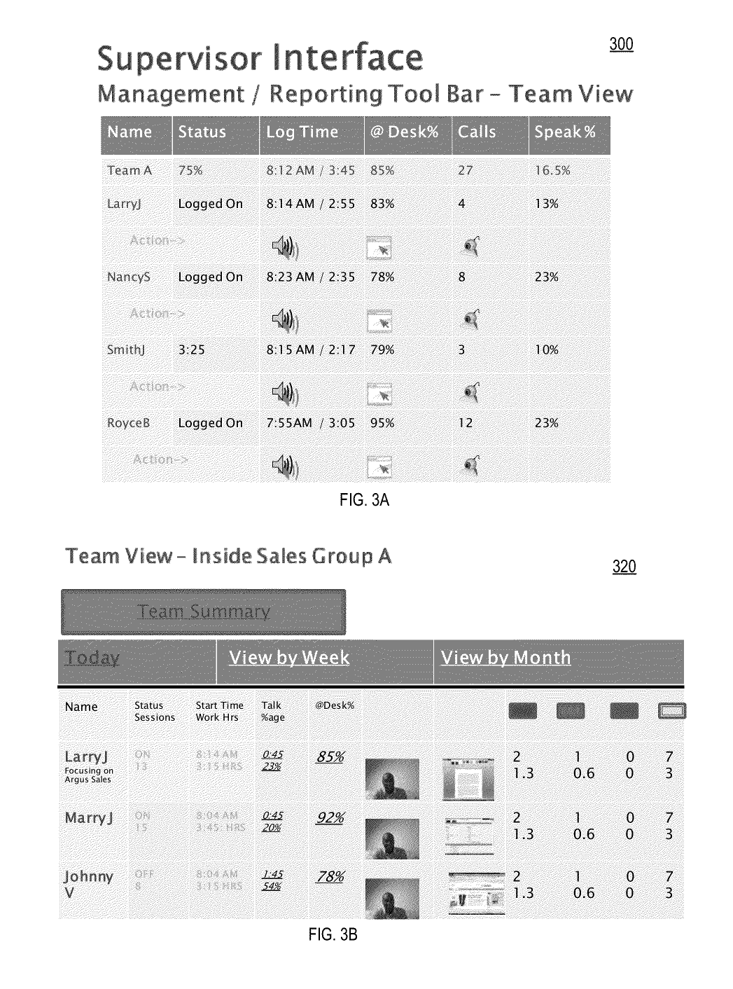

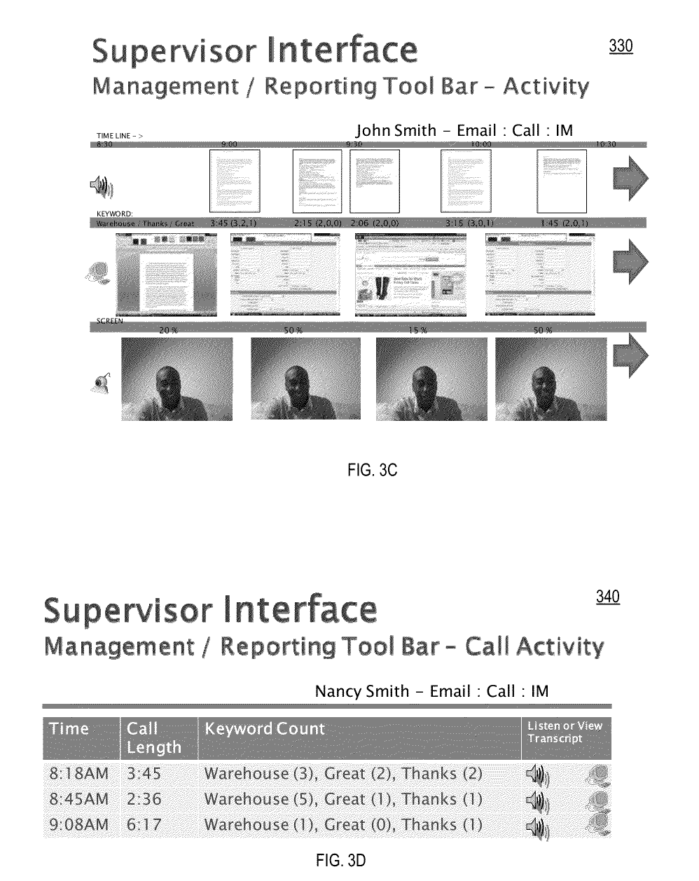

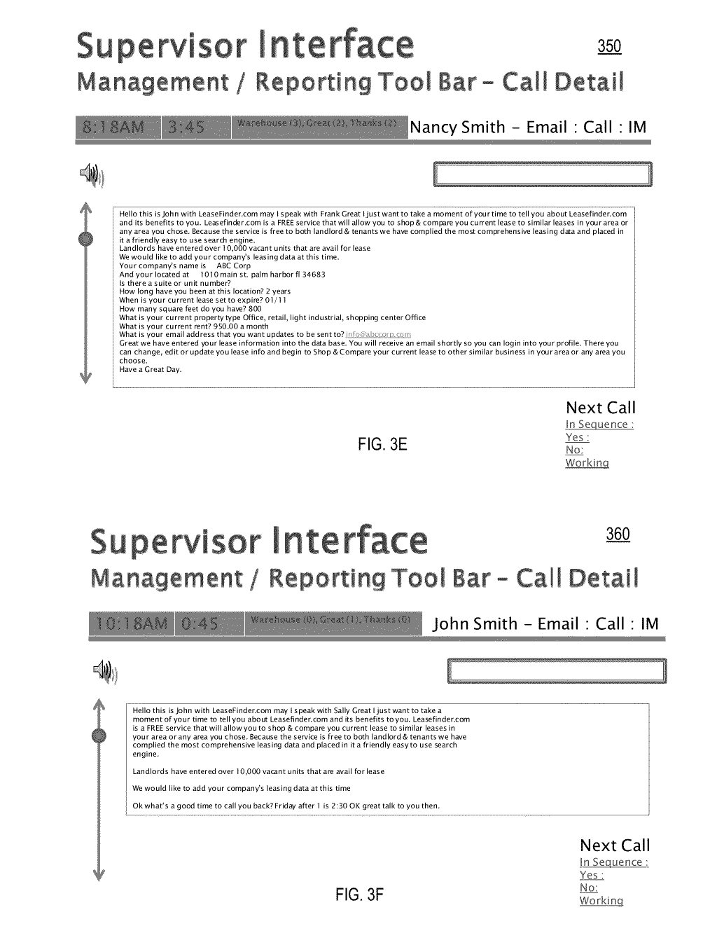

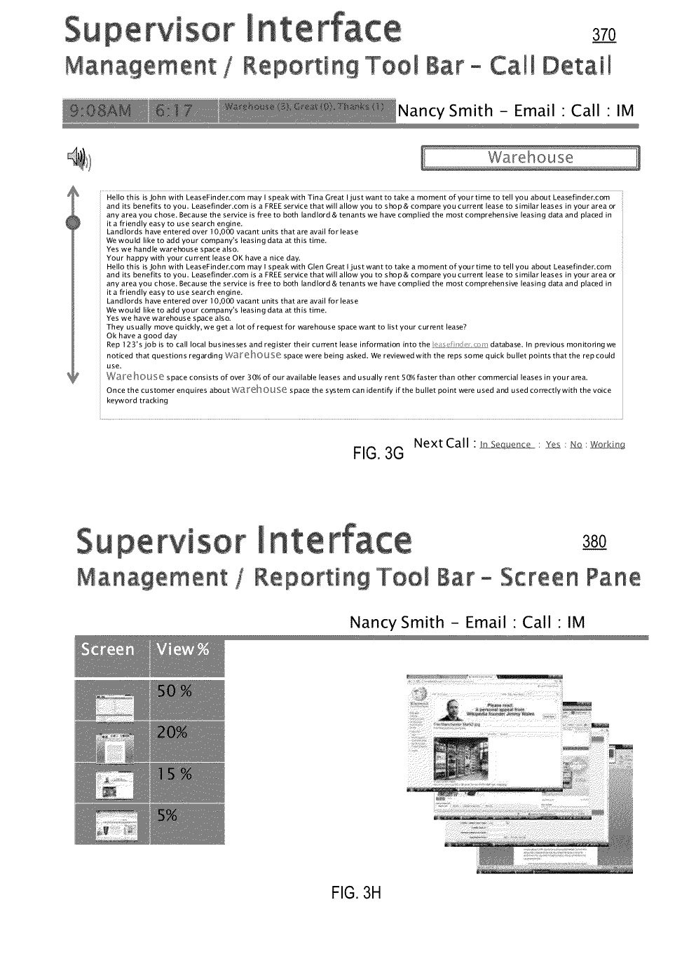

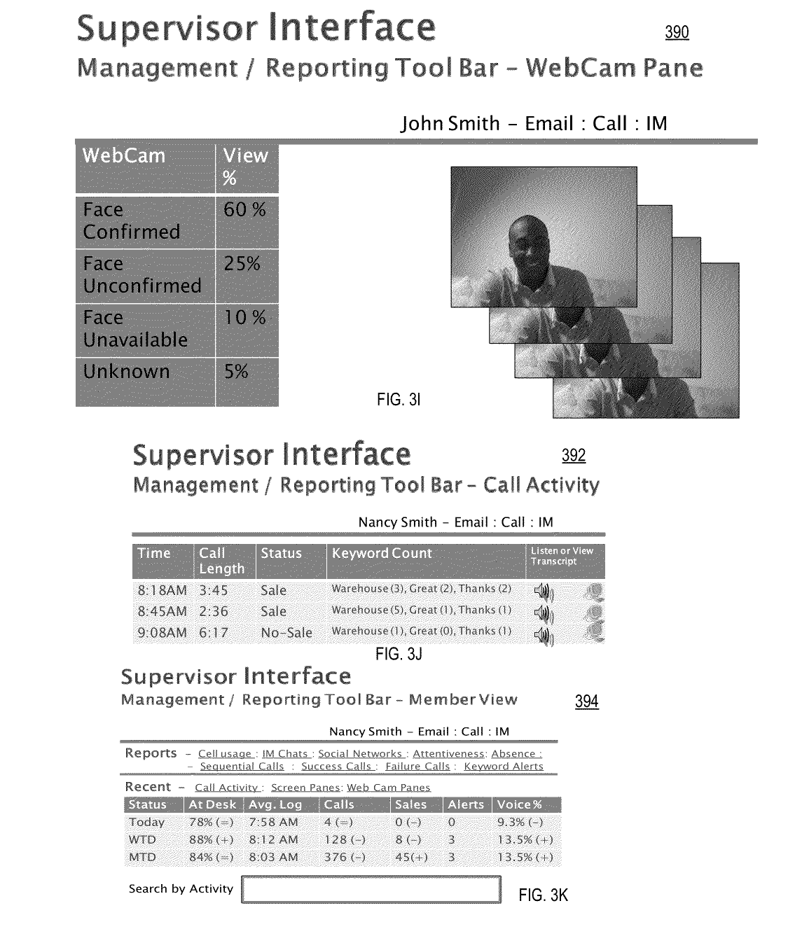

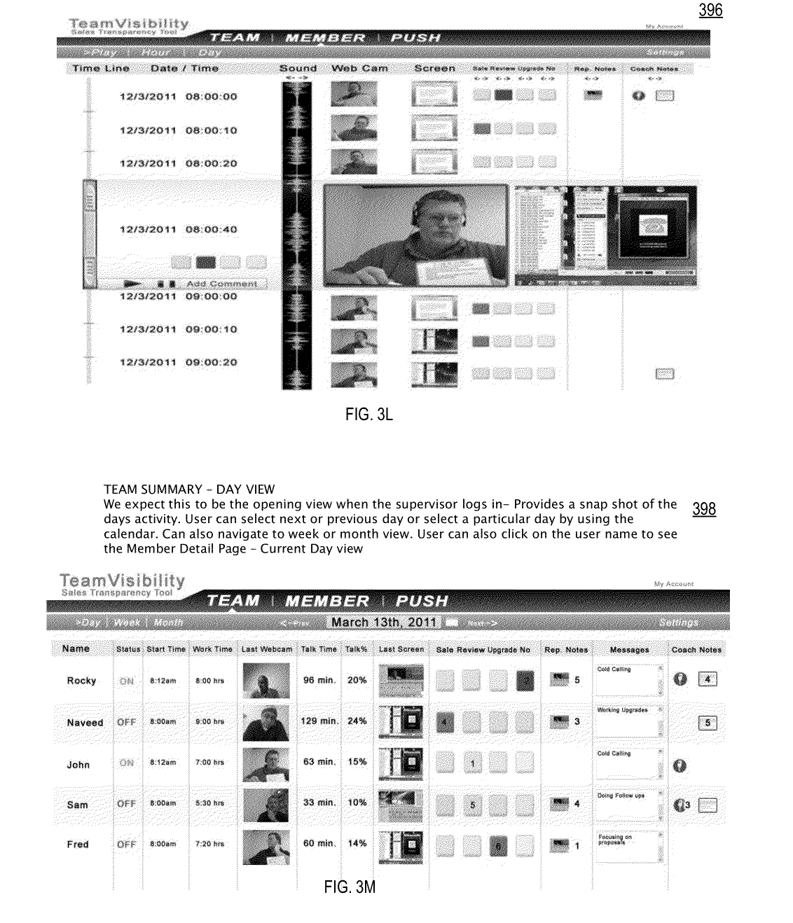

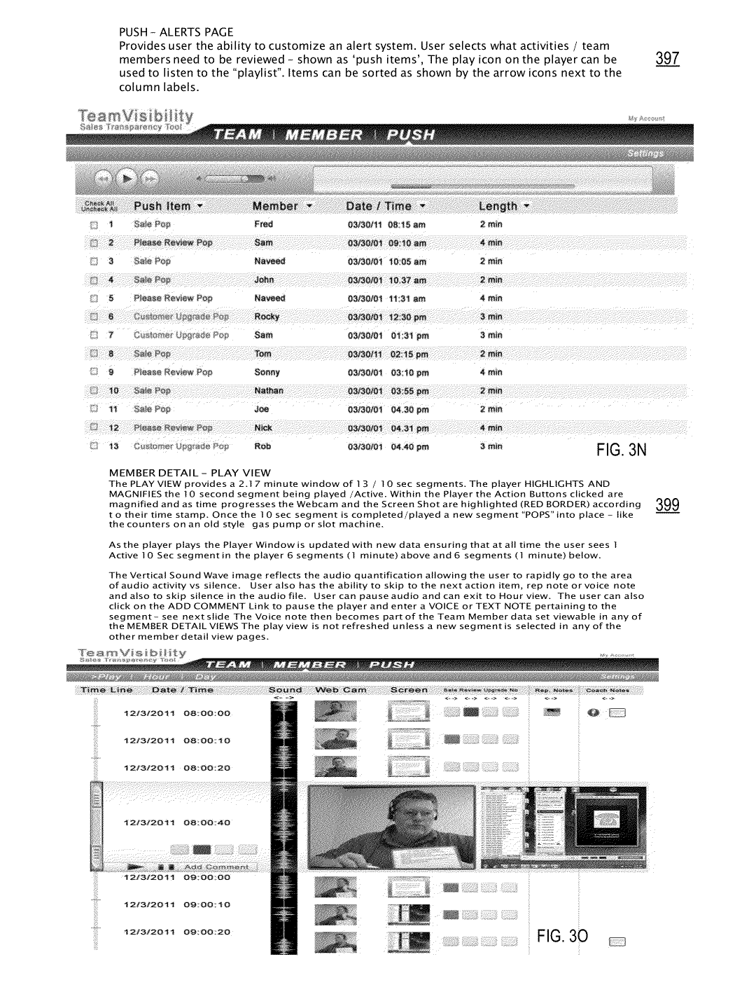

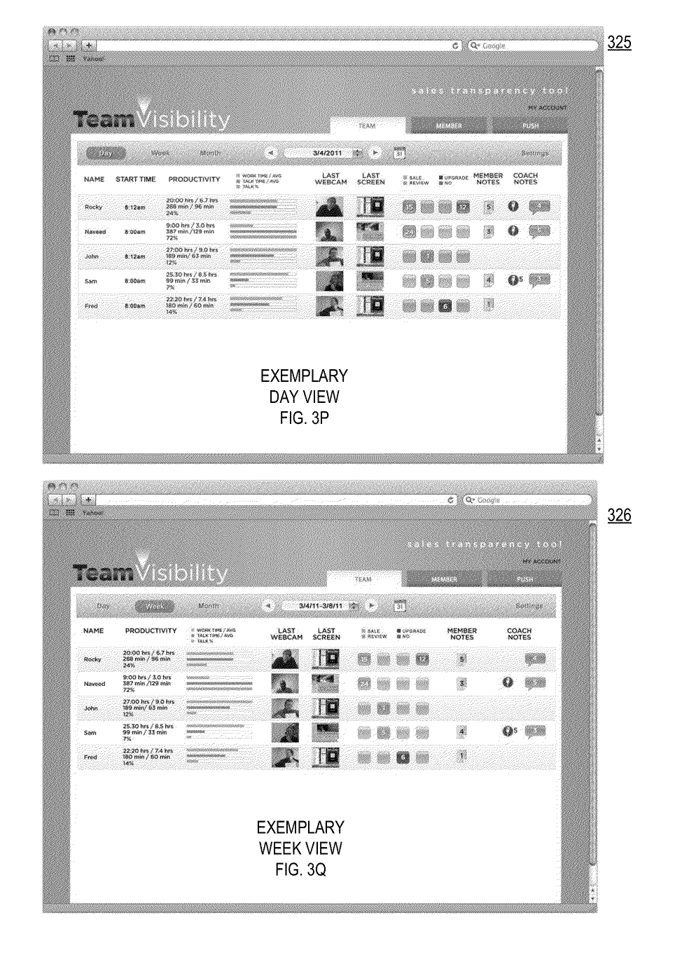

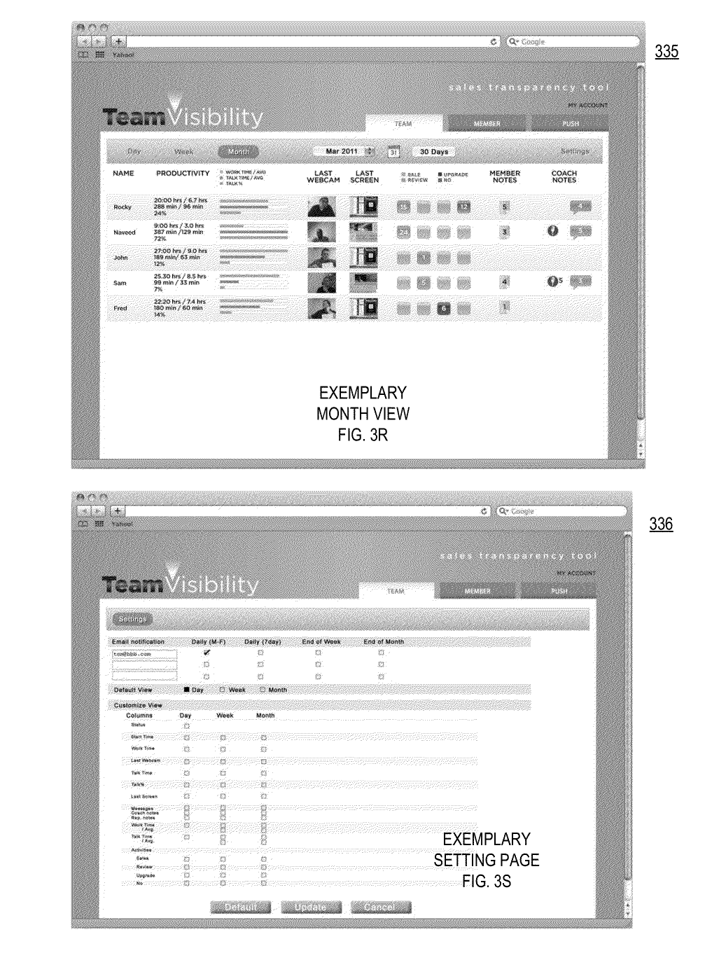

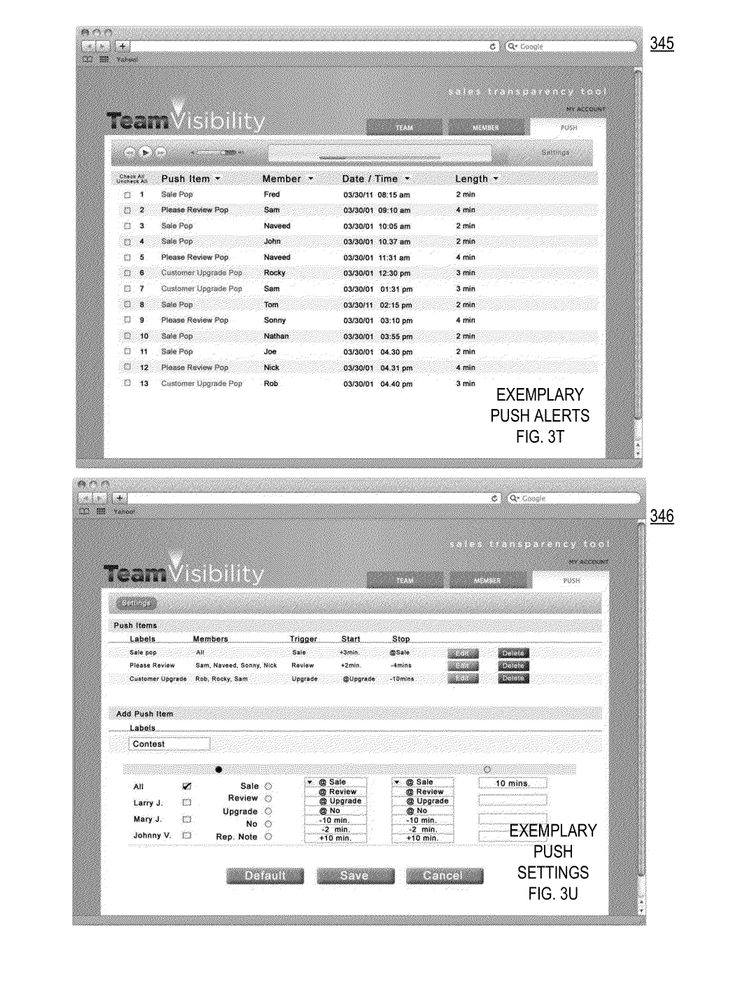

FIG. 3A depicts an exemplary embodiment of a diagram 300 illustrating an exemplary supervisor interface management reporting toolbar in an exemplary teamview 300, including various exemplary analysis, reporting features as may be provided in an exemplary embodiment.

FIG. 3B depicts an exemplary embodiment of a diagram 320 of an exemplary supervisor interface management indicating an inside sales group, including exemplary day, week and monthly views and compiled data as gathered from an exemplary employee or user toolbar, according to an exemplary embodiment.

FIG. 3C depicts an exemplary embodiment of a diagram 330 of an exemplary supervisor interface management/reporting tool bar indicating exemplary activity by an exemplary employee or user, including exemplary captured audio, captured screens, and captured images of the team member, according to an exemplary embodiment.

FIG. 3D depicts an exemplary embodiment of a diagram 340 of an exemplary supervisor interface management/reporting tool bar indicating exemplary call activity providing exemplary summaries of call activity by an exemplary employee or user, including time of call, exemplary duration, exemplary keyword counts, exemplary audio or textual transcripts and/or screen shots.

FIG. 3E depicts an exemplary embodiment of a diagram 350 of an exemplary supervisor interface management/reporting tool bar indicating exemplary call detail for an exemplary employee or user, including an exemplary captured transcript, email, or instant message (IM) message, call statistics, etc., according to an exemplary embodiment.

FIG. 3F depicts an exemplary embodiment of a diagram 360 of an exemplary supervisor interface management/reporting tool bar indicating exemplary call detail by an exemplary employee or user, including exemplary captured audio, email, or instant message (IM) message, call statistics, etc., according to an exemplary embodiment.

FIG. 3G depicts an exemplary embodiment of a diagram 370 of an exemplary supervisor interface management/reporting tool bar indicating exemplary call detail activity, where a transcript of the call has been captured/analyzed, and a keyword “warehouse” has been searched, according to an exemplary embodiment.

FIG. 3H depicts an exemplary embodiment of a diagram 380 of an exemplary supervisor interface management/reporting tool bar indicating exemplary screen pane activity, where a frequency of screen capture images is indicated for a given user, according to an exemplary embodiment.

FIG. 3I depicts an exemplary embodiment of a diagram 390 of an exemplary supervisor interface management/reporting tool bar indicating exemplary web cam (or other camera captured image) pane activity, where a frequency of web cam images, along with facial recognition processing data indication is indicated for a given user, according to an exemplary embodiment.

FIG. 3J depicts an exemplary embodiment of a diagram 392 of an exemplary supervisor interface management/reporting tool bar indicating exemplary call activity, where a status and keyword count of transcripts is provided as well as access to recorded transcripts for various call segments of a given user, according to an exemplary embodiment.

FIG. 3K depicts an exemplary embodiment of a diagram 394 of an exemplary supervisor interface management/reporting tool bar indicating exemplary member view, where various call activity, screen pane and web cam pane activity may be summarized, as well as various reports may be accessed regarding cell usage, IM chats, use of social networks, attentiveness indications, absence, sequential calls, successful calls, unsuccessful calls, keyword alerts, etc., may be searched, by keyword of transcripts for a given member user, according to an exemplary embodiment.

FIG. 3L depicts an exemplary embodiment of a diagram 396 of an exemplary supervisor interface management/reporting tool bar indicating exemplary member view, where various captured audio call activity, screen pane and web cam pane activity may be viewed via graphical user interface display of an exemplary timeline indicating call segments, and a selected magnified area for a selected call segment, including providing for adding comments, by, e.g., but not limited to, text or via voice recording, etc., by a coach/manager/supervisor, as well as review of the team member's action button selections, screen shot and web cam image of the team member, according to an exemplary embodiment.

FIG. 3M depicts an exemplary embodiment of a diagram 398 of an exemplary supervisor interface management/reporting tool bar indicating exemplary team view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment.

FIG. 3N depicts an exemplary embodiment of a diagram 397 of an exemplary supervisor interface management/reporting tool bar indicating exemplary push-alerts page view, providing the supervisor the ability to provide customized alerts, listing exemplary push activities, by team member, as well as the date/time and length of the segment, according to an exemplary embodiment.

FIG. 3O depicts an exemplary embodiment of a diagram 399 of an exemplary supervisor interface management/reporting tool bar indicating exemplary member detail play view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment.

FIG. 3P depicts a diagram 325 illustrating an exemplary embodiment of a diagram of an exemplary supervisor interface management/reporting tool bar indicating exemplary team day view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment.

FIG. 3Q depicts a diagram 326 illustrating an exemplary embodiment of a diagram of an exemplary supervisor interface management/reporting tool bar indicating exemplary team week view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment.

FIG. 3R depicts a diagram 335 illustrating an exemplary embodiment of a diagram of an exemplary supervisor interface management/reporting tool bar indicating exemplary team month view, where various captured audio call activity, screen pane and web cam pane activity may be viewed for an entire exemplary team, including summarized data, comparative statistics, status, work time, talk time, talk percentage, last viewed screen, summarized activity button selections, any rep notes, messages, coaches notes, in a graphical user interface display of an exemplary team, according to an exemplary embodiment.

FIG. 3S depicts a diagram 336 illustrating an exemplary embodiment of a diagram of an exemplary supervisor interface management/reporting tool bar indicating exemplary team setting page view, where various settings may be adjusted, according to an exemplary embodiment.

FIG. 3T depicts a diagram 345 illustrating an exemplary embodiment of a diagram of an exemplary supervisor interface management/reporting tool bar indicating exemplary push alerts, where various alerts may be reviewed, according to an exemplary embodiment.

FIG. 3U depicts a diagram 346 illustrating an exemplary embodiment of a diagram of an exemplary supervisor interface management/reporting tool bar indicating exemplary push settings page view, where various push settings may be adjusted, according to an exemplary embodiment.

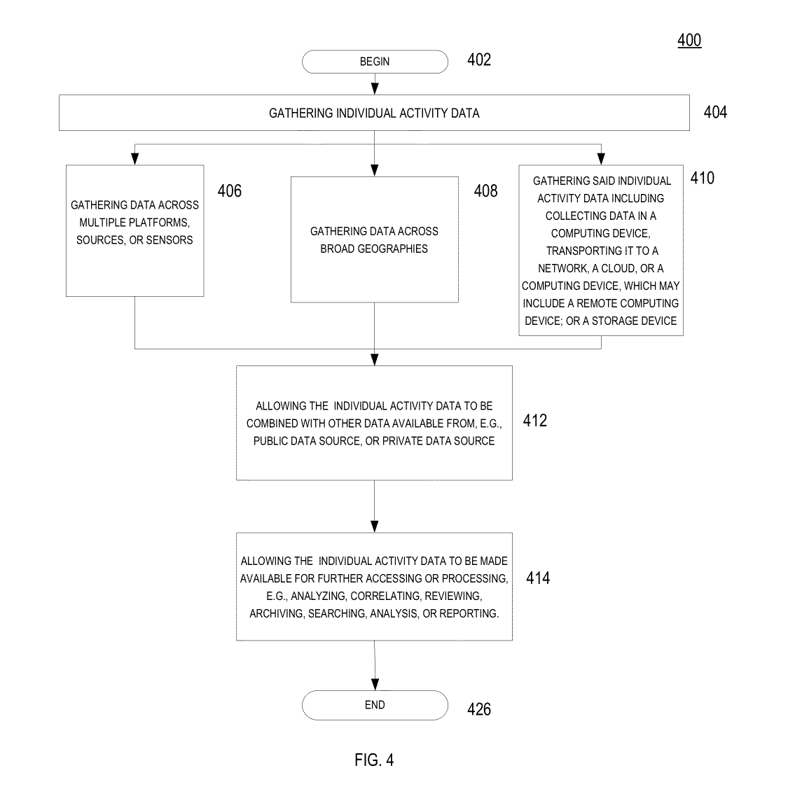

FIG. 4 depicts an exemplary flow diagram 400, according to an exemplary embodiment illustrating an exemplary process of gathering user activity data. According to an exemplary embodiment, an exemplary process 400 may begin with 402, and may continue with 404.

In 404, in an exemplary embodiment, individual activity data may be obtained, or gathered, such as, e.g., but not limited to, captured. Any of various exemplary capture or gathering subsystems or methods may be employed including, e.g., but not limited to, 406, 408, and/or 410. From 406, 408, and/or 410, flow diagram 400 may continue with 412.

In 406, gathering may be performed across multiple platforms, sources, or sensors. According to one exemplary embodiment, data may be captured at a user station.

In 408, gathering may be performed across broad geographies. According to an exemplary embodiment, users may be geographically disperse, however, using exemplary embodiments, via a client server, or peer-to-peer network, distributed users may be provided access to recorded content.

In 410, gathering data may include collecting data in a computing device, transporting the content to a network, a cloud, a remote device, or other networking, communications, and/or computing device, and/or a storage device.

In 412, process 400 may include allowing individual activity data to be combined with other data, such as, e.g., but not limited to, public, and/or private, data sources may provide data to be combined with the activity data. From 412, flow diagram 400 may continue with 414.

In 414, the process 400 may include allowing the individual activity data to be made available for further access, or processing, such as, e.g., but not limited to, analyzing, correlating, reviewing, searching, archiving, analysis, or reporting, etc. From 414, flow diagram 400 may continue with 426, and my immediately end, according to one exemplary embodiment.

Exemplary Team Visibility™ may enable unparalleled transparency into the Sales Process, which may allow for:
Call Quality Transparency;
Simplified Sales Metric Reporting; and/or
Superior Coaching tools.

Exemplary TeamVisibility solution may feature:
User Simplicity;
Ease of implementation; and/or
Extensive tool set for using user transparency information for efficiency, effectiveness analysis, and coaching.
Optional:

Easily Customizable user tools; and

Seamless integration with existing CRM; or other IT systems.

### Exemplary User Interface—Exemplary Toolbar:

Start Buttons may Record Activity;

Action Buttons on the Right may indicate specific user Actions such as Sale/No-Sale/Working/No-Contact etc.;

The Action Buttons may be customizable;

Message Field may allow Agent to send message to the manager/coach; and

Mail Notification Icon indicates feedback from the manager/coach

### Exemplary System Overview—Enhanced Features:

With the addition of programmable TeamVisibility Action buttons—the reporting and coaching tools are greatly enhanced.

Action Buttons essentially may “mark” a call with a certain “event”—which can enhance the use of the coaching & supervisor tools.

Programmable Action Buttons:

Can be clicked on TeamVisibility toolbar;

Can be programmed to be voice activated;

Can be integrated into CRM with API interface; and/or

For example, each agent may mark a call (or it can be fed from the CRM) to categorize each call with:

Sale,

No-Sale,

Working, and/or

No Contact.

### Exemplary Hyper-Efficient Coaching

This may allow the supervisor to enhance their management and coaching screens with key metrics.

May also allow for hyper efficient call monitoring. For example—let me “speed review” calls where there was “No Sale”—and the word Warehouse was discussed.

### Exemplary API & Marketplace

TeamVisibility provides a platform for third party service providers, consulting firms and software developers to provide a plethora of value-added tools and services'.

The platform may include two elements in an exemplary embodiment:
An API which may allow:

a secure, open access to the TeamVisibility toolbar through the API allows CRM platforms and other enterprise systems to be tightly integrated with the TeamVisibility Solution.
A Marketplace which may allow:

service providers and consultants to provide a wide array of services including; coaching, verifications, audits etc.
An APP Store which may allow:

software developers to provide complementary software applications.

Examples of APPS:
Foreign Language Translation;
Random Team Monitoring by Type;
Remote Coaching Services;
Optimal Contact analysis (time of day, etc);
Best Practice/keyword correlations;
Verifications;
Smart Phone “Outside” sales integration;
SIC lead optimizer;
Ipad App;
Email Summary Platform;
Agent Day Slideshow;
Transcription service integration; and/or
Peer review.

Exemplary embodiments of the toolbar may be downloaded on a client device such as, e.g., but not limited to, a workstation, a PC, a Smart Phone, a mobile device, a phone, a communications device, a computing device, a peer-to-peer device, a client device, etc. and/or may capture activity data for review on, e.g., the Web Site. Two example versions of the ToolBar are shown in various embodiments, a first with start button, recording button, a search field, one or more programmable action buttons, one or more buttons which may be used for sending a message, capturing a screen or other image by user selection, and/or customizing features, etc., among other features. A second exemplary toolbar may have less buttons, but may at least allow for starting of capture/recording, and an indication that recording is being made. In some embodiments, more or less features may be included.

### Exemplary Supervisor Section:

An exemplary collection of pages, which may be available in an exemplary reviewing system for an exemplary user/manager/team-leader/supervisor, etc. The pages may enable the supervisor to, e.g., but not limited to:
1) Review and analyze team data by day/week/month. (Using TEAM TAB);
2) Review & Analyze team member data by minutes/hour/day/week & month. (Using MEMBER TAB);
3) Provide coaching and feedback for team members. (Using VOICE/TEXT Notes in MEMBER TAB Play Section); and/or
4) Review Team Activity in near-real time. (Using PUSH TAB).

Exemplary TEAM SUMMARY-DAY VIEW

An exemplary opening view when the supervisor logs in may appear as shown in an exemplary team summary day view, which may provide a snapshot of the day's activity. An exemplary user can, e.g., but not limited to, select next or previous day or select a particular day by using the calendar. The user can also navigate to exemplary, but nonlimiting, other time periods such as, e.g., week, month, quarterly, and/or annual, etc. views. A user can also, according to an exemplary embodiment, click on the user name to see the exemplary Member Detail Page-Current Day view.

Exemplary PUSH-ALERTS PAGE

An exemplary push alerts page may provide a user the ability to customize an alert system, in an exemplary embodiment. A user may select what activities/team members need to be reviewed—shown as ‘push items’ in one embodiment. The exemplary play icon on the player can be used to listen to the “playlist,” according to an exemplary embodiment. Items can be sorted as shown by arrow icons next to the column labels, according to exemplary embodiments of the exemplary system.

Exemplary MEMBER DETAIL-PLAY VIEW

An exemplary embodiment of the PLAY VIEW may provide an exemplary, but nonlimiting, 2.17 minute window of exemplary 13/10 sec segments. The player may use an exemplary user interface indication or selection to HIGHLIGHT AND/OR MAGNIFY the exemplary 10 second segment being played/Active, in an exemplary embodiment. Within the Player the Action Buttons clicked may be magnified and as time progresses the Webcam and the Screen Shot may be highlighted (with e.g., but not limited to, a border such as, e.g., but not limited to, a RED BORDER) according to the elements exemplary time stamp. In an exemplary embodiment, once the 10 sec segment is completed/played a new segment may “POP” into place—like the counters on an old style gas pump, or slot machine, or the like, etc.

As the player plays the Player Window may be updated with new data ensuring that at all time the user sees at least, but not limited to, 1 Active exemplary 10 Sec segment in the player, with an exemplary 6 segments (e.g., 1 minute) above, and exemplary 6 segments (e.g., 1 minute) below, etc.

In an exemplary embodiment, the Vertical Sound Wave image may reflect the audio quantification allowing the user to rapidly go to the area of audio activity vs. silence. In an exemplary embodiment, the user may also have the ability, e.g., to skip to the next action item, rep note, or voice note and also to skip silence in the audio file. In an exemplary embodiment, the user can pause audio and can exit to an exemplary Hour view. In an exemplary embodiment, the user can also click on the ADD COMMENT Link to, e.g., but not limited to, pause the player and/or enter, e.g., but not limited to, a VOICE, or TEXT NOTE (and/or video or other content message, link, etc.) pertaining to the segment. In an exemplary embodiment, the Voice note may then become part of the Team Member data set viewable in any of the MEMBER DETAIL VIEWS. In an exemplary embodiment, the play view may not be refreshed unless a new segment is selected in any of the other member detail view pages.

Exemplary Team Member Section

This is a collection of pages available for the team-member. The pages may enable the user to:
1) Review & Analyze his or her data by minutes/hour/day/week & month. (Using MEMBER TAB); and/or
2) Review Feedback Notes on his or her activity. (Using NOTES TAB).

Exemplary MEMBER DETAIL-HOUR VIEW

In an exemplary embodiment, a Detail View by Hour may provide a more magnified main view which may allow itemized and detailed view of the team members activities for a particular hour. User can click on the voice note icon to listen to the voice note in a POP-UP player. Team Member messages from the Toolbar may be shown on the time line as are any rep notes provide by the Team Member (Rep Note). In an exemplary embodiment, by clicking on any segment on the timeline user may be sent to the MEMBER DETAIL-PLAY VIEW which may provide in an exemplary embodiment the player to allow a user to listen to user audio and review detailed data from the toolbar.

User can select next or previous hour. Can also navigate to Detail View by Hour/Day or Summary month view.

Exemplary MEMBER DETAIL-DAY VIEW

In an exemplary embodiment, an exemplary Detail View is the main view which allows itemized and detailed view of the team members activities. User can click on the voice note icon to listen to the voice note in a POP-UP player. As illustrated Team Member messages from the Toolbar may be shown on the time line as are any rep notes provide by the Team Member (Rep Note). By clicking on any segment on the timeline user may be sent to the MEMBER DETAIL-HOUR VIEW which provides the detailed data for the hour from the toolbar. User can select next or previous day or select a particular days by using the calendar. Can also navigate to Detail View by Hour/Day or Summary month view, in an exemplary embodiment.

Exemplary Account Management Section

This is a collection of pages available for the Supervisor to:

1) Setup the Team. (Using MANAGE TEAM TAB);

2) Add/Purchase Additional Services. (Using ADD SERVICES TAB);

3) Get Help (Using SUPPORT TAB); and/or

4) Update Billing and delete services etc. (Using Billing TAB).

Exemplary MEMBER SUMMARY-MONTH VIEW

An exemplary embodiment may provide a snap shot of the Team Members' months activity. In an exemplary embodiment, a User can select current month or 30 day summary.

Exemplary MEMBER SUMMARY-WEEK VIEW

An exemplary embodiment may provide a snap shot of the Team Members' weeks' activity. In an exemplary embodiment, a User can select next or previous week or select a particular set of days by using the calendar. In an exemplary embodiment, a user can also navigate to Detail View by Hour/Day or Summary month view.

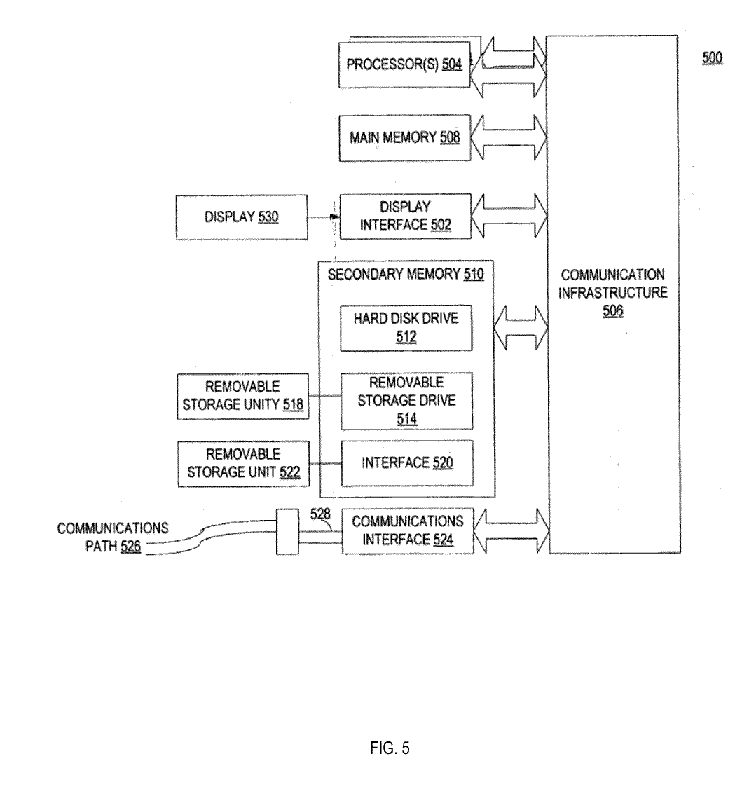

FIG. 5 depicts an exemplary diagram 500 illustrating an exemplary computer/communications device hardware architecture as may be used in various components of exemplary embodiments of the present invention. FIG. 5 depicts an exemplary view 500 of an exemplary computer system 102, 104, 112 as may be used in implementing an exemplary embodiment of the present invention. FIG. 5 depicts an exemplary embodiment of a computer system that may be used in computing devices such as, e.g., but not limited to, capture device 102, aggregation device 104, and/or server/consolidator device 112 according to an exemplary embodiment of the present invention. FIG. 5 depicts an exemplary embodiment of a computer system that may be used as client device 108, or a server device (not shown), etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A, OS/2 from IBM® Corporation of Armonk, N.Y., U.S.A, Mac/OS from APPLE® Corporation of Cupertino, Calif., U.S.A, etc, or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPhone, a smartphone, an iPad, a tablet based device, an ANDROID OS device, an iOS device, a Symbian based device, a Windows 8 device, etc., may also be implemented using a computer such as that shown in FIG. 5.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device such as, e.g., (but not limited to) a mouse or other pointing device such as a digitizer, and a keyboard or other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the present invention as discussed herein. In particular, the computer programs, when executed, may enable the processor 504 to provide a method to resolve conflicts during data synchronization according to an exemplary embodiment of the present invention. Accordingly, such computer programs may represent controllers of the computer system 500.

In another exemplary embodiment, the invention may be directed to a computer program product comprising a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11 compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc.

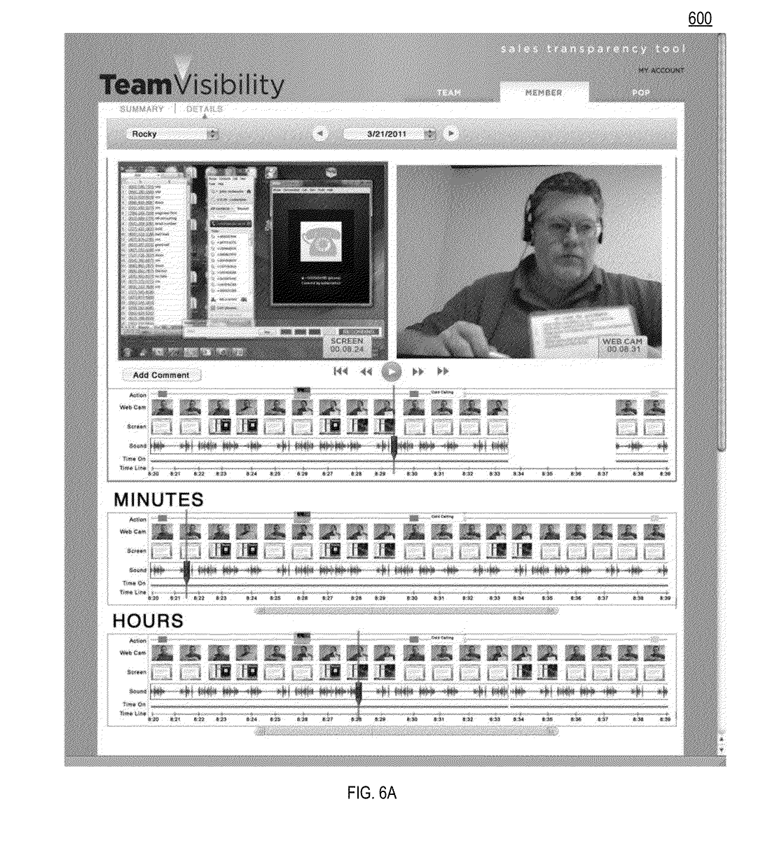

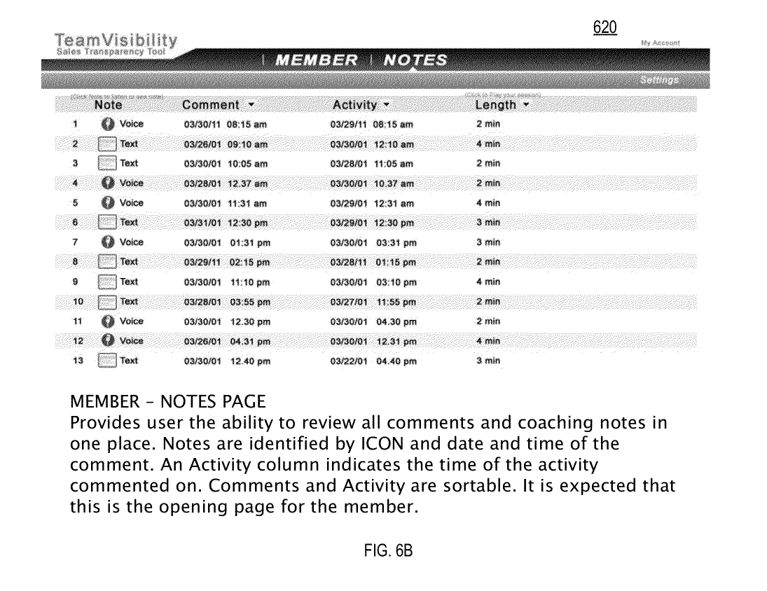

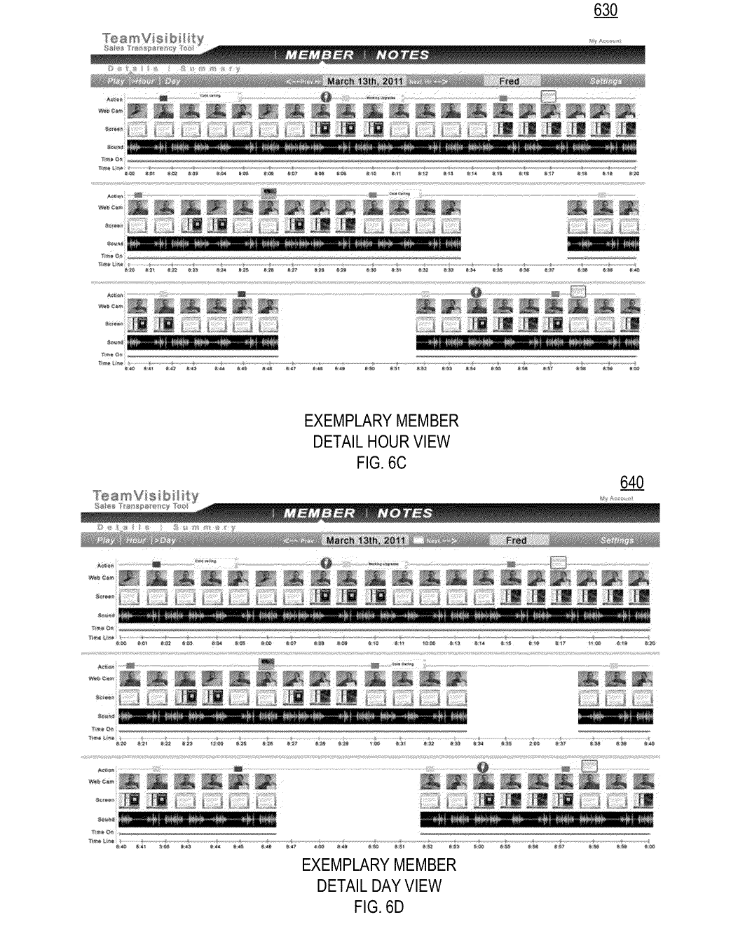

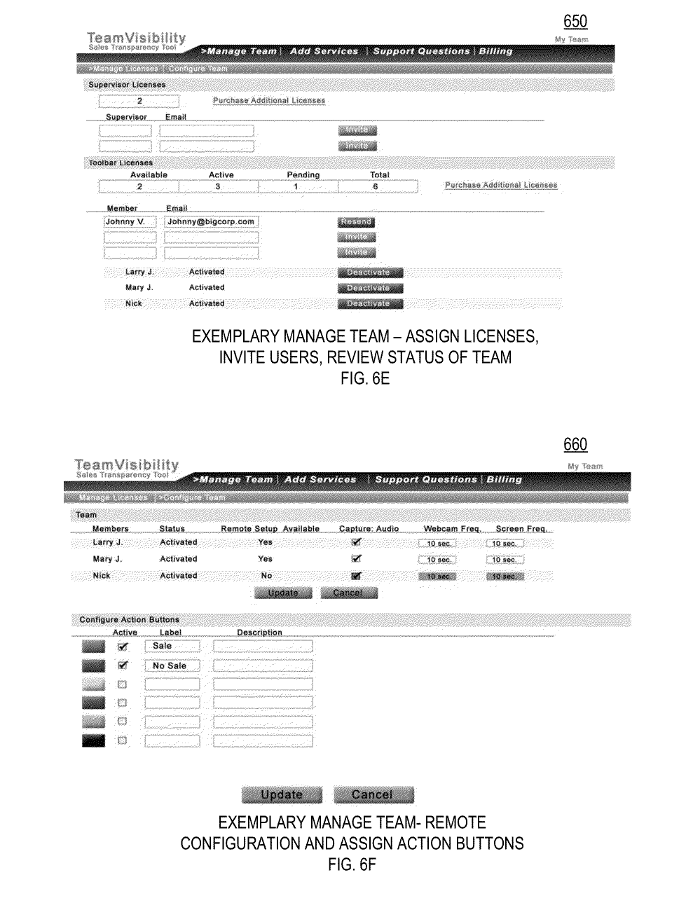

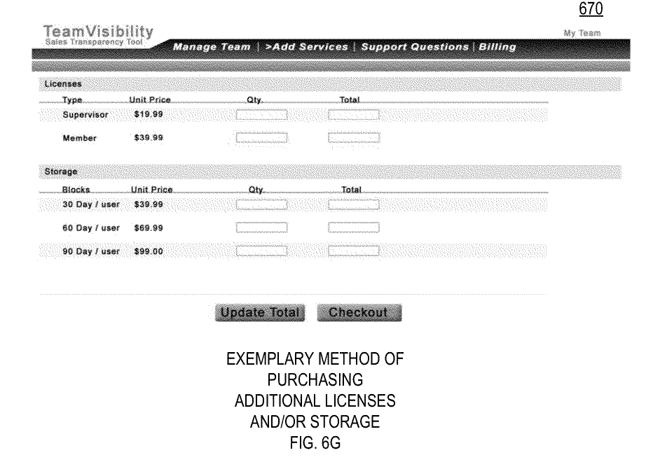

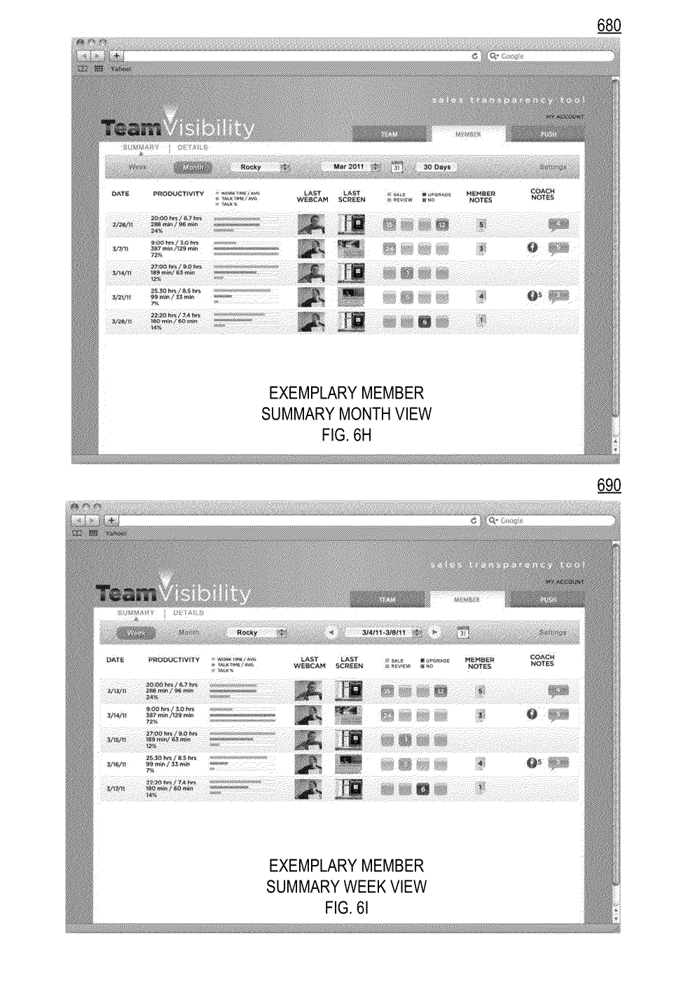

FIG. 6A depicts an exemplary embodiment of a diagram 600 illustrating an exemplary member view including an exemplary timeline of captured data, for a day, by minutes, or by hours, according to an exemplary embodiment.

FIG. 6B depicts an exemplary embodiment of a diagram 620 of an exemplary member notes view, where various exemplary audio or text messages are listed, as well as the time and duration of the notes, according to an exemplary embodiment.

FIG. 6C depicts an exemplary embodiment of a diagram 630 illustrating an exemplary member detail hour view including an exemplary timeline of captured data, for a day, by minutes, or by hours, according to an exemplary embodiment.

FIG. 6D depicts an exemplary embodiment of a diagram 640 illustrating an exemplary member detail day view including an exemplary timeline of captured data, for a day, by minutes, or by hours, according to an exemplary embodiment.

FIG. 6E depicts an exemplary embodiment of a diagram 650 illustrating an exemplary manage team view—for assigning licenses, inviting users, reviewing status of a team, according to an exemplary embodiment.

FIG. 6F depicts an exemplary embodiment of a diagram 660 illustrating an exemplary manage team remote configuration and assign action buttons configuration screen, according to an exemplary embodiment.

FIG. 6G depicts an exemplary embodiment of a diagram 670 illustrating an exemplary method of purchasing additional license and/or storage, exemplary add services screen, according to an exemplary embodiment.

FIG. 6H depicts an exemplary embodiment of a diagram 680 illustrating an exemplary member summary month view including an exemplary timeline of captured data, for a month, according to an exemplary embodiment.

FIG. 6I depicts an exemplary embodiment of a diagram 690 illustrating an exemplary member summary week view including an exemplary timeline of captured data, for a week for an exemplary member, according to an exemplary embodiment.

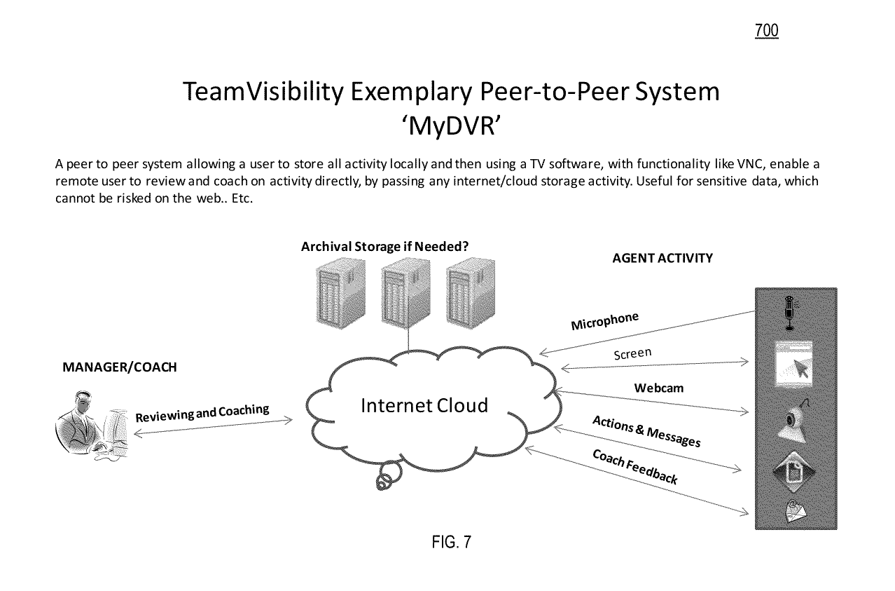

FIG. 7 depicts a diagram 700 of an exemplary embodiment of an exemplary environment illustrating an exemplary direct peer-to-peer implementation of the system. In this exemplary framework, all Employee or user Activity Records may be, e.g., stored locally on an employee/user device and the employee/user may be able to create in effect a ‘personal DVR (Digital Video Recorder).’ According to an exemplary embodiment, another user/supervisor/coach etc., can then directly access full or partial information on the user's computer. According to an exemplary embodiment, the collected information can be, e.g., but not limited to, deleted, uploaded to a private storage device, or directed for, e.g., but not limited to, storage, remote access, processing, in, e.g., but not limited to, the cloud/network environment. According to an exemplary embodiment, another user may review the data captured on an employee or user's device, via, an application allowing access and/or or viewing of the employee or user device, with exemplary functionality similar to, e.g., but not limited to, PCAnywhere, VNC, etc. According to an exemplary embodiment, the data may be deleted, or archived, as desired.

Conventional personal video recorders (PVRs) refer to a class of device that is similar to a videocassette recorder (VCR) but records television data in digital format as opposed to the VCR's analog format. Conventional PVRs encode video data in MPEG-1 or MPEG-2 formats, standards set by Moving Picture Experts Group (MPEG), and store the data in a hard drive. PVRs have all of the same functionality of VCRs (recording, playback, fast forwarding, rewinding, pausing) plus the ability to instantly jump to any part of the program without having to rewind or fast forward the data stream. Networked PVRs have been contemplated, e.g., in US Patent Publication No. US 2007/0039033 A1, the contents of which are incorporated herein by reference in their entirety.

A conventional PVR is also referred to as a hard disk recorder (HDR), digital video recorder (DVR), personal video station (PVS), or a personal TV receiver (PTR). Two common PVR systems are TiVo® and Replay TV®, among others. A PVR chooses programs based on explicit user requests or some intelligent algorithm that conjectures the user's preferences. The PVR then records the programs onto the hard disk drive. The user has the ability to watch any of the recorded programs at his convenience. The user has the ability to view a program simultaneously while the PVR records another program. A user may use various user interface tools such as, e.g., but not limited to, a timeline, pause capability, skipping forward by time, or segment of video, etc., forward, fast forward, rewind, fast rewind, quick replay, slow motion, etc. PVRs may allow another viewer to watch another recorded program via network connection.

Conventional PVRs or DVRs are limited in that they may only conventionally permit recording and playback of broadcast television video content.

According to exemplary embodiments of the present invention, a viewer may review recorded content of a first user including recorded content other than, or in addition to, broadcast television content, such as, e.g., but not limited to, audio content, screen capture content, webcam content, video conferencing, etc.

### Exemplary Integration with Telecommunication Provider Offering

An exemplary feature of the TeamVisibility (TV) solution, as described in previous filings, the contents of which are incorporated by reference herein, is the ability to capture audio from a user device and make it available for review in the TeamVisibility Web platform. In order to enhance the capabilities of the TV Solution and make deployment easier another exemplary method is described to integrate, according to an exemplary embodiment, the exemplary TV Solution with exemplary offerings of one or more Telecommunication Provider(s) (TP).

In one exemplary embodiment, customers of a TP can have access to the TV solution directly through the TP. When a TP customer chooses to add the TV Solution, phone calls to the customer may be recorded and/or captured at, e.g., but not limited to, the Telco Switch, according to an exemplary embodiment. The recording, according to an exemplary embodiment, can be for, one or more of the following:
All calls;
Inbound calls to a particular number;
Outbound calls from a particular number of group of numbers; and/or
Any combination thereof.

The recording, according to an exemplary embodiment, may occur as two separate channels, thereby isolating both ends of a conversation. In some cases, according to an exemplary embodiment, the two channel split may not be technically feasible and the entire conversation may be captured as a single channel. According to an exemplary embodiment, recording at the TP Switch may eliminate the need for a local audio capture device.

According to an exemplary embodiment, these one or more recording(s) may then be made available or posted to the TV System, according to an exemplary embodiment, along with, e.g., but not limited to, phone number information for both channels—thereby identifying the customer, as well as the caller. Additionally, according to an exemplary embodiment, the TP provider may make available a special dialing sequence on, e.g., but not limited to, a phone dial pad, allowing the caller to “disposition,” or dispose of, the outcome of the call, i.e. #2 could signify SALE, or #1 could signify NO SALE, etc. These capabilities, according to an exemplary embodiment, may also be available on a local (or remote) software application where they may be time synched with, e.g., but not limited to, recorded calls and may be displayed on the TV Web platform, according to an exemplary embodiment.

Additionally, according to an exemplary embodiment, the call recording rules can also incorporate a triggering mechanism, whereby a local (or remote) software application may be launched based on a call being handled by the TP, according to an exemplary embodiment. When an incoming or outbound call is identified by the TP, according to an exemplary embodiment, the TP may send a uniquely identifiable signal identifying the TV User which may then trigger the users of the exemplary TeamVisibility Software Application on the local (or remote) computing device, according to an exemplary embodiment. This local (or remote) application, according to an exemplary embodiment, may offer a set of additional features useful for identifying call and/or activity outcomes associated with the call, according to an exemplary embodiment.

The user, according to an exemplary embodiment, of this system may now have the following abilities:
He or she, according to an exemplary embodiment, can discard recorded calls or channels by accessing the TV Platform, e.g., but not limited to, through the web site, or on the local (or remote) software application, etc.
He or she, according to an exemplary embodiment, can sort and/or select any recorded audio, according to an exemplary embodiment, by searching through, e.g., but not limited to, phone numbers, or in some cases where the user is matched to a phone number, etc.
He or she, according to an exemplary embodiment, can sort and/or select calls made to, e.g., but not limited to, an incoming phone number, i.e., an inbound number may be associated with customer service, according to an exemplary embodiment. According to an exemplary embodiment, all calls to that number may then be available for review by, e.g., but not limited to, simply selecting that number.

Any and all of the described capabilities can be setup by default, according to an exemplary embodiment, so if recording the second party is not permitted, according to an exemplary embodiment, channel 2 recording may in such case never be captured.

According to an exemplary embodiment, the ability to directly integrate with a TP may enable a much broader and simpler platform to deploy the TV Solution, and/or the integrated platform may allow TPs to provide additional features and services to their customer base, according to an exemplary embodiment.

### Using the TV/Telco Integrated Solution to Leave Voice Notes

The TV System, according to an exemplary embodiment, is an activity management system that may enable users to access detailed activity records displayed across a time line, according to an exemplary embodiment. One of the features of this activity management system, according to an exemplary embodiment, is to record voice notes in real time and to have them available for review by the user, or his or her management, or his or her coach, according to an exemplary embodiment.

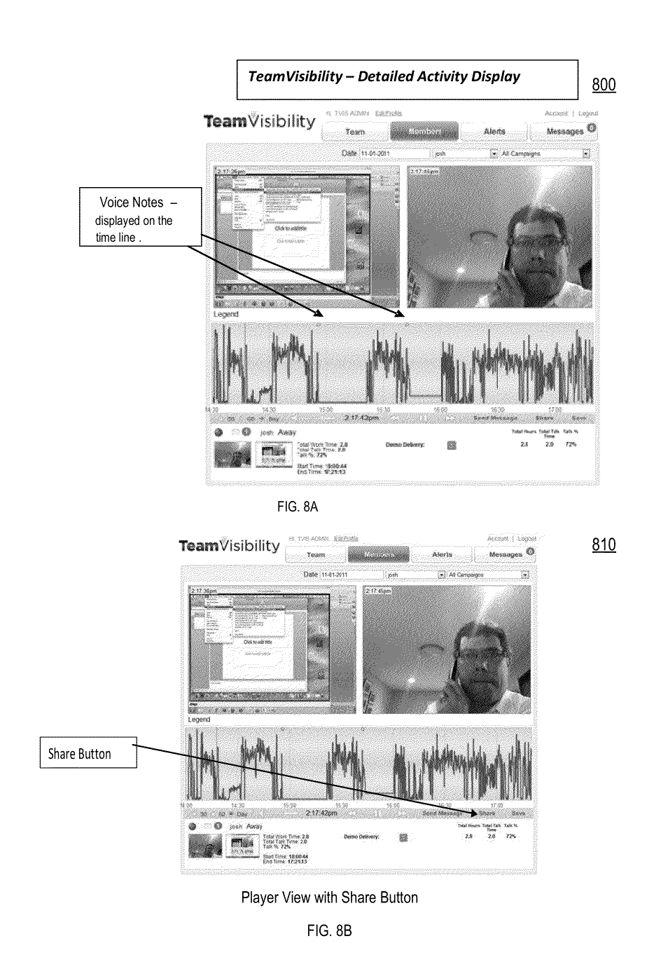

One mechanism, according to an exemplary embodiment, for leaving timely and effective notes is for a user to simply call a pre-designated phone, enter a unique identifier and leave a voice note. Additional features can be made available, according to an exemplary embodiment, whereby the user can designate, e.g., but not limited to, a particular customer, activity or event, etc. associated with that voice note directly using the dial pad, according to an exemplary embodiment. Should the user choose, according to an exemplary embodiment, he or she can subsequently associate that note with, e.g., but not limited to, a particular customer, activity or event, etc. According to an exemplary embodiment, this voice note may then become part of the user's activity time line as shown in FIG. 8A.

FIG. 8A depicts an exemplary embodiment of a diagram 800 illustrating an exemplary TeamVisibility system illustrating a detailed activity display and showing exemplary voice notes displayed on a viewing timeline, according to an exemplary embodiment.

### Enhanced Sharing

An exemplary embodiment of the TV System is the ability to enable authorized users and or other authorized viewers of the data to identify and select portions/segments of the recorded activity and to make it available for sharing.

Sharing a selection may be done using multiple methods accessible within the PLAYER VIEW (FIG. 8B). Segment selection, not limited to, may include user clicking on the share button and either inputting time segments or using a mouse to select a time segment.

FIG. 8B depicts an exemplary embodiment of a diagram 810 illustrating an exemplary TeamVisibility system illustrating an exemplary player view illustrating an exemplary share button for sharing a recorded activity to another user as authorized by a given setup, according to an exemplary embodiment.

Once a segment is selected the user may add notes using text, audio or video or some combination thereof. The user may additionally add tags to the selection or reference a subject in the selection, either from a pre-populated list or by creating a new entry, or identify elements, such as notes, webcam images, or screenshots, which should not be shared.

Sharing may occur within an authorized group of users, select users, i.e. coaches, auditors, verifiers and the like, or outside the employee's organization or to the public at large. Sharing may also occur via simple email to a desired recipient. Duration of sharing may be restricted by various means, not limited to, unique passwords, time expiration, number of views, exchange of public token or an expiring URL. Shared segment may be archived for future use, not limited to, training, compiling best practices and the like.

A user may also a select a number of his or her activities and save them in a folder for sharing, using the same options mentioned earlier. In this implementation, a user may in effect be sharing his or her portfolio of activities as needed.

One additional mechanism for sharing is the ability of users or their managers/administrators to authorize viewing privileges on an on-going basis to a particular user or group of users for all shared segments or only specific segment types, i.e., “best practices”.

### Enhanced Privacy

An exemplary embodiment of the TV System allows users to exercise complete control over their captured data. The user has complete control over who has access to what parts of their collected data.

User may designate which data is captured, frequency with which that data is captured, how long that data is stored and who has access to what portions of that data.

The user can designate viewing privileges to single individuals, groups of individuals or to no one. The user may additionally limit what data elements, such as webcam images or screenshots are shared.

This mode of Active Sharing allays privacy concerns among users while providing them the tools to be actively coached, learn and improve.

FIG. 2E shows the toolbar and displays the setting area. The settings area identifies the user's control over what data is captured and the level of sharing allowed by the user.

FIG. 2E depicts an illustration 250 of an exemplary embodiment of an exemplary TeamVisibility graphical user interface toolbar applet, application, gadget, application software program, etc., which may include exemplary but nonlimiting indicators and/or buttons, including various graphical user interface features, which may be used, e.g., for tracking messages, allowing a user to flag a recording, a record start/stop indication for stopping/starting recording, one or more activity counter button(s), which may be color coded or have other indicia to indicate information, which may be collected, various content selector(s) such as, e.g., but not limited to, a toggle or radio button object(s) for selecting, e.g., but not limited to, a mic, a webcam, a desktop screen capture, a manager's full view, and/or rep share only, etc. exemplary views, according to another exemplary embodiment.

### Toolbar, Additional Features, and Use as Information Dashboard

The ToolBar, the primary data collection tool used by the TV system, is typically turned on to initiate collection of user data. When the user logs in, he or she is asked to select from a list of active projects or campaigns. The user selects the project or campaign and the appropriate activity buttons associated with the project or campaign are displayed.

The Toolbar incorporates a reminder system, which alerts users to when the Toolbar ought to be turned on. It also has an alert mechanism which identifies any hardware malfunction and misconfiguration that prevents user data from being captured.

FIG. 2F depicts a diagram 260 illustrating an exemplary embodiment of an enhanced exemplary toolbar serving an exemplary information dashboard with exemplary third party data as may be integrated with an exemplary toolbar, illustrating an exemplary toolbar display of exemplary information from an exemplary CRM or other enterprise system, such as, e.g., but not limited to, a number of contacts, gross or net revenues, number of sales, number of callbacks, number of rejections, number of upsells, etc., exemplary indicators for recording, or to start/stop, a user flag, which may be used to mark a particular recording, or to alert a manager, etc., an icon to display and/or access messages; and/or exemplary activity counter(s) icon(s), as may appear on the exemplary toolbar, according to an exemplary embodiment.

An Alert button is identified in FIG. 2F to indicate a mechanism whereby the user can send an alert to the manager or coach or mark an event with a text or audio note on the user timeline as shown in the player. FIG. 2F also shows a message indicator, which provides easy access to messages directed at the user.

User data may consist of audio captured through the system microphone, webcam images or video captured from the image capture device on the user's computing device and screenshots of the user's computing device.

Additionally, the trigger mechanism for capturing data may be change in audio levels or detection of user image by the web cam.

The Toolbar also maintains a counter of employee activities. For a salesperson, the numbers on the activity buttons may indicate sales, call backs, wrong numbers etc. The tallies in the counter may be generated by the user clicking on the action buttons themselves to generate action markers or by the import of such actions from a system such as a CRM system.

The message field in the ToolBar can also be used by users to send status updates to managers/coaches or by managers/coaches to send instant messages to the individual user or flash updates to the entire team.

The ToolBar is additionally capable of displaying information captured in the user's enterprise systems, such as CRM, order management, enterprise resource planning etc. This information is displayed as an information dashboard which is continuously updated and obviates the need for the user to maintain multiple open software applications on his or her device. In cases where the ToolBar is used in conjunction with an external CRM or enterprise system, the activity buttons may not be displayed or may be displayed, but as counters for activity updates imported from the CRM.

Additionally, the information Dashboard can serve as part of reward system allowing information about a contest to be continually updated. As an example, if a team needs to achieve 8 sales by noon to qualify for free lunch the information dashboards can update team sales to provide the motivation for some team members to help achieve the goal of 8 Sales. See FIG. 2F.

The Information Dashboard component of the ToolBar can be configured to provide coaching and training reminders. For example, a user may be asked to undergo 90 minutes of training per week. The system automatically tracks and provides feedback on the kind of training that is required, how much training has not been completed and the optimum way of meeting ones training goals. See section on coaching and training for description on training aspects of the TV System.

Integration Between Team Visibility (TV) System and Other Enterprise Systems Such as CRM.

An exemplary embodiment of the system allows the TV System to enable data from other enterprise systems, such as CRM systems, to be displayed on the TV System's player timeline.

The TV system also allows a ToolBar to be integrated with a telephony platform, VoIP, CTI or any number of other telephony integration options to record audio directly from the telephony platform and import that into the TV System. This method has the benefit of allowing all calls to be clearly delineated by an automated mechanism, unavailable in a manual start/stop environment.

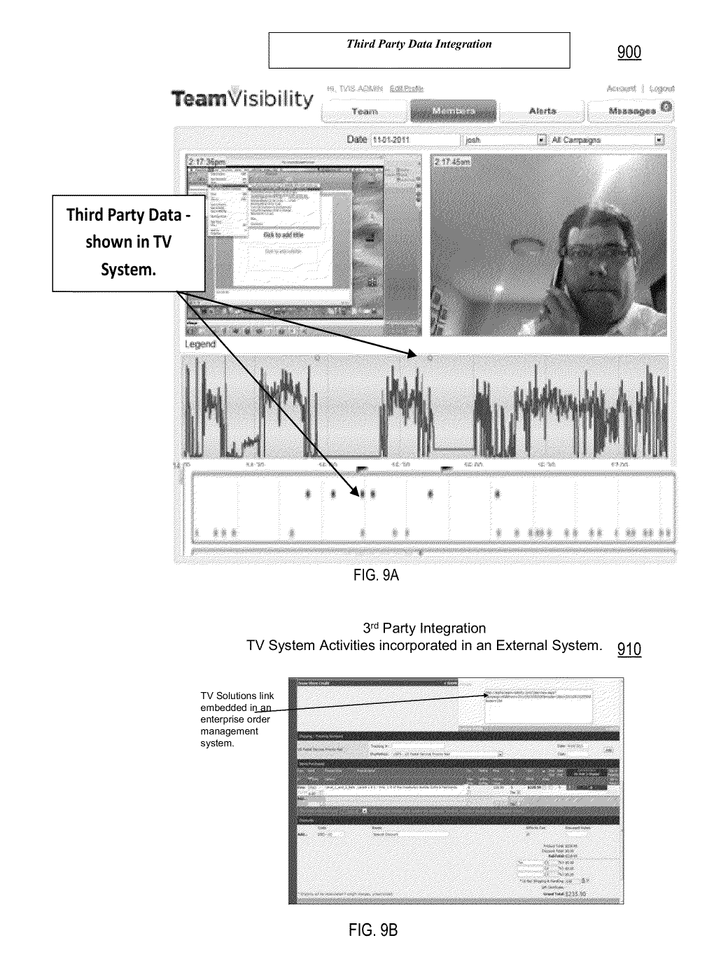

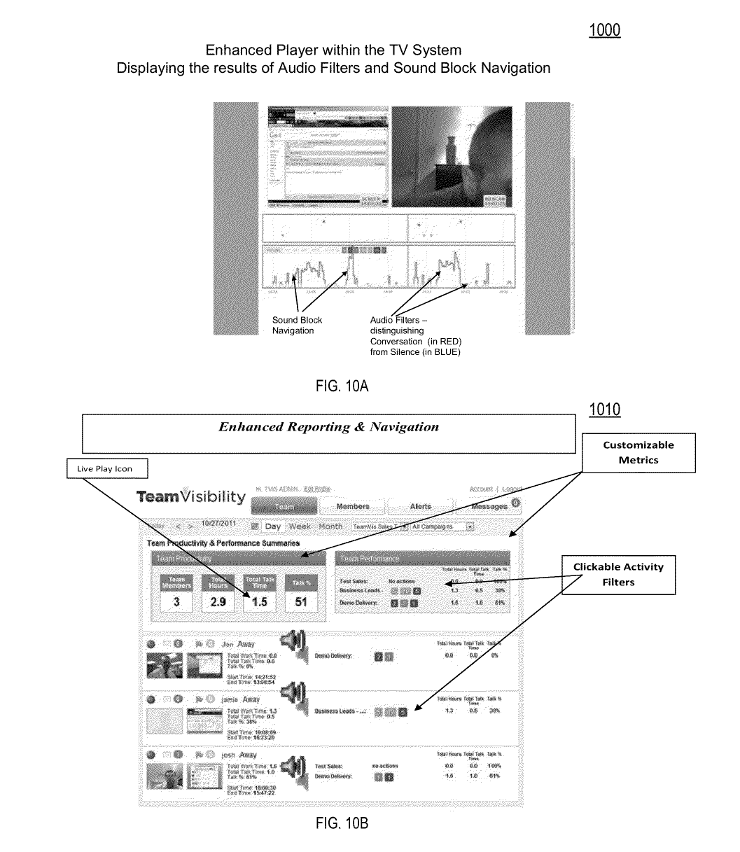

Additionally, external data such as weather, breaking news, industry specific events and the like can be displayed on the timeline—see FIG. 9A. If the data displayed on the timeline refers to unique identifiers such as a customer, the system allows the user to generate a search specific to that customer and pull up the totality of records associated with the customer in the TV System.

FIG. 9A depicts an exemplary embodiment of a diagram 900 illustrating an exemplary TeamVisibility (TV) Third Party Data Integration system illustrating exemplary third party data, e.g., a customer relationship management (CRM) system, such as, e.g., but not limited to, an exemplary view as shown in an exemplary TV system including an exemplary event indicator and exemplary integration, according to an exemplary embodiment.

Additionally, data from the TV System can be incorporated and made available within Enterprise systems, such as an ERP system, CRM system, order management systems etc. See FIGS. 9A & 9B. The TV System can be used to update fields, such as status changes, directly in the CRM itself, reducing the need for users to switch between and among multiple systems in order to provide managers with the most up to date information about customers.

FIG. 9B depicts an exemplary embodiment of a diagram 910 illustrating an exemplary TeamVisibility (TV) system activities incorporated in an external system, such as, e.g., but not limited to an order entry, or CRM system, illustrating an exemplary third party integration illustrating an exemplary TV solutions link embedded in an enterprise order management system, according to an exemplary embodiment.

The Application Programming Interface or API made available by the TV system allows the mini-player of the TV system to be embedded in any third party system. Call segments can then be played and reviewed from with any third party application.

The API also allows third party software to integrate with the Toolbar, enabling the automated launch of the Toolbar when the third party application is launched.

### Enhanced Player

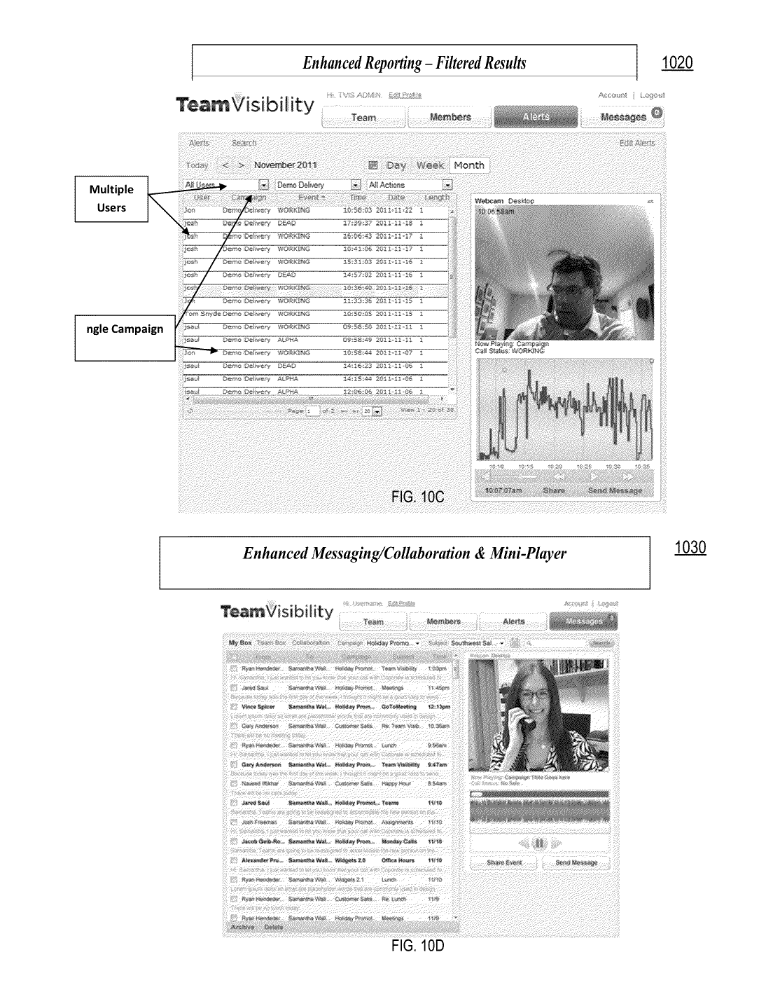

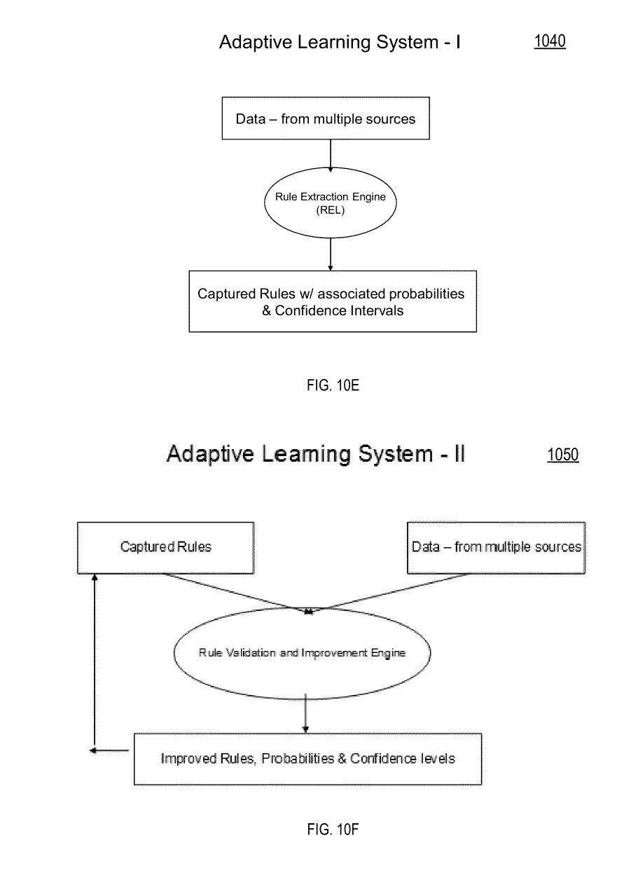

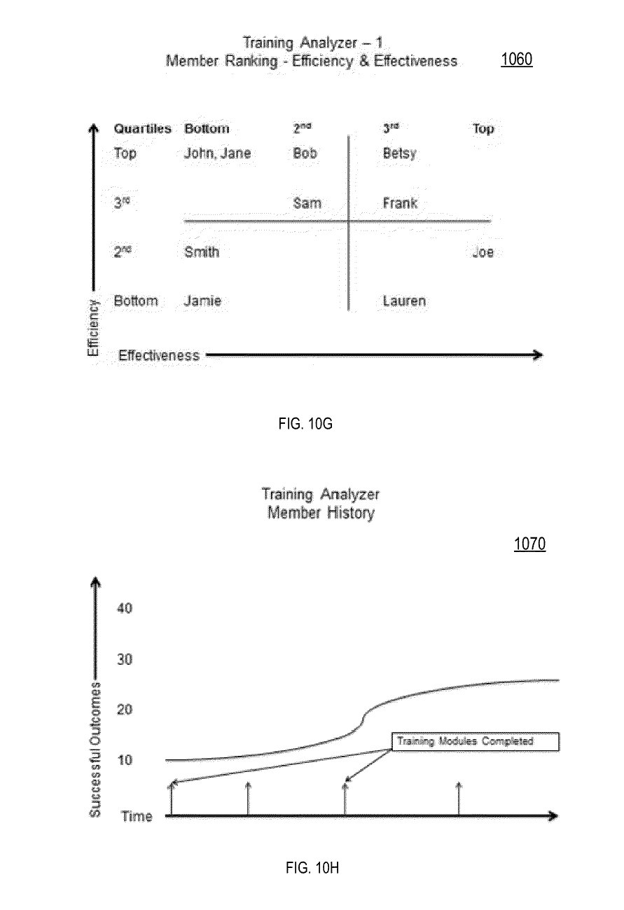

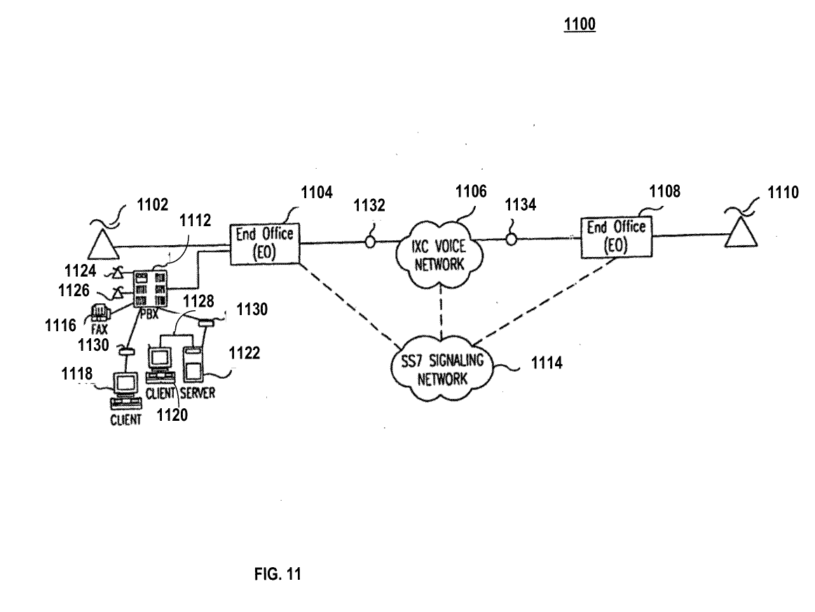

An exemplary embodiment of the TV System incorporates an enhanced player to review employee or salesperson activity. This player includes webcam images or video, audio recordings and activity markers, see FIG. 10A.

FIG. 10A depicts an exemplary embodiment of a diagram 1000 illustrating an exemplary TeamVisibility (TV) enhanced player displaying results of audio filters and exemplary sound block navigation according to an exemplary embodiment.

The Audio Graph in FIG. 10A incorporates an enhanced audio level detection filter which enables a viewer to distinguish areas of silence from conversations—these are shown on the audio graph as red areas or blue areas.

Additionally, the player features the ability to navigate from one sound block to another, saving the viewer the tedium of selecting conversation starting points manually or having to continually reverse and forward the play head (shown as the vertical green bar in the player).

Navigation can also be accomplished by clicking at any point in the Audio Graph or by clicking on a specific event marker displayed on the timeline. As shown in figures herein the activity counts are summarized and displayed within the player.

In one embodiment of the player, the user has the option to disable the use of a webcam and/or screenshots.

In that case the window occupied by the player provides additional detailed information about the employee activity or in some cases replaces the additional information with an Avatar or a still image.

While reviewing calls within the player, a user has the option to have notes or messages from coaches, managers or oneself, referenced at various points on the time line, to be played interspersed within the call. This Notes ON or Notes OFF allows a more seamless review of activity. This Notes ON or OFF feature is extensively available within the TV system and can be used across a variety of functions during call review.

### Enhanced Reporting & Search

An exemplary embodiment of the TV System includes an enhanced reporting system, which allows customizable metrics to be included in the summary web page. As shown in FIG. 7 below, the metrics included in the web page can be replaced with or supplemented with additional information. Metrics may include, but are not limited to, statistical data such as means, standard deviations, performance ratios, rates, etc.

An exemplary embodiment of the TV System includes the ability to navigate from the reporting system directly to filtered results. As shown in FIG. 10B, by clicking on an activity indicator for a particular employee, the viewer is taken to a Search or Alerts page where all data related to the employee having performed that activity is displayed. See FIG. 10C. The Search/Alerts page also incorporates a mini-player enabling the viewer to review targeted detailed data related to the activity and provide immediate coaching and feedback.

FIG. 10B depicts an exemplary embodiment of a diagram 1010 illustrating an exemplary TeamVisibility system depicting enhanced reporting and navigation illustrating an exemplary live play icon, customizable metrics, and exemplary clickable activity filters, according to an exemplary embodiment.

FIG. 10C depicts an exemplary embodiment of a diagram 1020 illustrating an exemplary TeamVisibility (TV) enhanced reporting of filtered results according to an exemplary embodiment.

One feature of the system is to enable live audio for any individual user to be played “live” from within the summary web page.

An enhanced search function can be accessed which allows a user to have “like” call searched. As an example, when reviewing calls, a user may search for additional calls that are “like” the call being reviewed. As a corollary to “like,” the system also has the ability to find “unlike” calls. The “like” & “unlike” function can find calls with any and all of the following functions:
Gender Voice
Selected Keywords within the conversation.
Frequency of certain words
Event type
Etc.

### Enhanced Messaging & Collaboration

An exemplary embodiment of the TV System includes a messaging system which enables communications between the user and the coach or manager. A user or any of the authorized viewers of the user data can identify segments of user/employee data and send messages or share that segment, as mentioned earlier in enhanced sharing. These segments are then available for review, comment, archiving or sharing within the messaging system. See FIG. 10D.

FIG. 10D depicts an exemplary embodiment of a diagram 1030 illustrating an exemplary TeamVisibility system depicting enhanced messaging/collaboration, and miniplayer system, according to an exemplary embodiment.

The messaging system not only incorporates a MYBOX, meant for one to one messages but also a TEAMBOX, which contains messages shared within a team or group of users.

The area called COLLABORATION, serves as a place for a BEST PRACTICES archive, a discussion forum and any other materials which enhance collaboration within the team.

### Performance Analytics—Adaptive Learning System (ALS)

An exemplary embodiment of the TV solution incorporates a multi-algorithmic analysis engine. The analysis engine or Rule Extraction Engine (REE) is part of an Adaptive Learning System (ALS) as shown in other figures. Key components of the ALS include the ability to process large amounts of employee activity data, including sales activity and sales outcome data.

The REE processes large amounts of data from multiple sources through a multitude of diverse algorithms, including but not limited to statistical analysis algorithms, non-linear neural-network algorithms, inductive learning mechanisms and the like. The result is a highly detailed analysis of factors and influences which affect various employee activities including sales activity. These results are formulated as critical success factors influencing various outcomes

Data gathering and analysis within the ALS is accomplished using automated voice recognition systems as well as statistical text analysis performed on transcripts generated by a speech to text engine.

The ALS continually processes new and additional data through the REE to validate and enhance ‘confidence intervals’ for critical success factors. See FIGS. 10E & 10F.

FIG. 10E depicts an exemplary embodiment of a diagram 1040 illustrating an exemplary TeamVisibility (TV) adaptive learning system I including an exemplary rule extraction engine (REL), and captured rules and confidence intervals according to an exemplary embodiment.

FIG. 10F depicts an exemplary embodiment of a diagram 1050 illustrating an exemplary TeamVisibility system adaptive learning system II including an exemplary rule validation and improvement engine, and captured rules and improved rules, probabilities and confidence levels according to an exemplary embodiment.

### Exemplary Usage of the ALS System

An exemplary usage of the ALS system in a sales environment may be as follows:

All recorded calls may be subjected to an automated voice recognition system or the call transcripts may be created by a speech to text engine and searched.

Each call may be subjected to statistical natural language analysis. During this analysis the system may identify certain keywords, their frequency of usage, time of use and correlate those with the outcome of the call. As the system acquires large amounts of data, the correlation between certain keywords and outcomes may get stronger.

The keywords may initially be searched from a pre-determined manual list or the system may develop one or more associations of its own over time. These keywords are called subjects and all sales activities are organized around these subjects. (Shown in Training Section below).

The following table of call text and subject/keyword appearing below shows the nature of the relationship for a call. The call text is shown in the column 1 and the subjects, analyzed to have had a statistically significant role (gathered over large historical data) are shown in the 2nd column. The Source column identifies, if the subject/keyword was predefined i.e., manual or statistically identified by the system i.e., auto.

Table of Call Text and Subject/Keyword

| Call Text | Subject/Keyword | Source | Outcome |
|---|---|---|---|
| Hello this is John with LeaseFinder.com may I speak | Landlord | Auto | |
| with Tina Great I just want to take a moment of your | | | |
| time to tell you about Leasefinder.com and its benefits | | | |
| to you. Leasefinder.com is a FREE service that will | | | |
| allow you to shop & compare you current lease to | | | |
| similar leases in your area or any area you chose. | | | |
| Because the service is free to both landlord & tenants | | | |
| we have complied the most comprehensive leasing | | | |
| data and placed in it a friendly easy to use search | | | |
| engine. | | | |
| Landlords have entered over 10,000 vacant units that | Vacant | Auto | |
| are avail for lease | | | |
| We would like to add your company's leasing data at | | | |
| this time. | | | |
| Yes we handle warehouse space also. | | | |
| Your happy with your current lease OK have a nice | | | |
| day. | | | |
| Hello this is John with LeaseFinder.com may I speak | Landlord | Auto | |
| with Glen Great I just want to take a moment of your | | | |
| time to tell you about Leasefinder.com and its benefits | | | |
| to you. Leasefinder.com is a FREE service that will | | | |
| allow you to shop & compare you current lease to | | | |
| similar leases in your area or any area you chose. | | | |
| Because the service is free to both landlord & tenants | | | |
| we have complied the most comprehensive leasing | | | |
| data and placed in it a friendly easy to use search | | | |
| engine. | | | |
| Landlords have entered over 10,000 vacant units that | Landlord | Auto | |
| are avail for lease | | | |
| We would like to add your company's leasing data at | Warehouse | Manual | |
| this time. | | | |
| Yes we have warehouse space also. | Warehouse | Manual | SALE |
| They usually move quickly, we get a lot of request for | | | |
| warehouse space want to list your current lease? | | | |
| Ok have a good day | | | |
| Rep 123's job is to call local businesses and register | Warehouse | Manual | |
| their current lease information into | | | |
| the leasefinder.com database. In previous monitoring | | | |
| we noticed that questions regarding warehouse space | | | |
| were being asked. We reviewed with the reps some | | | |
| quick bullet points that the rep could use. | | | |
| Warehouse space consists of over 30% of our | | | |
| available leases and usually rent 50% faster than other | | | |
| commercial leases in your area. | | | |
| Once the customer enquires about warehouse space | | | |
| the system can identify if the bullet point were used | | | |
| and used correctly with the voice keyword tracking | | | |

Such data forms the basis for many analytical aspects of the TV System. Training systems are organized around these subject libraries/groupings as shown in the Training section later.

### ALS

### Use in Coaching Evaluation

The ALS system is very effective in determining the impact of coaching interventions in employee performance, e.g. employee sales performance. By gauging performance across a time-line, with identifiable coaching interventions, the ALS can determine the contribution of coaching to improved employee performance. This can aid in evaluating the value of various coaching methods and the relationship of various coaching techniques to different sales environments or across different industries or geographies. One may find that method A is more effective in Industry B or method C is more effective in transactional sales and ineffective in multi-step long-cycle sales.

Data gathered and analyzed by the ALS system not only serves to enhance the performance within the company but also provides the basis for generating customized analysis for industries, service organizations and the like.

### ALS

### Use in Employee Training Systems—Success Wizards

The ALS system can be devised to create highly-customized training and feedback programs for employee improvement. As an example, a sales person's data is evaluated by the ALS to identify opportunities for improvement by comparing the sales person's effectiveness against the critical success factors extracted by the REE across the sales person's entire organization or industry or geography. Once the ALS identifies the appropriate training program, it can further tailor the training segments to the available training time, ensuring that optimized training can be imparted within the available training times.

One additional feature of the ALS is to try to identify any particular sales activity, which is more aligned with the profile of a particular sales person. A consultative sales person may have more success in a business to business setting than in a business to consumer setting etc.

One additional feature is to enable users to learn from best practices filtered by individuals with similar characteristics, i.e., gender, geography, etc.

### ALS

### Use in Coaching the Coach—Coach the Coach

The ALS system is an ideal mechanism to provide feedback to coaches about the relative effectiveness of their coaching methods and techniques. In addition to using the aforementioned ALS—Use in Coaching Evaluation, the system can present an employee's or salesperson's activity data without disclosing the activity outcome. The coach then provides his or her best estimate of outcome. The coach's outcome selection is then compared to actual outcomes as a means of improving the coach and coaching method.

### TV

### Marketplace

An exemplary embodiment of the TV Solution is the ability to make available a marketplace of services, products and add-ons available and billed through the TV Portal.

### Services

Users can select coaches, auditors, verifiers, translators among a host of other service providers to interact with their employee activities and performance and deliver their services through the TV marketplace. Selection criteria can be multi-fold and may include but not limited to; industry, size of firm, years in business, geographic scope, teaching/coaching method etc.

### Products

Users can also select from a variety of product add-ons, from telecommunication providers who integrate seamlessly with the TV System, to software system like CRM customized for particular industries and integrated with the TV System. Products may also include dialing solutions—power dialers and automated dialers. This is by no means an exhaustive list and one can envision the multiplicity of offerings.

The TV marketplace provides ranking and feedback comments on various providers, enabling an informed decision on the part of TV System users. The TV marketplace provides a unified billing platform for users to enjoy a unified purchasing and billing system for all services and products available through the TV System.

### Exemplary Simple Voice Network

FIG. 11 depicts a diagram 1100 illustrating an exemplary local exchange carrier telecommunications public switched telephone network (PSTN) in an exemplary environment. FIG. 11 is a block diagram providing an overview of a standard telecommunications network 100 providing local exchange carrier (LEC) services within one or more local access and transport areas (LATAs). Telecommunications network 1100 can provide a switched voice connection from a calling party 1102 to a called party 1110. FIG. 1 is shown to also include a private branch exchange 1112 which can provide multiple users access to LEC services by, e.g., but not limited to, a private line, and/or facilities. Calling party 1102 and called party 1110 can be ordinary telephone equipment, key telephone systems, a private branch exchange (PBX) 1112, or applications running on a host computer. Network 1100 can be used for modem access as a data connection from calling party 1102 to, for example, an Internet service provider (ISP) (not shown). Network 1100 can also be used for access to, e.g., but not limited to, a private data network. For example, calling party 1102 can be an employee or user working on a notebook computer at a remote location who is accessing his employer's private data network through, for example, a dial-up modem connection.

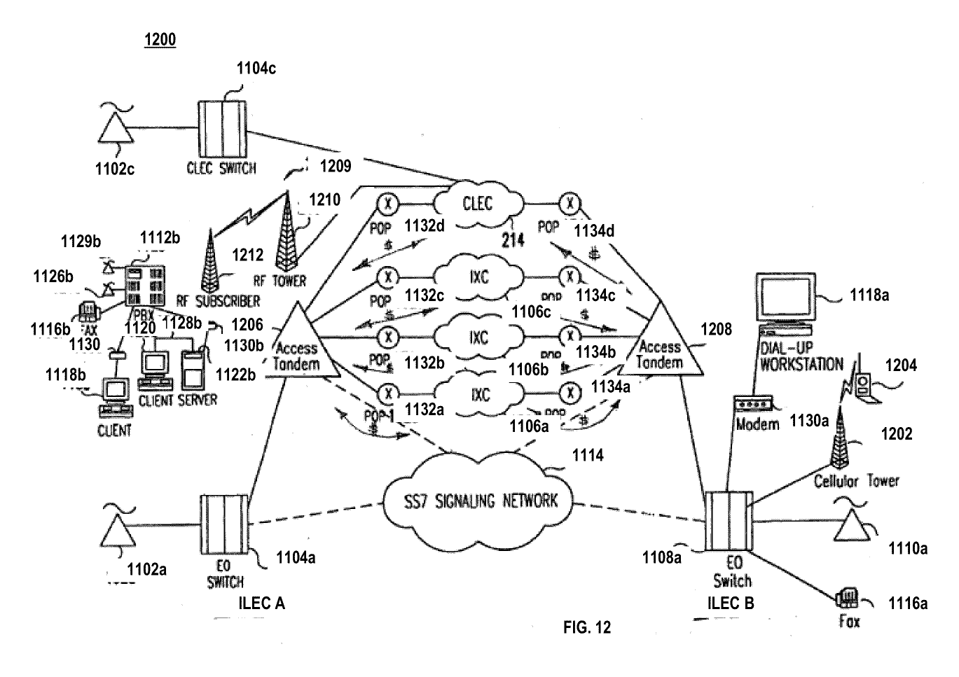

FIG. 11 includes end offices (EOs) 1104 and 1108. EO 1104 is called an ingress EO because it provides a connection from calling party 1102 to public switched telephone network (PSTN) facilities. EO 1108 is called an egress EO because it provides a connection from the PSTN facilities to a called party 1110. In addition to ingress EO 1104 and egress EO 1108, the PSTN facilities associated with telecommunications network 1100 include an access tandem (AT) (not shown) at points of presence (POPs) 1132 and 1134 that can provide access to, e.g., one or more inter-exchange carriers (IXCs) 1106 for long distance traffic, see FIG. 12. Alternatively, it may be apparent to a person having ordinary skill in the art that IXC 1106 could also be, for example, a CLEC, or other enhanced service provider (ESP), an international gateway or global point-of-presence (GPOP), or an intelligent peripheral (IP).

FIG. 11 also includes a private branch exchange (PBX) 1112 coupled to EO 104. PBX 1112 couples calling parties 1124 and 1126, fax 1116, client computer 1118 and associated modem 1130, and local area network 1128 having client computer 1120 and server computer 1122 coupled via an associated modem 1130. PBX 1112 is a specific example of a general class of telecommunications devices located at a subscriber site, commonly referred to as customer premises equipment (CPE).

Network 1100 also includes a common channel interactive signaling (CCIS) network for call setup and call tear down. Specifically, FIG. 11 includes a Signaling System 7 (SS7) signaling network 1114.

### Exemplary Detailed Voice Network

FIG. 12 is a block diagram illustrating an overview of a standard telecommunications network 1200, providing both LEC and IXC carrier services between subscribers located in different LATAs. Telecommunications network 1200 is a more detailed version of telecommunications network 1100. Calling party 1102a and called party 1110a are coupled to EO switches 1104a and 1108a, respectively. In other words, calling party 1102a is homed to ingress EO 1104a in a first LATA, whereas called party 1110a is homed to an egress EO 1108a in a second LATA. Calls between subscribers in different LATAs are long distance calls that are typically routed to IXCs. Sample IXCs in the United States include AT&T, MCI and Sprint.

Telecommunications network 1200 includes access tandems (AT) 1206 and 1208. AT 1206 provides connection to points of presence (POPs) 1132a, 1132b, 1132c and 1132d. IXCs 1106a, 1106b and 1106c provide connection between POPs 1132a, 1132b and 1132c (in the first LATA) and POPs 1134a, 1134b and 1134c (in the second LATA). Competitive local exchange carrier (CLEC) 1214 provides an alternative connection between POP 1132d and POP 1134d. POPs 1134a, 1134b, 1134c and 1134d, in turn, are connected to AT 1208, which provides connection to egress EO 1108a. Called party 1110a can receive calls from EO 1108a, which is its homed EO.

Alternatively, it may be apparent to a person having ordinary skill in the art that an AT 1206 can also be, for example, a CLEC, or other enhanced service provider (ESP), an international gateway or global point-of-presence (GPOP), or an intelligent peripheral.

FIG. 12 depicts a diagram 1200 illustrating an exemplary local exchange carrier and intraexchange carrier telecommunications public switched telephone network (PSTN) in an exemplary environment.

Network 1200 also includes calling party 1102c homed to CLEC switch 1104c. Following the 1996 Telecommunications Act in the U.S., CLECs gained permission to compete for access within the local RBOCs territory. RBOCs are commonly referred to as incumbent local exchange carriers (ILECs).

Network 1200 further may include a fixed wireless CLEC 1209. Fixed wireless CLEC 1209 includes a wireless transceiver/receiver radio frequency (RF) tower 1210 in communication over an RF link to a subscriber transceiver RF tower 1212. Subscriber RF tower 1212 is depicted coupled to a CPE box, PBX 1112b. PBX 1112b couples calling parties 1124b and 1126b, fax 1116b, client computer 1118b and associated modem 1130b, and local area network 1128b having client computer 1120b and server computer 1122b coupled via an associated modem 1130b.

Network 1200 also includes called party 1110a, a fax 1116a, client computer 1118a and associated modem 1130a, and cellular communications RF tower 1202 and associated cellular subscriber called party 1204, all coupled to EO 1108a, as shown.

EO 1104a, 1108a and AT 1206, 1208 are part of a switching hierarchy. EO 1104a is known as a class 5 office and AT 1208 is a class 3/4 office switch. Prior to the divestiture of the regional Bell Operating Companies (RBOCs) from AT&T following the modified final judgment, an office classification was the number assigned to offices according to their hierarchical function in the U.S. public switched network (PSTN). An office class is a functional ranking of a telephone central office switch depending on transmission requirements and hierarchical relationship to other switching centers. A class 1 office was known as a Regional Center (RC), the highest level office, or the “office of last resort” to complete a call. A class 2 office was known as a Sectional Center (SC). A class 3 office was known as a Primary Center (PC). A class 4 office was known as either a Toll Center (TC) if operators were present, or otherwise as a Toll Point (TP). A class 5 office was an End Office (EO), i.e., a local central office, the lowest level for local and long distance switching, and was the closest to the end subscriber. Any one center handles traffic from one or more centers lower in the hierarchy. Since divestiture and with more intelligent software in switching offices, these designations have become less firm. Technology has distributed functionality closer to the end user, diffusing traditional definitions of network hierarchies and the class of switches.

Exemplary arrows are depicted illustrating exemplary invoice charges that may flow between different exemplary entities. For example, but not limited to, exemplary telecommunications charges, which may include, e.g., intercarrier charges may include, e.g., but without limitation, in exemplary embodiments, call detail records (CDRs), facility cost records (FCRs), voice over Internet Protocol (VoIP) records, packet records, wireless, content, ringtone, audio, video, broadcast, and other usage, facility and other charges. Charges on invoices may relate, e.g., but not limited to, to carriers charges, Internet service provider (ISP) charges, VoIP charges, wireless charges, content provider charges, music company charges, video company charges, broadcast content charges, alert charges, packet charges, and any other fixed and/or variable fee charges which may be included in an invoice.

### Connectivity to Internet Service Providers (ISPs)

In addition to providing a voice connection from calling party 1102a to called party 1110a, the PSTN can provide calling party 1102a a data connection to an ISP (i.e. similar to client 1118b).

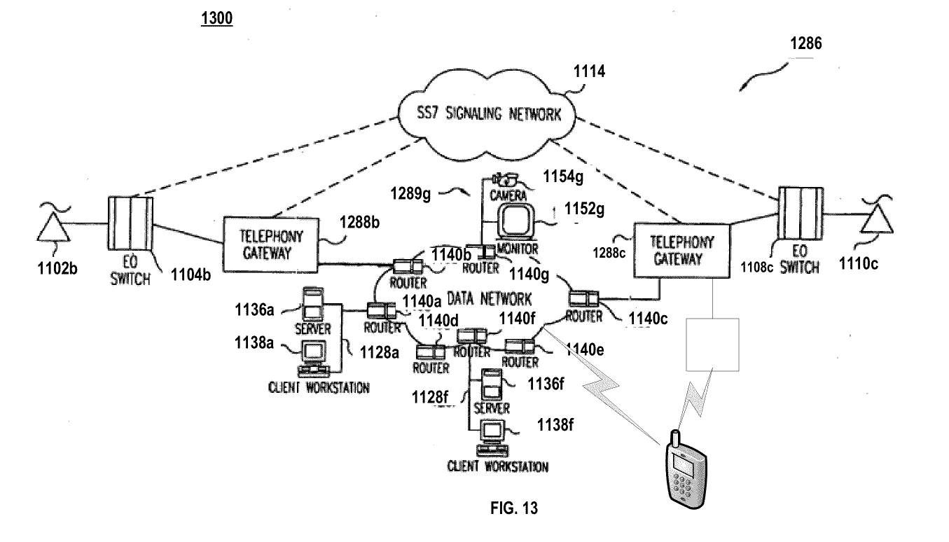

Network 1200 can also include an Internet service provider (ISP) (not shown) which could include a server computer 1122 coupled to a data network 1142 as will be discussed further below with reference to FIG. 13. The Internet is a well-known, worldwide network comprising several large networks connected together by data links. These links can include, for example, Integrated Digital Services Network (ISDN), T1, T3, FDDI and SONET links. Alternatively, an internet can be a private network interconnecting a plurality of LANs and/or WANs, such as, for example, an intranet. An ISP can provide Internet access services for subscribers such as client 1118b.

To establish a connection with an ISP, client 1118b can use a host computer connected to a modem (modulator/demodulator) 1130b. The modem can modulate data from the host computer into a form (traditionally an analog form) for transmission to the LEC facilities. Typically, the LEC facilities convert the incoming analog signal into a digital form. In one embodiment, the data is converted into the point-to-point protocol (PPP) format. (PPP is a well-known protocol that permits a computer to establish a connection with the Internet using a standard modem. It supports high-quality, graphical user-interfaces.) As those skilled in the art will recognize, other formats are available, including, e.g., a transmission control program, internet protocol (TCP/IP) packet format, a user datagram protocol, internet protocol (UDP/IP) packet format, an asynchronous transfer mode (ATM) cell packet format, a serial line interface protocol (SLIP) protocol format, a point-to-point (PPP) protocol format, a point-to-point tunneling protocol (PPTP) format, a NETBIOS extended user interface (NETBEUI) protocol format, an Appletalk protocol format, a DECnet, BANYAN/VINES, an internet packet exchange (IPX) protocol format, and an internet control message protocol (ICMP) protocol format.

Although perhaps not shown, the exemplary embodiments of the present invention are equally applicable to any of, e.g., but not limited to, circuit switched, packet switched, wired line, wireless, cable TV (CATV), voice over power line, etc. networks, whether voice based, cell based, analog, digital, personal area, local area, and/or wide area networks, music, video, audio, movie, broadcast, digital and analog contents.

### Exemplary Communications Links

Note that FIGS. 11, 12 and other figures described herein include lines which may refer to communications lines or which may refer to logical connections between network nodes, or systems, which are physically implemented by telecommunications carrier devices. These carrier devices include circuits and network nodes between the circuits including, for example, digital access and cross-connect system (DACS), regenerators, tandems, copper wires, and fiber optic cable. It may be apparent to persons having ordinary skill in the art that alternative communications lines can be used to connect one or more telecommunications systems devices. Also, a telecommunications carrier as defined here, can include, for example, a LEC, a CLEC, an IXC, an Enhanced Service Provider (ESP), a global or international services provider such as a global point-of-presence (GPOP), and an intelligent peripheral.

EO 1104a and AT 1206 are connected by a trunk. A trunk connects an AT to an EO. A trunk can be called an inter machine trunk (IMT). AT 1208 and EO 1108a are connected by a trunk which can be an IMT.

Referring to FIG. 11, EO 1104 and PBX 1112 can be connected by a private line with a dial tone. A private line can also connect an ISP (not shown) to EO 104, for example. A private line with a dial tone can be connected to a modem bay or access converter equipment at the ISP. Examples of a private line are a channelized T1 or integrated services digital network (ISDN) primary rate interface (PRI). An ISP can also attach to the Internet by means of a pipe or dedicated communications facility. A pipe can be a dedicated communications facility. A private line can handle data modem traffic to and from an ISP.

Trunks can handle switched voice traffic and data traffic. For example, trunks can include digital signals DS1-DS4 transmitted over T1-T4 carriers. Table 1 provides typical carriers, along with their respective digital signals, number of channels, and bandwidth capacities.

TABLE 1

| Digital | Number | | Bandwidth in Megabits |
|---|---|---|---|
| signal | of channels | Designation of carrier | per second (Mbps) |
| DS0 | 1 | None | 0.064 |
| DS1 | 24 | T1 | 1.544 |
| DS2 | 96 | T2 | 6.312 |
| DS3 | 672 | T3 | 44.736 |
| DS4 | 4032 | T4 | 274.176 |

Alternatively, trunks can include optical carriers (OCs), such as OC-1, OC-3, etc. Table 2 provides typical optical carriers, along with their respective synchronous transport signals (STSs), ITU designations, and bandwidth capacities.

TABLE 2

| Optical | | International | |
|---|---|---|---|
| carrier | Electrical signal, or | Telecommunications | Bandwidth in |
| (OC) | synchronous transport | Union (ITU) | Megabits per |
| signal | signal (STS) | terminology | second (Mbps) |
| OC-1 | STS-1 | | 51.84 |
| OC-3 | STS-3 | STM-1 | 155.52 |
| OC-9 | STS-9 | STM-3 | 466.56 |
| OC-12 | STS-12 | STM-4 | 622.08 |
| OC-18 | STS-18 | STM-6 | 933.12 |
| OC-24 | STS-24 | STM-8 | 1244.16 |
| OC-36 | STS-36 | STM-12 | 1866.24 |
| OC-48 | STS-48 | STM-16 | 2488.32 |

As noted, a private line is a connection that can carry data modem traffic. A private line can be a direct channel specifically dedicated to a customer's use between two specified points. A private line can also be known as a leased line. In one embodiment, a private line is an ISDN/primary rate interface (ISDN PRI) connection. An ISDN PRI connection can include a single signal channel (called a data or D channel) on a T1, with the remaining 23 channels being used as bearer or B channels. (Bearer channels are digital channels that bear voice and data information.) If multiple ISDN PRI lines are used, the signaling for all of the lines can be carried over a single D channel, freeing up the remaining lines to carry only bearer channels.

### Exemplary Telecommunications Traffic

Telecommunications traffic can be sent and received from any network node of a telecommunications carrier. A telecommunications carrier can include, for example, a LEC, a CLEC, an IXC, and an Enhanced Service Provider (ESP). In an embodiment, this traffic can be received from a network node which is, for example, a class 5 switch, such as EO 1104a, or from a class 3/4 switch, such as AT 1206. Alternatively, the network system can also be, for example, a CLEC, or other enhanced service provider (ESP), an international gateway or global point-of-presence (GPOP), or an intelligent peripheral.

Voice traffic refers, for example, to a switched voice connection between calling party 1102a and called party 1110a. It is important to note that this is on a point-to-point dedicated path, i.e., that bandwidth is allocated whether it is being used or not. A switched voice connection is established between calling party 1102a and EO 1104a, then to AT 1206 then over an IXC's network such as that of IXC 1106a to AT 1208 and then to EO 1108a and over a trunk to called party 1110a. In another embodiment, AT 1206 or IXC 1106a can also be, for example, a CLEC, or other enhanced service provider (ESP), an international gateway or global point-of-presence (GPOP), or an intelligent peripheral.

It is possible that calling party 1102a is a computer with a data connection to a server over the voice network. Data traffic refers, for example, to a data connection between a calling party 1102a (using a modem) and a server 1122b that could be part of an ISP. A data connection can be established, e.g., between calling party 1102a and EO 1104a, then to AT 1206, then to CLEC 1214, then over a fixed wireless CLEC 1209 link to PBX 1112b to a modem 1130b associated with server 1122b.

A voice-over-Internet Protocol (VoIP) call may also be made and telephony and other data may be delivered over a data network as shown in FIG. 13.

FIG. 13 depicts a diagram 1300 illustrating an exemplary voice over a data network hardware architecture as may illustrate an exemplary voice over Internet Protocol (VoIP) hybrid communications network including both VoIP devices, as well as PSTN devices, coupled together via an exemplary voice over IP network as may include, e.g., but not limited to, gateways, routers, signaling devices, SIP and/or MGCP protocol devices, softswitches, etc., as will be apparent to those skilled in the relevant art.

### Enhanced Coaching, Training and Collaboration

### Overview

Each organized calling activity, called a campaign, has a group of common subjects. (For example: a sales person selling cars may be asked about price, service quality, availability and the like. The subjects for such a campaign may be price, service quality and availability.)

### Training Playbook

The system organizes all campaign/subject-related training materials in a simple and easy to use format called a playbook. The playbook is a collection of all relevant training components organized around subjects.

Components available within the Playbook may include, e.g., but not limited to:
Sales Scripts
Bullet Points
Images, audio clips, video clips
Reference materials identified with that subject
Coaching notes, marked as good, neutral or bad (red, yellow or green)
Collection of Best Practices
Management notes
Discussion Forum
Subject-specific performance data & rank within the team. For example: for the subject price a user may have 6 successful outcomes out of 20. This 30% success rate may place the user in the top quartile of the team. As another example, for the subject availability the user may only have a 5% success rate, placing him or her in the bottom quartile of the team.

One key feature of the system is to optimize training by allowing a user to enter the training time available and have the system prioritize training activities around that constraint.

### Prioritized Training for Subject Mastery

An exemplary ultimate purpose of the system may be to present a library of effective training materials (made up of a number of components including best practice, general selling advice, etc)- and specifically may order the library by subject based upon an analytical engine's determination of those subjects where the user's improvement may have the greatest impact on improving success.

The system may do this by analyzing, e.g., but not limited to:
Progression of subjects during observed interactions and associated outcomes.
Qualitative notes from supervisor—grouped by subject—and ranked on a scale from good (1) to bad (10).
Previous attempts at improvement and the likelihood of success across the team by subject. (for example, training related to pricing objections have proven to be more effective than training related to improvements in tone or being cheerful)

It then orders the library, by subject, to maximize effectiveness.

### Subject-Component Ranking System

The purpose of this system is to provide users who are training on a specific subject with components within that subject that are ordered in a way most likely to improve their performance for said subject.

The system does this by analyzing:
Historical improvement of success rates by component type both across the entire TEAM and for that particular user. For example, if coaching notes have a higher impact on improving success rates, they may be prioritized over review of reference materials.
Amount of time available for training

### Management System

When deploying the TV System (TV herein refers to various exemplary embodiments of a TeamVisibility system as described throughout), management sets a usage and training goal for each of its reps and coaches. For example a rep may be asked to log into the system for 3 hours daily and mark at least 7 outcomes during calling activity and to do 2 hours of training weekly. A coach may be asked to review 3 calls for each rep daily and provide a minimal amount of notes for feedback.

Managers can view a rep report, sent daily by the TV System, to alert management to any usage and training deficiencies.

Managers can view a coach report, sent daily by the TV System, to alert management to any deficiencies.

### Enhanced Coaching, Training and Collaboration

### Details

The TV system incorporates unique features to automate the training and coaching of people using the system and to enhance collaboration across users. For illustrative purposes, an example of sales activity within an organization is used to describe the TV system. Application of this approach is readily extensible to a broad range of employee activities across a wide range of functions.

### Exemplary Case: Sales Activity

In one exemplary usage a sales team is engaged in outbound calling with a particular sales objective.

Each organized calling activity, called a campaign, has a group of common subjects. (For example: a sales person selling cars may be asked about price, service quality, availability and the like. The subjects for such a campaign may be price, service quality and availability.)

### Training Management

Training Management within the TV System consists of collecting the various training components, for a particular campaign/subject and using those in conjunction with employee performance and management objectives to develop a continuously adaptive and evolving training program for each member.

### Training Components

The TV System can accommodate a variety of training components, for illustrative purposes five are presented for our aforementioned exemplary case: Reference Materials, Employee Feedback, Best Practices, Subject Library, Discussion Forum and Employee Role Play.

### Reference Materials

Prior to engaging in a particular campaign, the members of the sales team are provided a set of training materials. These training materials, organized by subjects, include, but are not limited to, sales materials and informational/reference materials about the product or service being sold and any additional reference materials.

The sales materials, organized by subjects, include, but are not limited to, a calling script, along with helpful hints from sales management as to the subtleties associated with the script. These helpful hints may include, but are not limited to, how to sound confident, how to maintain composure during strong objections and the like.
Sales Materials—Calling Script, Presentations, Multi-media materials, Management Notes, helpful hints and the like.
Product/Service Reference Materials—Product Literature, Company Information, and the like.
External References—Industry provided materials, articles in the press, interviews with specialists and the like.

### Employee Feedback

Once members of the sales team initiate calling for a particular campaign, all calling data, including audio, video, desktop screenshots and outcomes, marked by activity buttons, is collected in the TV System. The data captured can be from an assortment of different computing devices and across a broad spectrum of network connections.

During the review of calling data by management and others and/or the users themselves, the reviewer has an opportunity to provide feedback to the person, whose call is being reviewed. The feedback is specific to a particular moment in the call and allows the user to select the segment of the call to include in the note. Duration of the call may be referenced by selecting a time range from the call timeline, selecting a time increments e.g. 30 seconds before and 60 seconds after or by having the system automatically select it by analyzing “sound blocks”. This feedback, for illustrative purposes, takes three basic forms:

Direct note, written or recorded from the manager/coach to the user, with or without an indicator, signifying the ranking/importance or quality (good, bad or neutral) of the call. Additionally, each note is marked with a subject title, to help organize the note. The note is meant for the user only.

Group note, written or recorded from the manager/coach to the user, with or without an indicator, signifying the ranking/importance or quality (good, bad or neutral) of the call. Additionally, each note is marked with a subject title, to help organize the note. The note is meant for a group of users, either preselected members of a team or a customized selection of users.

Best Practices note, written or recorded by the manager/coach, with or without an indicator, signifying the ranking/importance or quality (good, bad or neutral) of the call. Additionally, each note is marked with a subject title, to help organize the note. The note is meant as an example of the best practice in addressing that subject at that moment in the call. The note is meant for sharing within the group and also to become part of a permanent archive of best practices.

Any and all notes can be organized around campaigns, subjects, and importance of note.

### Subject Library

The TV System, utilizing a voice recognition system or searching through transcription of call recordings, which have been transcribed by a voice to text system, has the ability to identify subjects/keywords associated with various outcomes. These subject/keywords may have occurred just prior to the call or these subject/keywords are then designated as subjects and constitute a listing of various calls, with their associated outcomes and the user. See table below:

Campaign 1
Outcome

| Subject | Outcome | Date | Recording (click to Play) |
|---|---|---|---|
| Price | No Sale | Mar. 4, 2010 | John - 3 minutes - <PLAY> |
| Price | No Sale | Mar. 6, 2010 | Sally - 2 minutes - <PLAY> |
| Maintenance | Sale | Mar. 6, 2010 | Bob - 4 minutes - <PLAY> |
| Support | Sale | Apr. 8, 2010 | Hank - 6 minutes - <PLAY> |

This Subject library can be automatically added to the Employee Feedback system as a group call or made available to coaches and managers for further review and assignment as a part of the employee feedback system.

### Discussion Forum

Another resource available to users is the use of a discussion forum which is organized around campaigns and subjects. The TV System tracks member participation in the forum and also enables coaches and members to rate member contributions if needed.

### Best Practices Archive

The best practice archive is a collection of materials deemed worthy of retention and to be shared by all and for use in training Some items which may be included in the Best Practice Archive are:
Best Practice Note—written or spoken, from the manager/coach to the user, with or without an indicator, signifying the importance of the note. Additionally, each note is marked with a subject title, to help organize the note and to relate it to a particular subject.
Discussion Forum Comments—management and coaches have the capability of selecting and rating specific member comments on a particular subject and making them available as part of the Best Practices Archive.
Important Materials—Any Materials that are deemed valuable for sharing across the team as part of a best practices archive.

### Employee Role Play

Members of the Team can engage in mock role play to practice their use of the calling scripts and to practice various sales techniques. This mock call activity is marked within the system, rated by the coaches and managers and becomes an ongoing element of employee training

### Training Analyzer

The training analyzer is a system, utilizing the aforementioned Adaptive Learning System, which develops an individualized training program for each member of the team. The goal of the training program is to improve two aspects of an individual's performance; effectiveness and efficiency. Broadly speaking, measures of effectiveness focus on “successful outcomes” versus “unsuccessful outcomes” and measures of efficiency focus on the rate of “successful outcomes”. The system also allows customized metrics to be defined as goals for the training program, such as reducing the number of neutral outcomes, i.e. call backs etc.

The training analyzer accepts as its input five explicit elements:
Management Objectives: The system allows for management goals and objectives to be incorporated in developing a training program. For example, if management wants to complete a campaign that is time-sensitive, it may require a training program that focuses on improving efficiency over effectiveness. Additionally, management allocates how much time each member and coach is expected to devote to training and coaching.
Absolute Individual Performance: The efficiency and effectiveness of each individual member over time.
Relative Individual Performance: The efficiency and effectiveness ranking of each individual member within the team at any given time and over time.
Training Time Available: The amount of time a team member has available for engaging in training activities, as defined by management in its objectives.
Coaching Time Available: The amount of time a coach has available to provide training and feedback to various team members.

The training analyzer utilizes a multitude of statistical methodologies within its engine to develop and tune the training elements offered to an individual. These include, but are not limited to:
A Bayesian process which assigns equal probability and weight to each training component at the start of the training program. It then evaluates the users' performance over time, ascertains availability of new training components (i.e. best practices, feedback notes, etc.) and couples that with the success of various training components across other members of the team. With reassigned probabilities and weights for each training components, it then develops the next iteration of a training module and repeats the loop in a continuous improvement cycle.
A design for experiment approach that provides a weighting of various training components in a pseudo-randomized manner across multiple users to determine high impact training components to make training more efficient across the team.
A statistical measure approach, including regression, in its various forms. This allows performance to be tracked across various parameters and develops a causal association between outcomes and various training components.

As shown in FIG. 10G below, the training analyzer has grouped members of a team in various quartiles according to their efficiency and effectiveness. Based on Management Objectives, training time available and training components available the TV System will provide an individualized training program.

As shown in FIG. 10H, the training analyzer has tracked the effectiveness of a team member across time. The up arrows indicate the completion of various training modules and the impact of those modules on employee effectiveness.

### Individualized Training Program

The primary objective of the training program is to make it very easy for the user to complete the training program as efficiently as possible.

In order to accomplish that objective the user is presented with a Training Gap Report.

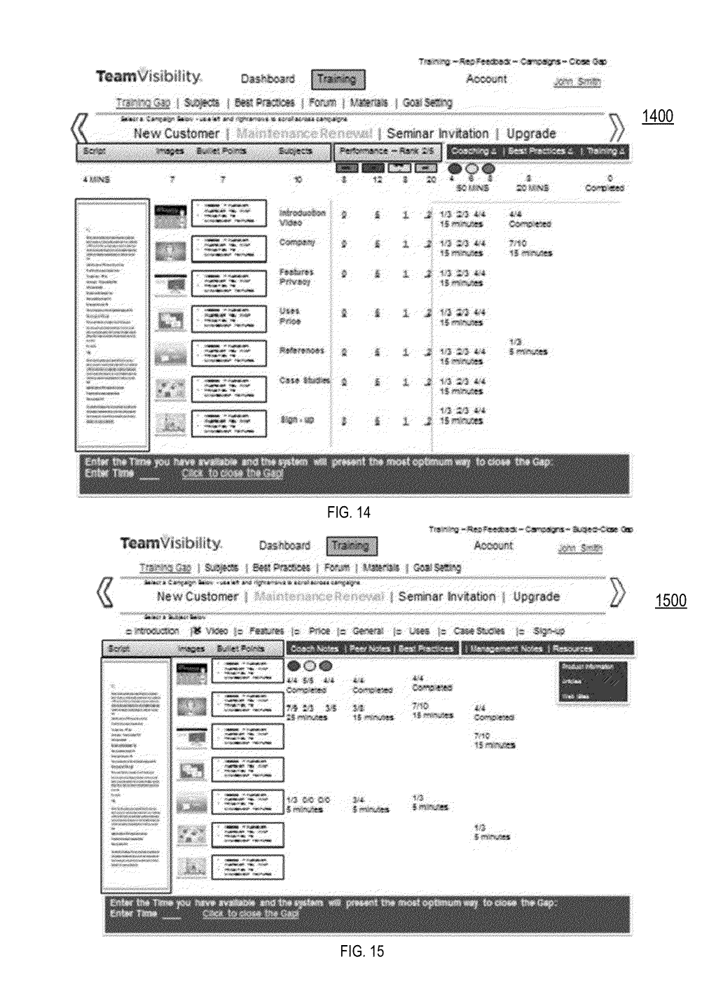

FIG. 14 outlines the web site page a team member may see when reviewing his or her training program for a particular campaign. The goal of this page is to identify the training activities that have not been completed by this team member and to assist the member in completing those most efficiently.

FIG. 14 depicts an exemplary embodiment of a diagram 1400 illustrating an exemplary TeamVisibility (TV) training gap, rep feedback, campaigns, close gap summary; according to an exemplary embodiment.

As the screen indicates, the Left Grey Box identifies various stages of a script along with the associated images and bullet points. Each portion of the script also identifies various subjects, which have been identified either by the manager/coach or by the automated voice recognition or transcription system. The next grey box displays the various outcomes associated with various stages of the script. The Blue Box identifies the training opportunities.

Under the column coaching Δ one sees three color coded circles signifying the feedback notes for the team member. Red—very important, yellow—neutral but worth reviewing and green—positive feedback. Numbers under the column signify that the number of incomplete training activities out of a pre-set number. So ⅓ means out of 3 activities, the member needs to complete 1 call review to complete his or her training The same format applies to the Best Practices Column as well as any unfinished training materials. Additionally, each training portion provides an estimate of the training time required to complete the training.

In order to “close the training gap” the member can click on each individual link or use the automated system to guide him or her through the most optimum training path. By entering the number of minutes he or she has available in the RED Area at the bottom of the screen, the system will guide the user through the training program, optimizing the most important training elements, within the constraints of the time available.

Additionally, the member may select to review training by Subject and or Best Practices.

The embodiment shown in the FIG. 15 is organized by Campaign and then by Subject.

FIG. 15 depicts an exemplary embodiment of a diagram 1500 illustrating an exemplary TeamVisibility (TV) training gap, rep feedback, campaigns, close gap summary of FIG. 14, scrolled to the right; according to an exemplary embodiment.

This identifies all the training components available to the user—selected by Subject.

This effectively acts as the “Playbook” for a member—all materials associated with a campaign and a subject are available in one place as a resource. The only thing not shown on the page is the members performance vis-à-vis the team. This performance data is the rate of successful outcomes and the ranking of that performance within the team.

As the screen indicates, the Left Grey Box identifies various stages of a script along with the associated images and bullet points. The Blue Box identifies the training opportunities, from Coach Notes, Peer Notes, Best Practices, Management Notes and any additional resources associated with that Subject and that Campaign. The Coach notes additionally, provide three color coded circles signifying the feedback notes for the team member. Red—very important, Yellow—neutral but worth reviewing and Green—positive feedback. Numbers under the column signify that the number of incomplete training activities out of a pre-set number. So ⅓ means out of 3 activities, the member needs to complete 1 call review to complete his or her training for that portion.

In order to “close the training gap” the member can click on each individual link or use the automated system to guide him through the most optimum training path. By entering the number of minutes he or she has available in the RED Area at the bottom of the screen, the system will guide the user through the training program, optimizing the most important training elements, within the constraints of the time available.

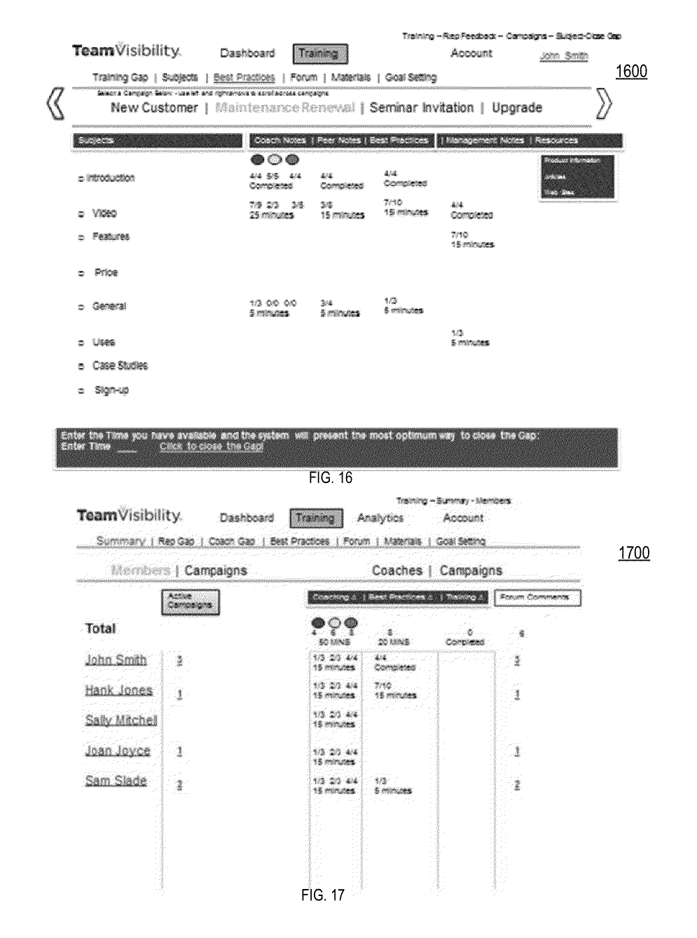

The Web Pages associated with Best Practices are shown in FIG. 16, organized by Campaign and grouped by subject. The aforementioned descriptions and training completion mechanism applies.

FIG. 16 depicts an exemplary embodiment of a diagram 1600 illustrating an exemplary TeamVisibility (TV) Best Practices, training tool, rep feedback, campaigns, close gap summary; according to an exemplary embodiment.

### Management Review of Training

As part of the TV System, management sets a usage and training goal for each of its reps and coaches. For example a rep may be asked to log into the system for 3 hours daily and mark at least 7 outcomes during calling activity and to do 2 hours of training weekly. A coach may be asked to review 3 calls for each rep daily and provide a minimal amount of notes for feedback.

Managers can view a rep report, sent daily by the TV System, to alert management to any usage and training deficiencies

| Name | Usage-hrs | Target | Δ | Actions | Target | Δ | Training Δ |
|---|---|---|---|---|---|---|---|
| John | 3.5 | 3 | +0.5 | 7 | 7 | 0 | −10 mins |
| Hank | 2.8 | 3 | −0.2 | 8 | 7 | +1 | +20 mins |
| Sally | 2.1 | 3 | −0.7 | 4 | 7 | −3 | −45 mins |
| Jane | 5 | 3 | +2 | 12 | 7 | +5 | +25 mins |

Managers can view a coach report, sent daily by the TV System, to alert management to any deficiencies.

| Name | Calls Reviewed | Target | Δ | Feedback Notes | Target | Δ |
|---|---|---|---|---|---|---|
| Jon | 10 | 3 | +7 | 12 | 7 | +5 |
| Henry | 2 | 3 | −1 | 8 | 7 | +1 |
| Susan | 1 | 3 | −2 | 4 | 7 | −3 |
| Janet | 5 | 3 | +2 | 7 | 7 | 0 |

Managers can view the status of training for individuals by using a management summary web page, shown in FIG. 17. This identifies number of active campaigns for a particular user and the training gap associated with that member.

FIG. 17 depicts an exemplary embodiment of a diagram 1700 illustrating an exemplary TeamVisibility (TV) Summary, training, and members, coaches, and campaign information according to an exemplary embodiment.

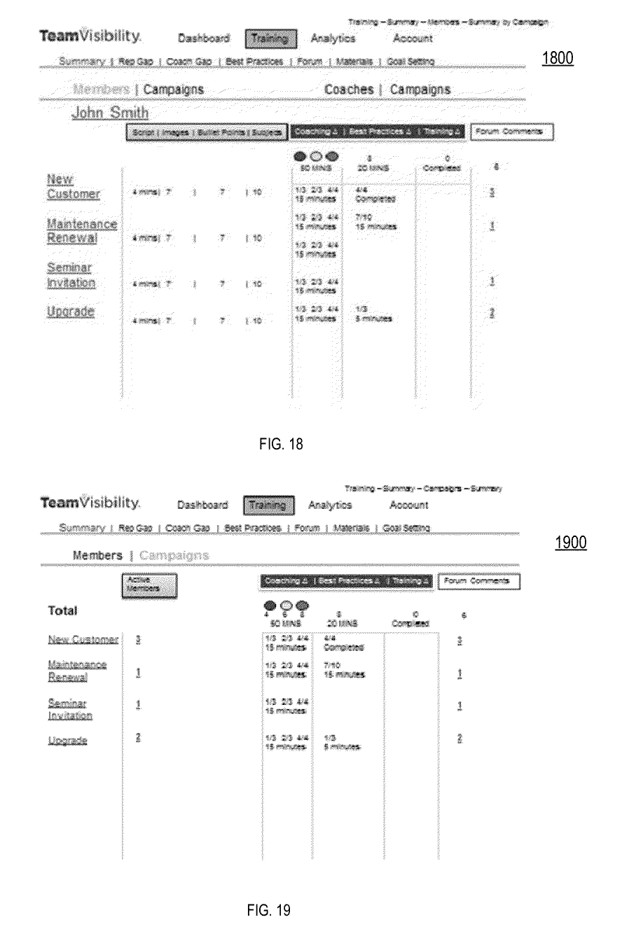

Detailed gaps in the member training can be reviewed by clicking on the member name as shown on the subsequent FIG. 18.

FIG. 18 depicts an exemplary embodiment of a diagram 1800 illustrating an exemplary TeamVisibility (TV) Training, Summary by campaign, member information for an exemplary member; according to an exemplary embodiment.

Managers can also view the status of training for campaigns by using a management summary web page, shown in FIG. 19. This identifies number of active members for each campaign and the training gap associated with that campaign.

FIG. 19 depicts an exemplary embodiment of a diagram 1900 illustrating an exemplary TeamVisibility (TV) Summary, training, for an exemplary campaign summary information according to an exemplary embodiment.

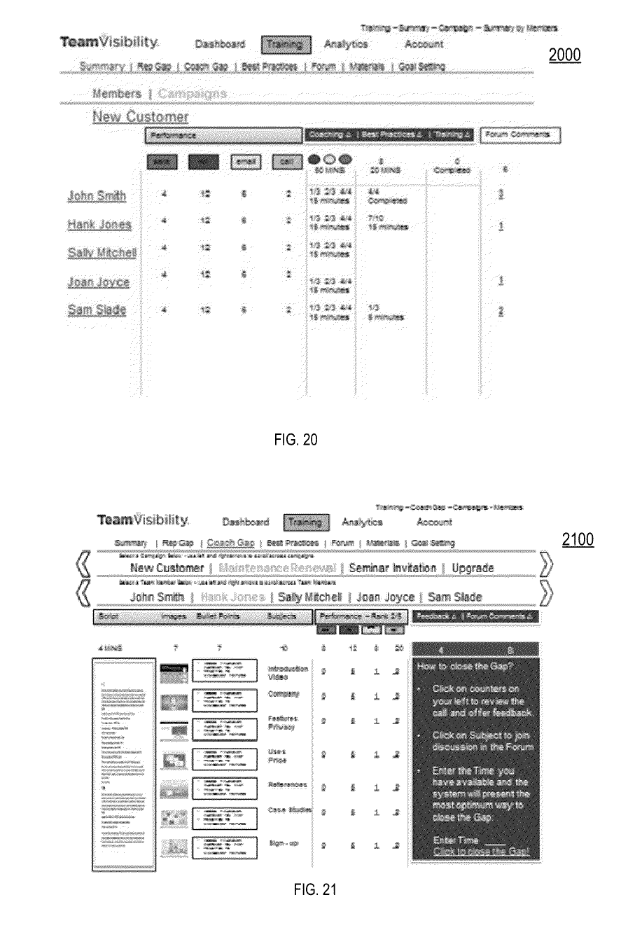

Managers can also view the status of training for a particular campaign by using a management summary web page, shown in FIG. 20. This identifies number of active members for a particular campaign and the training gap associated with each member within that campaign. The additional feature of this page is the ability to view performance alongside the training gap.

FIG. 20 depicts an exemplary embodiment of a diagram 2000 illustrating an exemplary TeamVisibility (TV) Training, Summary by campaign, for a given member; according to an exemplary embodiment.

As part of the TV System, management can designate coaching goals which identify the number of calls that a coach needs to review as part of his or her responsibility. The web page in FIG. 21 below highlights the call that need to be reviewed for team member. Additionally, management may require contributions to the discussion forum. The RED box indicates the number of calls/feedback comments that the coach is expected to provide along with number of comments/contributions expected in the discussion forum. As the bottom of the blue box indicates, the TV system has the ability to help close the coaching gap by enabling the coach to enter the time available and having the system optimize that time most effectively.

FIG. 21 depicts an exemplary embodiment of a diagram 2100 illustrating an exemplary TeamVisibility (TV) Summary, training, coach gap, campaign and member information according to an exemplary embodiment.

### Coach Effectiveness Analysis

All the activities around a coach are evaluated by the TV system for their impact on member effectiveness and efficiency. As the system acquires data it can assign a confidence interval to the impact of coaching on the effectiveness and efficiency of a particular member. This impact analysis is subsequently used to rank coaches.

Ranking of coaches enables an organization to improve its coaching by developing a coach the coach program, whereby higher ranked coaches provide feedback to lower ranked coaches. This system allows continual evaluation of coaches and ensures impactful coaching for the team members.

The system deployed uses the same analytical engine as the one used for members, Except that the outcome targeted is improving the confidence interval of the impact of coaching on member outcomes.

### Member Effectiveness Analysis

One additional feature of the Training System is to use the aforementioned ALS is to try to identify any particular sales activity, which is more aligned with the profile of a particular sales person. A consultative sales person may have more success in a business to business sales setting involving longer sales cycle than in a business to consumer setting where the sales cycle is much shorter.

### Enhanced Sales Analytics

Within the TV System, it is possible for a Campaign to utilize multiple variants of various sales materials, to optimize the effectiveness of various sales techniques and sales materials. As an example, parts of a sales script can be modified so that different members are using different sales scripts. This affords the opportunity to see the impact of various modifiers of the Sales Script on various Campaign outcomes. The table below indicates scripts versus success outcomes. (Associated data pertaining to rate of success outcomes, call counts and other confounding variables have been normalized for illustrative purposes).

| Script | Success Outcomes |
|---|---|
| Sales Script 1 | 10 |
| Sales Script 2 | 15 |
| Sales Script 3 | 8 |

Script Impact.

Statistically Insignificant: Script 1 versus Script 2

Statistically Significant: Script 1 & Script 3 versus Script 2.

This kind of analysis can be further improved by relying on Statistical Design of Experiments methodology to optimize the script testing environment.

While various embodiments of the present invention have been described above, it should be understood that they have been presented by way of example only, and not limitation. Thus, the breadth and scope of the present invention should not be limited by any of the above described exemplary embodiments, but should instead be defined only in accordance with the following claims and their equivalents.

What is claimed is:

1) A computer implemented method of providing an employee or user activity management system comprising:
a. receiving, by at least one processor, an indication to start or stop recording, wherein said indication comprises receiving at least one of a selection to start recording, a selection to stop recording, a trigger, or a toggle, comprising at least one of:
i. receiving said selection based on a timer, wherein said timer comprises at least one of a user defined timer or a signaled timer from a remote web server to start recording user activity and stop recording said user activity;
ii. receiving said selection based upon receiving launching of at least one user-selected software application, or portion of at least one software application to start recording user activity;
iii. receiving said selection based upon receiving closing or making inactive at least one user-selected software application, or portion of at least one software application to stop recording user activity;
iv. receiving said selection based upon receiving facial recognition by at least one of the webcam, or other video capture device;
v. receiving said selection based upon receiving a change in audio level or a prescribed voice detection;
vi. receiving said selection based upon receiving a signal from a remote web server, initiated by a manager or automated based on detection of certain external events or software parameters; or
vii. receiving said selection based upon receiving a signal from at least one of a VoIP session initiation, or telco activity, to at least one of: start recording user activity, or stop recording activity;
b. upon receiving said indication, recording, by at least one processor, activity information at an employee or user computing device, said recording comprising at least one of:
i. capturing audio from at least one of a mic, speaker, telco device, or VoIP session;
ii. capturing at least one of a video, an image from a web cam, or an image from a camera;
iii. capturing a screen capture of a computing device;
iv. capturing a screen capture of an employee or user computing device;
v. capturing environmental data from at least one sensor comprising at least one of a temperature sensor, a humidity sensor, or an environmental conditions sensor;
vi. capturing geo-location information from at least one location sensing device;
vii. capturing computer usage data;
viii. capturing electronic communications comprising at least one of an electronic mail message, an instant message, an SMS message, or an MMS message;
ix. capturing at least one social media post; or
x. capturing at least one social networking activity; and
c. providing or transmitting, by the at least one processor, said activity information to a network cloud for at least one of: storage, processing, access, or review.

2) The method of claim 1, further comprising at least one of:
a. making information available, by the at least one processor, for at least one of:
i. providing or performing at least one of analyzing, viewing, reporting, training, or alerting;
ii. attaching employee or user activity record to at least one of IT or other independent system comprising at least one of: employee or user activity referenced or attached to corporate IT systems including at least one of enterprise resource planning (ERP), customer relationship management (CRM), engineering project management (EPM), project management, collaboration, knowledge management (KM), or human resources (HR);
iii. verifying commitment of an employee or user comprising at least one of: reviewing a recorded session of said commitment of the employee or user, wherein said commitment is to at least one of a peer, customer, or manager, or approving said commitment; or
iv. processing by a third party verification system.

3) The method of claim 1, further comprising at least one of:
a. receiving, by the at least one processor, feedback of at least one of a manager, a supervisor, or a coach, and associating or incorporating said feedback with said content;
b. receiving, by the at least one processor, at least one note to self, and associating or incorporating, as part of an employee knowledge base; or
c. providing for user selection, by the at least one processor, of at least one activity or at least one session for training purposes, and receiving said user selection, or storing said user selection in a company knowledge base.

4) The method of claim 1, further comprising at least one of:
a. providing by at least one processor, an information display mechanism, whereby the recording component serves to display information of at least one user activity.

5) The method of claim 4, wherein said providing said information display mechanism further comprises at least one of:
a. providing a visual display of information of various outcomes across user activities comprising at least one of:
i. a number of telco calls;
ii. a number of CRM outcomes;
iii. a number of feedback messages;
iv. a number of user defined outcomes in various software applications;
v. a user specific electronic message;
vi. a team specific electronic message; or
vii. an alert based on at least one of an organizational or a user defined characteristic comprising at least one of a breaking news item, weather, product information, service information, or company information;
b. providing a recent webcam image to provide visual feedback as to mood or facial expression of the user;
c. providing a performance ranking or a status of a user within a team;
d. providing proximity to defined goals, or potential awards, of a user or a team of the user; or
e. providing for review of training materials or time required to achieve a training objective of the user.

6) The method of claim 1, further comprising at least one of:
a. analyzing, by the at least one processor, a volume level of an audio recording to determine when an actual conversation was taking place;
b. analyzing, by the at least one processor, how often, or a percentage of time the user was engaged in a conversation;
c. analyzing, by the at least one processor, a conversational tone for mood detection or determining at least one of: a level of anxiety, level of stress, or level of calmness;
d. analyzing, by the at least one processor, a mood of the user during various times;
e. correlating, by the at least one processor, a mood of the user with user productivity;
f. analyzing, by the at least one processor, a webcam image to determine presence of an individual in an image to ascertain amount of time user was at desk of the user;
g. analyzing, by the at least one processor, a facial expression of the user for mood detection;
h. analyzing, by the at least one processor, a desktop screen image of the user to assess the nature of computing activity engaged by the user;
i. analyzing, by the at least one processor, a software application used by the user;
j. analyzing, by the at least one processor, a duration of use of a software application by the user; or
k. analyzing, by the at least one processor, a frequency of use of a software application by the user.

7) A computer-implemented method comprising:
a. receiving, by at least one processor, input comprising at least one of audio data, visual data, screen data, webcam data, sensory data, or environmental data comprising:
i. capturing data or receiving captured data comprising at least one of:
1. capturing or receiving data of a category comprising at least one of:
a. capturing or receiving continuous audio data captured in a plurality of portions from a source comprising at least one of:
i. a mic;
ii. a speaker;
iii. a cloud based telco;
iv. a VoIP calls;
v. a video conference;
vi. a captured audio; or
vii. an audio stream;
b. capturing or receiving a video comprising at least one of: at least one image, or a stream of images, wherein said at least one image or said stream is captured at a configurable frequency from a video source comprising at least one of:
i. a Webcam;
ii. an external video capture device;
iii. a video conference device; or
iv. a camera;
c. capturing or receiving a screen capture comprising at least one of: at least one screen image, or a stream of screen images, wherein said at least one screen image or said stream is captured at a configurable frequency from a display screen capture source comprising at least one of:
i. a user display device;
ii. a display device controller;
iii. a software usage catalog;
iv. a computer usage list; or
v. a browser usage catalog;
d. capturing or receiving user activity data comprising at least one user activity captured at a configurable frequency from at least one interactive device comprising at least one of:
i. a camera;
ii. a video device;
iii. an audio device;
iv. a capture device;
v. a sensing device;
vi. a behavioral demographic indication of user activity;
vii. a psychographic indication of user activity;
viii. an action button;
ix. an activity indicator;
x. a message capture;
xi. an electronic message;
xii. an instant message (IM);
xiii. a social media post; or
xiv. a message;
e. capturing or receiving a location using a location based sensing device comprising at least one of:
i. a global positioning system (GPS) sensing device;
ii. a geo tagging system;
iii. a wireless location sensing system; or
iv. a multi-dimensional location sensing system;
f. capturing or receiving data of or for a customer relationship management (CRM) system;
g. capturing or receiving data of or for telco data comprising at least one of: data of calls initiated through the ToolBar; data of calls on the Web; data of calls on VoIP; data of calls recorded as separate calls; data of separate calls flagged as separate calls/interactions; or calls incorporated in the Analysis/Viewing System;
h. capturing or receiving sales force automation data comprising at least one of:
i. CRM data;
ii. customer data;
iii. customer service data;
iv. purchasing data; or
v. billing data;
i. capturing or receiving sensor based data comprising at least one of:
i. capturing location data;
ii. capturing environmental data; or
iii. capturing user activity data;
j. capturing or receiving Environmental data comprising at least one of:
i. capturing temperature data;
ii. capturing humidity data; or
iii. capturing sensor-based data;
k. capturing or receiving user data; or
l. capturing or receiving scanning data comprising at least one of scanner data, or fax data; or
2. capturing or receiving data of a source comprising at least one of:
a. capturing a user-initiated data; or
b. capturing an automated capture of data;
ii. creating or receiving, and storing or receiving, metadata comprising at least one of:
1. monitoring or analyzing capture activity;
2. creating log of activity;
3. tracking time of transfers; or
4. sending a message about transfer to server;
b. analyzing, by the at least one processor, said input comprising at least one of:
i. analyzing audio content comprising at least one of:
1. analyzing at least one of a client end, or server end;
2. performing audio quantification comprising at least one of:
a. distinguishing noise from silence comprising at least one of:
i. placing audio content on a scale; or
ii. enabling a supervisor to use a threshold to filter;
b. performing call analysis comprising at least one of:
i. analyzing Web-based calls; or
ii. analyzing VoIP calls;
c. capturing calls since the calls may not necessarily be recorded at the client;
d. determining at least one of inbound, or outbound calls; or
e. distinguishing telephony calls comprising at least one of VoIP or plain old telephone system (POTS) calls from generic audio;
3. processing audio comprising analyzing using a speech-to-text engine comprising at least one of:
a. transcribing audio;
b. translating a language transcription;
c. analyzing an audio transcript for keywords;
d. enabling searches of audio content; or
e. analyzing audio for possible filtering of at least one of unauthorized, or non-consensual recordings;
ii. analyzing image content, wherein said image content comprises at least one of webcam, camera, or videoconference image content, said analyzing comprising at least one of:
1. analyzing on a device comprising at least one of a client; or a server, said analyzing comprising at least one of:
a. comparing images analyzing presence of user;
b. comparing images analyzing non-presence of user;
c. detecting presence of user;
d. marking presence of user;
e. detecting nonpresence of user;
f. marking nonpresence of user;
g. monitoring facial expressions for at least one of: changes, or mood changes; or
iii. performing screen capture content analysis comprising at least one of:
1. analyzing at at least one of a client, or a server, comprising at least one of:
a. analyzing computing device screens for cataloging user software usage;
b. analyzing computing device activity;
c. analyzing browser activity; or
d. cataloguing for review; and
c. providing output, by the at least one processor, of said process to at least one of:
i. a display for a Viewing System of a viewing user;
ii. storage; or
iii. a display, wherein the display comprising displaying at least one of:
1. displaying individual captured data;
2. displaying individual analyzed data;
3. displaying team captured data;
4. displaying team analyzed data;
5. displaying a timeline of user activity for playback comprising at least one of:
a. displaying and allowing feedback to user during interaction;
b. displaying an audio graph of audio/volume levels recorded;
c. displaying screen captured images;
d. displaying webcam images captured;
e. displaying activity detail from external systems comprising at least one of enterprise resource planning (ERP), customer relationship management (CRM), engineering project management (EPM), project management, collaboration, knowledge management (KM), human resources (HR), or other user defined software;
f. displaying weather data;
g. displaying breaking news;
h. displaying customer name, company name, telephone number from an external CRM or Telco system; or
i. receiving at least one of audio or text comments from at least one of a manager, a supervisor, a coach, or a peer;
6. setting up an Alert System comprising at least one of:
a. providing a push system;
b. displaying selected data; or
c. displaying selected data based on supervisor defined rules and/or triggers;
7. setting up a training system comprising at least one of:
a. displaying selected data; or
b. displaying selected data based on supervisor selection;
8. displaying random sampling of the users activities during the day as a slideshow;
9. displaying random sampling of team activities during the day as a slideshow;
10. benchmarking;
11. displaying benchmark data to compare at least one of a team or an individual activity to at least one of industry average, or geographic averages; or
12. displaying individual captured data as a personal diary.

8) A computer implemented system comprising a processor and memory coupled to said processor, said system comprising:
a user capture system operative
to capture content data about a first user comprising:
audio content captured continually in a plurality of segments,
webcam content comprising a plurality of images captured at a configurable frequency, and
screen capture content comprising a plurality of images or data captured at a configurable frequency;
to capture meta data about said captured content;
to store said captured content and said meta data; and
to transfer said captured content and said meta data about said captured content to at least one of a cloud based network system or a cloud based storage system for at least one of analysis or processing to prepare said content for viewing by a second user.

9) The system of claim 8, further comprising:
an analysis system on at least one of:
said user capture system, or
the cloud based network or storage system,
said analysis system operative to process said content.

10) The system of claim 8, further comprising:
a viewing system, coupled to the cloud based network or storage system, adapted to allow the second user to access said captured content of the first user.

11) The system of claim 8, further comprising:
a management system operative to provide users a subscription-based access to an application program service adapted to provide said capture, storage, and transmission of said captured content from said user capture system, adapted to provide an analysis system adapted to analyze said captured content to obtain analyzed content, and adapted to provide display on a viewing system of said analyzed content, and adapted to provide said storage and access to said storage of said analyzed content on the cloud-based network and storage system.

12) The system of claim 8, wherein said audio content is segmented in 1 minute segments.

13) The system of claim 8, wherein each image of said plurality of images of said webcam content is captured every 10 seconds.

14) The system of claim 8, wherein each image of said plurality of images of said screen capture content is captured every 10 seconds.

15) The system of claim 8, wherein said user capture system comprises a browser based toolbar application program comprising at least one of:
a start recording button;
a recording activity button;
at least one activity button; or
a message button.

16) The system of claim 8, wherein said user capture system comprises a browser-based toolbar application program comprising:
a start recording button;
a recording activity button;
at least one activity button; and
a message button.

17) The system of claim 8, further comprising a viewing system coupled to the cloud-based network and storage system, adapted to display to the second user analyzed data comprising at least one of:
analysis of individual captured content; or
analysis of team based captured content.

18) A computer program product embodied on a computer readable storage medium comprising a plurality of program instructions which, when executed on at least one computer processor, provide a method of providing an employee or user activity management system, the method comprising:
a. recording, by at least one processor, activity at the employee or user computing device comprising at least one of:
i. capturing audio from at least one of a mic, a speaker, a telco, or VoIP;
ii. capturing at least one of video or images from a web cam;
iii. capturing a screen capture of a computing device of an employee or user;
iv. capturing environmental data from sensors comprising at least one of temperature, humidity, or environment data;
v. capturing location information from a multi-dimensional location sensing device;
vi. capturing computer usage;
vii. capturing electronic communications; or
viii. capturing social networking activity;
b. providing, by the at least one processor, or transmitting, by the at least one processor, information to a network cloud for at least one of: storage, or processing; and
c. making information available, by the at least one processor, for at least one of:
i. performing at least one of analyzing, viewing, reporting, training, or alerting;
ii. attaching employee activity record to records comprising at least one of: employee or user activity referenced IT systems comprising at least one of enterprise resource planning (ERP), customer relationship management (CRM), engineering project management, project management, knowledge management (KM), or HR;
iii. verifying employee or user commitments comprising at least one of: a recorded session of an employee or user or user interaction with at least one of a peer, a customer, or a manager; or
iv. processing by a third party verification system.

19) The computer program product of claim 18, wherein the method further comprises at least one of:
v. incorporating, by the at least one processor, feedback of at least one of a manager, a supervisor, or a coach as part of the user record;
vi. incorporating, by the at least one processor, notes to self as part of the employee or user knowledge base; or
vii. enabling, by the at least one processor, a user to select an activity or session for training purposes and to include in a company knowledge base.

20) An employee or user activity management system comprising:
at least one processor adapted to record activity at the employee or user computing device comprising at least one of:
audio from at least one of a mic, a speaker, a telco device, or VoIP session;
a video or at least one image from a web cam;
a screen capture of an employee or user computing device;
environmental data from at least one sensor comprising at least one of a temperature, a humidity, or other environmental data;
location information from a multi-dimensional location sensing device;
computer usage;
electronic communication; or
social networking activity;
said at least one processor adapted to provide, or transmit information to at least one of a cloud based network, or a cloud based storage, for at least one of storage or processing; and
said at least one processor adapted to make information available to at least one of:
to perform at least one of analyzing, viewing, reporting, training, or alerting;
attaching an employee or user activity record to system comprising at least one of: an employee or user activity record of a corporate IT systems, an enterprise resource planning (ERP) system, a customer relationship management (CRM) system, an engineering project management (EPM), a project management system, a knowledge management (KM) system, or a human resources (HR) system;
to verify a user commitment comprising at least one of: a recorded session of a user's promise to at least one of a peer, a customer, or a manager;
to intelligently make available talking points comprising at least one of a sales tip, training, coaching, or product feature information for user access based on type of call or activity employee or user engaged in;
to intelligently make available resource links/applications (e.g., credit bureaus, etc.) for employee or user to access based on type of call or activity employee or user engaged in; or
to process by a third party verification system.

21) The system of claim 20, further comprising analyzing of recording activity comprising at least one of:
means for incorporating at least one of a manager's, a supervisor's, or a coach's feedback as part of the Employee or user record;
means for incorporating notes to self as part of the Employee or user Knowledge base;
enable a company to select activities/sessions for training purposes and to include in the company knowledge base;
means for recognizing words in a recording activity;
means for recognizing the length of a recording activity;
means for determining the percentage of time of activity as compared to inactivity;
means for recognizing a number of speakers in a recording activity;
means for recognizing a number of speakers in a recording activity;
means for recognizing a language of a recording activity;
means for recognizing an age of a participant in a recording activity;
means for recognizing an audio quality of a recording activity;
means for recognizing a video quality of a recording activity;
means for recognizing gender of a participant in a recording activity;
means for evaluating a recording activity;
means for selecting a particular recording activity from a plurality of recording activities for review;
means for capturing a screen associated with a recording activity;
means for performing voice recognition on a recording activity;
means for speech to text recognition of a recording activity;
means for translation of a recording activity;
means for keyword searching of a recording activity;
means for identifying people in a recording activity;
means for detecting stress in a recording activity;
means for detecting emotion in a recording activity;
means for identifying location of a participant in a recording activity; or
means for geolocation sensing of a recording activity.

22) The system of claim 8, further comprising means for recording activity of at least one of:
a distributed employee or user recording activity;
a distributed workforce recording activity;
a mobile workforce recording activity;
a virtual workforce recording activity;
a manager review of an employee or user recording activity;
a customer and employee or user recording activity;
a recording activity for a government or public worker;
a recording activity for a private industry worker;
a sales person and a customer recording activity;
a manager and subordinate recording activity;
a trainer and a trainee recording activity;
a peer to peer recording activity;
a recruiter to recruit recording activity;
a customer relationship management (CRM) recording activity;
a call recording activity;
a VoIP call recording activity;
an employer and candidate recording activity;
a commercial recording activity;
a business-related recording activity;
an employment management activity;
a human resource tracking recording activity;
a personal diary recording activity;
a compliance tracking recording activity; or
a recording activity of an employee or user's actions.

23) The method of claim 1, further comprising capturing or storing content in the cloud, said content further comprising at least one of:
audio content;
video content;
a recording;
a file;
a stream of content;
a video content stream;
an audio content stream;
a media content stream;
compressed content;
uncompressed content;
digital content;
sampled audio content;
captured video content;
digitized analog content; or
data compressed in a compressed format comprising at least one of:
a WAV format,
an MP3 format,
an OGG format,
an MPEG format,
an AVI format, or
another compressed format.

24) A method for gathering person specific activity data, comprising:
capturing activity data through at least one collection device, the at least one collection device being of at least one of: a distributed work force, or a mobile work force, and
allowing the data to be at least one of:
exported,
saved for review,
analyzed,
referenced, or
exported to a third party system.

25) A method for gathering person specific activity data, comprising:
capturing person specific activity data through at least one collection device, or receiving from at least one of a public or private data source, said capturing comprising:
capturing information regarding at least one of a distributed or mobile work force, and
allowing said captured data to be at least one of:
exported,
saved for review,
analyzed,
referenced, or
exported to a third party system.

26) A method comprising:
gathering individual activity data comprising at least one of:
gathering data across multiple platforms,
gathering data from at least one of multiple sources or sensors, or
gathering data across broad geographies, said gathering said individual activity data comprising:
collecting data in a computing device,
transmitting said data to a network cloud computing device comprising at least one of:
a remote computing device;
a storage device;
allowing said individual activity data to be combined with data available from at least one of:
a public data source, or
a private data source; and
allowing said individual activity data to be made available for at least one of:
analyzing,
correlating,
making available for a least one of:
reviewing,
archiving,
searching,
analysis, or
reporting.

27) The method according to claim 26, further comprising:
using said individual activity data by at least one of:
an organization for at least one of employee or user activity management, or
a school for student activity management.

28) The method according to claim 22, further comprising:
taking said data collected, and at least one of:
inserting,
exporting,
attaching to an other system comprising at least one of:
customer relationship management (CRM),
enterprise resource planning (ERP),
project management (PM),
engineering project management (EPM),
knowledge management (KM), or
human resources (HR).

29) The method according to claim 22, further comprising at least one of:
intelligently making available analysis;
intelligently making available talking points;
intelligently analyzing at least one of screen activity or sensed data;
intelligently making available talking points for at least one of: sales tips, coaching, training, information, or product feature information for user access based on type of call or activity user is engaged in;
intelligently making available resource links or applications for at least one of: a credit bureau, an information service a user to access based on type of call or activity in which user is engaged; or
intelligently making available via an underlying artificial intelligence system recommended processing.

30) The system according to claim 8, wherein said user capture system is further
adapted to share said recording activity comprising at least one of:
adapted to authorize selected viewers to view user recorded activities; or
adapted to authorize selected viewers to view portions of user recorded activities.

31) The system according to claim 30, wherein said user capture system is further adapted to receive at least one of:
1. a selection of recorded activity comprising being adapted to at least one of:
a. receive a selection of at least one segment of a plurality of items on a time line;
b. select a least one segment based on at least one pre-defined length;
c. select at least one segment based on a selection or pointing device adapted to select a selection or particular range; or
d. select at least one segment based on at least one received input of at least one time selection;
2. a selection of recorded activity, adapted to analyze at least one of:
a. at least one keyword in the recording;
b. a frequency of at least one keyword in the recording;
c. a voice match of at least one voice in the recording;
d. a gender match of at least one voice in the recording;
e. a phrase match in the recording;
f. a keyword match in at least one of an associated audio note, or feedback message within a recording;
g. an other software activity match, displayed on a time line of a recording;
h. a particular screen image match;
i. a particular URL match within the software activity;
j. at least one of a VoIP or Telco Activity match displayed within a time line of a recording;
k. a location match of the recording activity; or
3. a selection of access to at least one selected recorded activity or group of recording activities made available through a system adapted to at least one of:
a. embed at least one segment in an email or other communication message;
b. create a URL, accessible via the web, comprising at least one of:
i. open access—no password or access control;
ii. user defined passwords;
iii. expiring URLs that become unavailable after a pre-defined length of time; or
iv. number of views;
c. make at least one segment available within a messaging or sharing component; or
d. tag at least one selected recorded activity by at least one specific tag and programmatically make them available to a user or pre-defined group of users.

32) The system according to claim 4, further comprising being adapted for privacy and control of recording activity comprising being adapted to at least one of:
i. designate which sensory data is to be captured;
ii. designate how often sensory data is captured;
iii. designate who is authorized to view what, when, and/or for how long; or
iv. designate, select or permanently delete data.

33) The system according to claim 4 further adapted to provide output, by the at least one processor, of said process adapted to provide for viewing at least one time line of recording data adapted to display at least one of:
i. a timeline of user activity for playback comprising being adapted to at least one of:
a. display or allow feedback to user during interaction; or
b. receive at least one of audio or text comments from at least one of a manager, a supervisor, a coach, or a peer;
c. display an audio graph of audio/volume levels recorded
d. display screen captured images
e. display webcam images captured
f. display activity detail from external systems such as CRM or ERP or Project Management or other user defined Software
g. display weather data
h. display breaking news
i. display customer name, company name, telephone number from an external CRM or Telco system
j. display feedback and messages associated with that moment in the recording; or
ii. a navigation of a display by a time line comprising being adapted to at least one of:
a. receive a click or selection on any point or moment on the time line; or
b. receive a click or selection on any event marked on the time line.

34) The system according to claim 4 further adapted to provide output comprising being adapted to provide at least one of:
1. a view system whereby a viewer can select or search calls by at least one of:
a. an event across one user or an entire team of users;
b. an event for a particular user;
c. to define a call and have a system find “like” calls, wherein a like call comprises a call being determined or evaluated by a common characteristic across one or a plurality of calls comprising at least one of:
i. keywords within the calls;
ii. frequency of keywords within the calls;
iii. gender voice;
iv. event type;
v. time of call;
vi. length of call;
vii. geography of call; or
viii. demographics of call;
d. to define a call and have a system find “unlike” calls, wherein unlike calls are determined by evaluating an uncommon characteristic across one or a plurality of calls comprising at least one of:
i. at least one keyword within a call;
ii. a frequency of at least one keyword within the call;
iii. a gender of a voice;
iv. an event type;
v. time of call;
vi. length of call;
vii. geography of call; or
viii. demographics of call;
e. select “Live” and listen to at least one call in near real-time; or
2. a view system adapted to display a list of one or more calls selected, displayed in at least one of a plurality of ways, said view system adapted to at least one of:
i. incorporate a “mini-player” adapted to allow the user to select to play audio of one or more searched calls in a sequential or nonsequential fashion; or
ii. incorporate a “mini-player” adapted to allow the user to select to play audio of one or more searched calls with associated notes and feedback comments in a sequential or nonsequential fashion.

35) The method according to claim 7 further comprising:
analyzing, by at least one processor, critical success factor data associated with at least one activity outcome or result, said analyzing comprising:
a. analyzing data comprising at least one of:
i. endogenous factors comprising at least one of:
1. audio transcript for keywords;
2. frequency of keyword usage;
3. CRM data;
4. customer data;
5. customer service data;
6. purchasing data;
7. billing data;
8. words in a recording activity;
9. speech during recording activity;
10. silence during recording activity;
11. length of a recording activity;
12. percentage of time of activity as compared to inactivity;
13. number of speakers in a recording activity;
14. gender of a participant in a recording activity;
15. capturing a screen associated with a recording activity;
16. people in a recording activity;
17. stress in a recording activity;
18. emotion in a recording activity;
19. location of a participant in a recording activity;
20. geolocation sensing of a recording activity; or
ii. exogenous factors comprising at least one of:
1. environmental factors;
2. breaking political news;
3. breaking financial news;
4. breaking industry news; or
5. breaking company news.

36) The method of claim 35, further comprising at least one of:
continuously refining results based on new data;
developing associated improved impact coefficients; or
improving accompanying confidence intervals for probabilistic critical success factors.

37) The method of claim 35, further incorporating data from at least one of:
a. a training material mastered by at least one user further comprising at least one of:
i. a reference material;
ii. a best practice;
iii. an audio transcript;
iv. participation in a discussion forum;
v. a note or feedback from at least one of a coach, a peer, or a manager;
vi. a duration of time having been coached;
vii. industry news;
viii. financial news; or
b. a performance of a team member comprising at least one of;
i. a number of years of experience in a profession;
ii. a number of years of experience in an industry;
iii. a gender of a team member;
iv. an education of a team member;
v. a cumulative amount of training time;
vi. an on-going training per time period comprising at least one of a week, a month, or a year; or
vii. a number of hours at least one of coaching, or being coached.

38) The method of claim 35, further comprising:
ascertaining effectiveness of at least one of: coaching methods, coaches, or training programs, comprising at least one of:
reviewing changes in performance outcomes after coaching interventions; or
reviewing changes in performance outcomes after training sessions.

39) The method of claim 38, comprising:
enabling a coach to review an intervention of an other coach, comprising at least one of:
providing review without identifying a particular coach; or
judging an evaluation of an intervention of a coach against actual results.

40) The method of claim 37, comprising at least one of:
ascertaining at least one training deficiency of a user;
identifying at least one high impact training activity for a user; or
developing at least one automated training program for a user.

41) The method of claim 40, comprising:
allowing a user to determine how much time is available for training; and
allocating a most efficient or effective training regimen based on said time available.

42) The method of claim 35, comprising:
matching a particular user to at least one of:
an activity to which the particular user is most suited;
a sales product to which the particular user is most suited; or
a demographic to which the particular user is most suited to target.

43) A computer implemented method of providing an employee or user a training, coaching and collaboration system comprising:
a. providing, by at least one processor, a training playbook comprising:
i. a sales script or talking point;
ii. a summarized list of bullet points;
iii. at least one image, video clip, or audio clip;
iv. a reference material;
v. at least one coaching note, or feedback note marked as at least one of good, bad or neutral;
vi. a collection of at least one best practice;
vii. at least one of an employee or a user role play;
viii. at least one management note;
ix. at least one management priority;
x. at least one discussion forum;
xi. an industry news item; and
xii. at least one product detail.

44) The method of claim 43, further comprising at least one of:
categorizing or cataloguing each element of the playbook around a subject;
associating a subject or associated material from a playbook with an activity or sales outcome;
prioritizing or associating a subject or associated material from a playbook with an activity or sales outcome;
creating a subject library of playbook materials;
creating a display of outcomes across a group of users or a team; or
providing a performance ranking for each user around at least one subject or playbook material.

45) The method of claim 44, wherein performance of each user is further provided comprising at least one of:
analyzing the performance around at least one outcome associated with at least one subject, or
analyzing the performance around at least one outcome and associated playbook materials, or
analyzing performance, wherein if the performance is subpar, selecting at least one of the associated playbook materials for improvement, coaching, or training.

46) The method of claim 45, wherein training of each user is further provided comprising at least one of:
prioritizing by at least one management objective or
customizing,
to deliver materials with a highest degree of anticipated impact on the at least one outcome and within a time constraint of the user.

47) The method of claim 46, further comprising at least one of:
a. enabling review by management of training activity of a user at least one of: by subject or by material, and ensuring proper availability of time to close any training gap; or
b. enabling review by a user of a training deficit at least one of: by subject, by material, or priority, and closing the training deficit efficiently.

48) The method of claim 44, further comprising at least one of:
continuously updating an importance of a particular subject; or
reprioritizing training based on an importance of a particular subject.

49) The method of claim 45, further comprising at least one of:
identifying a need for coaching intervention;
focusing on a particular user, subject, or playbook material; or
creating an impact on an outcome.

50) The method of claim 43, further comprising at least one of:
presenting at least one version of at least one of: at least one sales script, at least one talking point, or at least one reference material;
presenting at random across at least one of a team, or group of users; or
ascertaining an effectiveness of at least one material in producing a positive outcome.
